(19) United States
(12) Patent Application Publication
(10) Pub. No.: US 2007/0282744 A1
(43) Pub. Date: Dec. 6, 2007

(54) SUPPLY CHAIN FINANCING AND CREDIT MEMO SYSTEMS AND METHODS

(75) Inventors: Robert L. Barnes, London (GB); Daniel L. Duncan, Atlanta, GA (US); Dan Juliano, Gibsonia, PA (US)

Correspondence Address: MORRIS MANNING MARTIN LLP, 3343 PEACHTREE ROAD, NE, 1600 ATLANTA FINANCIAL CENTER, ATLANTA, GA, 30326, US

(73) Assignee: PrimeRevenue, Inc., Atlanta, GA (US)

(21) Appl. No.: 11/756,484

(22) Filed: May 31, 2007

Related U.S. Application Data
(63) Continuation-in-part of application No. 11/561,837, filed on Nov. 20, 2006.
(60) Provisional application No. 60/739,034, filed on Nov. 22, 2005.
(60) Provisional application No. 60/754,518, filed on Dec. 28, 2005.
(60) Provisional application No. 60/799,722, filed on May 9, 2006.
(60) Provisional application No. 60/803,516, filed on May 31, 2006.
(60) Provisional application No. 60/827,475, filed on Sep. 29, 2006.

(51) Int. Cl. G06Q 40/00

(52) U.S. Cl. 705/40

(57) ABSTRACT

In an electronic supply chain finance system, a method of enabling a buyer to apply credit against accounts receivable owed to a supplier by the buyer, comprising receiving a payment obligation from the buyer, the payment obligation having a payment value and a payment maturity date and being associated with an underlying accounts receivable from the buyer to the supplier, receiving a credit note from the buyer, the credit note having a credit value and a credit maturity date and being associated with the underlying accounts receivable from the buyer to the supplier, presenting the payment obligation to a financial institution as if the payment value has been reduced according to the credit value, and upon or before the payment maturity date, reducing the payment value of the payment obligation according to the credit value of the credit note.

### CROSS REFERENCE TO RELATED APPLICATIONS

This application is a continuation-in-part of U.S. patent application Ser. No. 11/561,837, filed on Nov. 20, 2006, entitled “Supply Chain Financing Systems and Methods,” which claims benefit under 35 U.S.C. § 119(e) of U.S. Provisional Patent Application Ser. No. 60/739,034, filed Nov. 22, 2005, entitled “Buyer Program and Method,” of U.S. Provisional Patent Application Ser. No. 60/754,518, filed Dec. 28, 2005, entitled “Payment Obligation System,” and of U.S. Provisional Patent Application Ser. No. 60/799,722, filed May 10, 2006, entitled “System and Methods for the Supply Chain Financing Platform.” This application also claims benefit under 35 U.S.C. § 119(e) of U.S. Provisional Patent Application Ser. No. 60/803,516, filed May 31, 2006, entitled “Credit Memo Specification,” and of U.S. Provisional Patent Application Ser. No. 60/827,475, filed Sep. 29, 2006, entitled “Credit Memo Dispute Handling Processing,” each of which is incorporated herein by reference as if set forth herein in its entirety.

### FIELD OF THE PRESENT INVENTION

The present invention relates generally to electronic commerce financing and, more particularly, to improved financial supply chain management systems and methods for enabling all parties to a “supply chain” (buyers, suppliers, and financial institutions) to collaborate across the accounts payable (A/P) and accounts receivable (A/R) processes to enable a supplier to sell receivables effectively to a financial institution or other financial partner based upon the financial strength of the buyer rather than the financial strength or credit risk of the supplier.

### BACKGROUND OF THE PRESENT INVENTION

A supply chain describes the network of vendors, suppliers, manufacturers, subcontractors, service providers, assembly operations, warehousing and distribution centers, end customers, and other parties that participate in the sale, production, and delivery of a product or service. Such supply chains are focused on satisfying customer orders for finished goods or services at chosen locations. Typically, each order describes the desired goods or services, the quantity, a cost, and an expected delivery date. Parties to the supply chain can generally be categorized as buyers or suppliers. Financial institutions or commercial lenders often get involved in the supply chain to provide funding to assist in the financing of such transactions and to support the cash flow of suppliers and buyers.

In a typical business-to-business transaction, a buyer places an order for goods or services from a supplier. This is generally documented by a purchase order. Once the purchase order is received by the supplier, the fulfillment of the order is undertaken by the supplier to deliver the requested goods or services. The delivery of the requested goods or services may involve many intermediate steps, such as assembly, warehousing, drop shipping, and local transportation, all of which add to the complexity of the distribution chain as well as to the payables because of the number of parties involved in a particular transaction.

In general, when a product leaves the supplier or after a service has been provided, an invoice is created by the supplier and communicated to the buyer. The invoice date is typically the date the invoice is transmitted from the supplier's place of operation, and this invoice date starts a period of time (i.e. “grace period”) during which no payment from the buyer is required or expected. This grace period creates, in effect, a credit line established by the supplier on behalf of the buyer, and is generally offered with no interest being charged on the outstanding balance. Often, a discount is offered by the supplier for early payment. Once the grace period has passed, payment in full is due to the supplier from the buyer. The standard grace period or due date for payment on an Invoice is 30 days.

In modern commerce, however, buyers often extend the grace period beyond the 30 day point, ignoring the supplier's terms requiring payment in 30 days, as expressed in the original invoice. This is a particular problem for large scale buyers, such as a major retailer, who delay payment as long as possible to take advantage of the time value of capital. Suppliers, who are typically much smaller than retail buyers, have little recourse with the buyers' delay tactics and have to find interim funding to cover their cash-flow needs.

To address these cash flow needs, the A/R of a supplier may be sold or used as collateral for a loan by the supplier to raise capital for operations or other purpose of the supplier. The term “factoring” is used to describe the sale or collateralization of A/R. Unfortunately, factoring presents a sub-optimal and inefficient solution to this cash-flow problem. The factoring process can be lengthy and cumbersome. For example, suppliers typically must submit detailed paperwork to the factor and follow-up with substantial documentation and proof of invoice validity prior to obtaining cash for those receivables from the factor. This approach is problematic and based upon the supplier's entire receivable base, which is usually devalued due to debtors with low credit ratings. The factor generally only lends up to 80% of the true value of the A/R because these receivables are vulnerable to returns (dilution) from the buyer. Further, the factor only takes on the credit risk of the buyer, not “product” risk. Additionally, interest rates in factoring are generally very high (12%+), even for A/R from “investment grade” buyers. All of these drawbacks arise because the factor does not have direct real-time access to the supplier's A/R or visibility into the buyer's A/P process.

A number of patents in the field describe various attempts to improve the existing factoring process for the benefit of buyers and suppliers. However, there remains a general need for systems and methods for enabling a supplier to sell receivables, rather than merely using the receivables as collateral for a loan, and to value such receivables based upon the financial strength and backing of the buyer rather than the credit risk of the supplier.

There is a further need for methods and systems that streamline the flow of capital from buyers to suppliers using electronic or traditional commerce.

There is a need for methods and systems that enable suppliers to receive early payment, albeit at a discounted value, for goods or services on a payment schedule that fits the supplier's cash flow needs.

There is yet a further need for methods and systems that provide buyers with a means to purchase goods from suppliers in which a third party guarantee secures the payment to the supplier.

There is a need for methods and systems in which electronic commerce within a supply chain financing platform is performed in an efficient manner for all parties in the supply chain.

There is an additional need for methods and integrated systems that provides visibility and ability for funds to flow through between buyers, suppliers, and their associated financial institutions or other lenders.

There is a need for methods and systems that reduce the risk on behalf of the buyers and/or financial institutions (who may be financing the suppliers' debt load while they wait for payment from the buyers).

There is yet a further need for methods and systems that provide suppliers with improved cash flow management and, in particular, with the ability to receive payment for outstanding invoices on a time schedule of their choosing, rather than waiting for the buyer's accounting department to make payments.

There is further need for methods and supply chain finance systems in which a financial institution takes title to a payment obligation based on A/R by transferring ownership of the payment obligation to itself, rather than establishing a lien based on the A/R.

There is a further need for methods and systems that enable suppliers to convert A/R into liquid funds (capital) with lower conversion costs than with factoring.

There is a further need for methods and systems that provide a means for A/R to be cleared at the time of purchase by a financial institution, rather than having the A/R exist during the entire grace period between invoice date and when the buyer pays the invoice.

There is yet another need for methods and systems for enabling the purchase of A/R from suppliers at a discount rather than guaranteeing the A/R at a discounted level and structuring the transaction as a loan.

There is a need for methods and systems that provide suppliers with an automated process that optimally values and discounts their A/R, by providing accuracy and accountability that enables suppliers to obtain the highest return on their A/R while minimizing the impact of devaluations due to suppliers with low credit rating.

There is a further need for methods and systems that enable parties to the supply chain to see and rely upon a date certain as to when a buyer is going to pay on a particular account receivables or payment obligation.

The present invention meets one or more of the above-referenced needs as described herein in greater detail.

### SUMMARY OF THE INVENTION

The present invention relates generally to electronic commerce financing and, more particularly, to improved financial supply chain management systems and methods for enabling all parties to a “supply chain” (buyers, suppliers, and financial institutions) to collaborate across the accounts payable (A/P) and accounts receivable (A/R) processes to enable a supplier to sell receivables effectively to a financial institution based upon the financial strength of the buyer rather than the financial strength of the supplier.

The supply chain finance (SCF) system of the present invention is a closed loop financial system that integrates, within defined communities, a buyer and its associated suppliers and financial institutions. The SCF system consists of many buyers, suppliers, and financial institutions that belong to one or more separate communities. The SCF system is intended to supplement the existing relationships that already exist, outside of the SCF system, between buyers and their suppliers within standard supply chain relationships.

Within the SCF system, each of the parties to a community has access, preferably within a web-hosted environment, to a common and controlled set of financial and non financial supply chain information. In particular, the SCF system enables a buyer to upload electronic output from its accounts payable (A/P) system with approved payables data, such as payee, payable date, amount, etc. This A/P data is generally referred to A/P data or supplier invoice data; however, when such data is input into the SCF system, discrete A/P data is characterized as an irrevocable payment obligation on behalf of the buyer for the benefit of the supplier, as will be described in greater detail herein.

At any time, a supplier can log into the SCF system and view the amount and exact payment date of each payment obligation posted by one of its buyers. The present system then allows the supplier, optionally, to sell payment obligations prior to their maturity date at a discounted value. Unlike factoring, payments made by a financial institution based on a payment obligation are not loans using the accounts receivable as collateral, but rather actual sale of a financial instrument, a payment obligation, from the supplier to a participating financial institution.

Suppliers may choose to receive cash for any (or all) of these receivables at any point up until a configurable cut-off date just prior to the original maturity date of each payment obligation. Suppliers, thus, have the option of selling selected accounts receivable embodied in payment obligations from particular buyers rather than merely seeking loans based on individual or bundled accounts receivable.

Within the SCF system, payment cycles are reduced to as little as 48 hours from current terms, which can be as long as 60 days or more. It is an automated, secure service that is preferably delivered by a virtual private network (VPN), eliminating manual and labor intensive processes.

A first aspect of the present invention includes, in an electronic supply chain finance system having a buyer, at least one supplier who provides goods/services to the buyer outside of the system, and at least one financial institution, each of which accesses the system through a computer network interface, a method of enabling the supplier to sell to the financial institution accounts receivable owed to the supplier by the buyer, comprising the steps of receiving a payment obligation from the buyer, the payment obligation having a value and a maturity date and being associated with an underlying accounts receivable from the buyer to the supplier, providing the payment obligation to the supplier, receiving a sell offer from the supplier, the sell offer associated with the payment obligation but having a discounted value and a payment date earlier than the maturity date, receiving an acceptance of the sell offer from the financial institution, wherein the acceptance transfers legal ownership of the payment obligation from the supplier to the financial institution, disbursing the discounted value of the sell offer from the financial institution to the supplier on the payment date, on the maturity date, receiving payment from the buyer in the amount of the value of the payment obligation, and disbursing the amount received from the buyer to the financial institution as the owner of the payment obligation.

In a feature of the first aspect, acceptance of the sell offer occurs when the financial institution indicates a verbal or electronic intent to transfer funds to the supplier based on purchase of the payment obligation. In other embodiments, acceptance is deemed to be merely “conditional acceptance” when verbal or electronic intent to transfer funds is made to the system by the financial institution and actual acceptance occurs when funding is provided to the system or to the disbursement account of the financial institution. Other triggers for actual acceptance may be negotiated or agreed upon by the parties to the system, as appropriate or desirable under the circumstances.

In a feature of the first aspect of the invention, the terms and conditions associated with the sell offer are governed by a buyer program configured prior to the receipt of the payment obligation. Preferably, the buyer program identifies the suppliers and financial institutions affiliated with the buyer. Further, the buyer program identifies which of the financial institutions to receive the sell offer.

In other features, the buyer program determines the discounted value of the sell offer and whether the sell offer can be created by the supplier. Optionally, this determination is based on whether the sell offer falls within an acceptable trade window of time wherein the buyer program identifies the time zone for the window of time. As another option, the determination is based on whether the sell offer exceeds an amount acceptable to the financial institution wherein the determination is based on aggregate sell offers already received from the supplier or based on aggregate sell offers already received by the financial institution from multiple suppliers.

In other features, the buyer program identifies the currency for the sell offer, identifies bank accounts of the buyer, the supplier, and the financial institution for management of fund transfers therebetween, and determines whether the sell offer is automatically generated on behalf of the supplier in response to receipt of the payment obligation. In different embodiments and arrangements, the determination to automatically generate the sell offer is made by the supplier or by a system manager.

In yet a further feature, the buyer program determines whether the sell offer is automatically accepted by the financial institution wherein the determination to automatically accept the sell offer is made by the financial institution.

In other features, the buyer program defines the amount of fees retained by the financial institution and other financial partners after the sell offer is accepted by the financial institution and determines how long the sell offer is valid.

In yet a further feature, the method includes the additional step of providing the sell offer from the supplier as a buy offer to the financial institution wherein the step of providing the sell offer from the supplier as the buy offer to the financial institution preferably comprises displaying the buy offer to the financial institution through the system.

In other various features, the step of providing the payment obligation to the supplier comprises displaying the payment obligation to the supplier through the system, a portion of the value of the payment obligation is provided to at least one financial partner when the payment is received from the buyer, a portion of the value of the payment obligation is provided to at least one financial partner when the discounted value of the sell offer is disbursed, the difference between the value of the payment obligation and the discounted value of the sell offer includes fees retained by the financial institution and a financial partner. Typically, the financial partner includes one or more of the following: a system manager, a system operator, a system administrator, a broker, a system service provider, a community manager, or the buyer, for example, if the buyer is self-funding or charging a fee to its suppliers for early receipt of payment.

In other features, the payment obligation is batch loaded into the system from an accounts payable system of the buyer, and wherein the payment obligation represents an irrevocable agreement by the buyer to submit payment in the amount of the value, on the maturity date, to the system. In one embodiment, the payment obligation is irrevocable when submitted to the system by the buyer. In other embodiments, the payment obligation does not become irrevocable until a later time, such as, at the maturity date, when a sell offer is made by a supplier, when a sell offer is accepted by a financial institution, or some other arbitrary cutoff time, as may be selected by the buyer, financial institution, or by the system.

Preferably, the sell offer is generated automatically by the system based on a setup decision by the supplier or by a system manager, administrator, operator, or service provider or by a community manager.

In further features, the acceptance of the sell offer is generated automatically by the system based on a setup decision by the financial institution; and the buyer, the supplier, and the financial institution each have respective bank accounts accessible by the system from which and to which payments by the system are made.

A second aspect of the present invention includes, in an electronic payment system accessed by a buyer and supplier, the supplier providing goods/services to the buyer outside of the system, the system managed by a system administrator, the buyer and supplier each accessing the system through a computer network interface and each having a respective bank account of which the system administrator is authorized to transfer funds in and out, a method comprising the steps of receiving a payment obligation from the buyer, the payment obligation having a value and a maturity date and being associated with an underlying accounts receivable from the buyer to the supplier based upon goods/services provided by the supplier, wherein the payment obligation represents an irrevocable legal agreement by the buyer to have the amount of the value withdrawn from the bank account of the buyer, on the maturity date, by the system administrator, presenting the payment obligation to the supplier prior to the maturity date, providing the supplier with an opportunity to sell the payment obligation to a third party prior to the maturity date at a discounted value, on the maturity date, withdrawing the amount of the value of the payment obligation from the bank account of the buyer

In a feature of the second aspect of the invention, if the supplier sells the payment obligation to the third party prior to the maturity date, the method further includes the step of disbursing the amount of the discounted value of the payment obligation to the bank account of the supplier prior to the maturity date and disbursing the amount of the value of the payment obligation to a bank account of the third party on the maturity date.

In another feature of the second aspect of the invention, if the supplier sells the payment obligation to the third party prior to the maturity date, ownership of the payment obligation transfers from the supplier to the third party on the date of the sale.

In yet a further feature of the second aspect of the invention, if the supplier does not sell the payment obligation to the third party, the method further comprises the steps of disbursing the amount of the value of the payment obligation to the bank account of the supplier on the maturity date.

As described above and hereinafter, the concept of disbursing funds includes actual disbursement or transfer of funds or the providing of instructions or a request to a financial institution or bank to wire or transfer funds from one specified account to another in a specific amount and at a specified date/time.

In another feature, the discounted value of the payment obligation is presented to the supplier as part of providing the supplier with the opportunity to sell the payment obligation prior to the maturity date.

In yet a further feature, the method further comprises the steps of receiving a sell offer from the supplier for the payment obligation prior to the maturity date and offering the payment obligation to the third party.

In another feature, the difference between the value and discounted value of the payment obligation includes fees retained by the financial partner, wherein the financial partner includes a system manager, a system operator, a system administrator, a broker, a system service provider, a community manager, or the buyer.

A third aspect of the present invention includes, in an electronic supply chain finance system having buyers, suppliers who provide goods/services to the buyers outside of the system, and financial institutions, all having access to the system through computer network interfaces, a method of enabling suppliers to sell their accounts receivable, comprising the steps of defining a community within the system, the community including at least one respective buyer and one or more suppliers and financial institutions associated with the respective buyer, configuring a buyer program associated with the respective buyer, the buyer program associating a subset of the suppliers and of the financial institutions with the respective buyer, and, thereafter, receiving a payment obligation from the respective buyer, the payment obligation having a value and a maturity date and being associated with an underlying accounts receivable from the buyer to a respective supplier of the subset of suppliers, providing the payment obligation to the respective supplier, receiving a sell offer from the respective supplier, the sell offer associated with the payment obligation but having a discounted value and a payment date earlier than the maturity date, providing a buy offer associated with the sell offer to a respective financial institution of the subset of financial institutions, receiving an acceptance of the buy offer from the respective financial institution, wherein the acceptance legally transfers title to the payment obligation from the respective supplier to the respective financial institution, disbursing the discounted value of the sell offer from an account of the respective financial institution to the respective supplier on the payment date, and, on the maturity date, receiving payment from an account of the respective buyer in the amount of the value of the payment obligation, wherein the sell offer, the buy offer, and associated disbursements within the community are governed by terms and conditions defined by the buyer program.

In a feature of the third aspect of the invention, the buyer program identifies the respective financial institution of the subset of financial institutions to receive the sell offer. Preferably, the buyer program determines the discounted value of the sell offer, identifies the currency for the sell offer, identifies bank accounts of the respective buyer, the respective supplier, and the respective financial institution for management of fund transfers therebetween, determines whether sell offers are automatically generated on behalf of the respective supplier in response to receipt of the payment obligation, determines whether sell offers are automatically accepted on behalf of the respective financial institution, defines the amount of fees retained by the respective financial institution and financial partners after the sell offer is accepted by the respective financial institution, and how long the sell offer is valid, wherein the financial partner includes a system manager, a system operator, a system administrator, a broker, a system service provider, a community manager, or the buyer.

Preferably, the buyer program also determines whether the sell offer can be created by the respective supplier wherein the determination is based on whether the sell offer falls within an acceptable trade window of time and wherein the buyer program identifies the time zone for the window of time. Alternatively, the determination is based on whether the sell offer exceeds an amount acceptable to the respective financial institution, such as, for example, based on aggregate sell offers already received from the respective supplier or based on aggregate sell offers already received by the respective financial institution from multiple suppliers.

In a feature, the step of providing the payment obligation to the respective supplier comprises displaying the payment obligation to the respective supplier through the system.

In another feature, a portion of the value of the payment obligation is provided to a financial partner when the payment is received from the respective buyer, wherein the financial partner includes a system manager, a system operator, a system administrator, a broker, a system service provider, a community manager, or the buyer. Alternatively, a portion of the value of the payment obligation is provided to a financial partner when the discounted value of the sell offer is disbursed.

In yet another feature, the difference between the value of the payment obligation and the discounted value of the sell offer includes fees retained by the respective financial institution and at least one other financial partner wherein the at least one other financial partner includes a system manager, a system operator, a system administrator, a broker, a system service provider, a community manager, or the buyer.

In a further feature, the payment obligation is batch loaded into the system from an accounts payable system of the respective buyer.

In another feature, the payment obligation represents an irrevocable agreement by the respective buyer to submit payment in the amount of the value, on the maturity date, to the system. In one embodiment, the payment obligation is irrevocable when submitted to the system by the buyer. In other embodiments, the payment obligation does not become irrevocable until a later time, such as, at the maturity date, when a sell offer is made by a supplier, when a sell offer is accepted by a financial institution, or some other arbitrary cutoff time, as may be selected by the buyer, financial institution, or by the system.

A fourth aspect of the present invention provides a method for enabling the buyer to apply credit against accounts receivable owed to the supplier by the buyer, comprising receiving a payment obligation from the buyer, the payment obligation having a payment value and a payment maturity date and being associated with an underlying accounts receivable from the buyer to the supplier, receiving a credit note from the buyer, the credit note having a credit value and a credit maturity date and being associated with the underlying accounts receivable from the buyer to the supplier, presenting the payment obligation to the financial institution as if the payment value has been reduced according to the credit value, and upon or before the payment maturity date, reducing the payment value of the payment obligation according to the credit value of the credit note.

In a feature of the fourth aspect of the invention, a method is provided for enabling the buyer to apply credit against accounts receivable owed to the supplier by the buyer in a community of buyers, suppliers, and financial institutions, comprising defining a community within the system, the community including at least one respective buyer and one or more suppliers and financial institutions associated with the respective buyer, configuring a buyer program associated with the respective buyer, the buyer program associating a subset of the suppliers and of the financial institutions with the respective buyer, and thereafter: receiving a payment obligation from the respective buyer, the payment obligation having a payment value and a payment maturity date and being associated with an underlying accounts receivable from the respective buyer to a respective supplier of the subset of suppliers, receiving a credit note from the respective buyer, the credit note having a credit value and a credit maturity date and being associated with the underlying accounts receivable from the respective buyer to the respective supplier, presenting the payment obligation to a respective financial institution of the subset of financial institutions as if the payment value has been reduced according to the credit value, and upon or before the payment maturity date, reducing the payment value of the payment obligation according to the credit value of the credit note.

In yet another feature of the fourth aspect of the present invention, a method is provided for enabling the buyer to apply credit against accounts receivable owed to the supplier by the buyer, comprising receiving a payment obligation from the buyer, the payment obligation having a payment value and a payment maturity date and being associated with an underlying accounts receivable from the buyer to the supplier, receiving a credit note from the buyer, the credit note having a credit value and a credit maturity date and being associated with the underlying accounts receivable from the buyer to the supplier, presenting the payment obligation to the financial institution as if the payment value has been reduced according to the credit value, and upon determining a correspondence between the credit note and the payment obligation, reducing the payment value of the payment obligation according to the credit value of the credit note.

### BRIEF DESCRIPTION OF THE DRAWINGS

Many aspects of the invention can be better understood with reference to the following drawings. The components in the drawings are not necessarily to scale, emphasis instead being placed upon clearly illustrating the principles of the present invention. Moreover, in the drawings, like reference numerals designate corresponding parts throughout the several views.

FIG. 1 is a high-level overview of an exemplary process for a supply chain finance (SCF) system.

FIG. 2 illustrates data flow transfer from the community manager and the service provider to and from a buyer program setup and management process for the supply chain finance system of FIG. 1.

FIG. 3 is an exemplary process for the setup and management of a buyer program for financial supply chain management.

FIG. 4 is an exemplary user log in web page of the buyer program entities for the SCF system of FIG. 3.

FIG. 5 is a diagram illustrating buyer program community manager web page features for the buyer program of FIG. 3.

FIG. 6 is an exemplary screen image of the community manager home page for the buyer program community manager entity of FIG. 5.

FIG. 7-A is an exemplary screen image of the list FI pricing profile for the buyer program community manager entity of FIG. 5.

FIG. 7-B is an exemplary screen image of the edit FI pricing profile for the buyer program community manager entity of FIG. 5.

FIG. 7-C is an exemplary screen image of the view FI pricing profile history for the buyer program community manager entity of FIG. 5.

FIG. 7-D is an exemplary screen image of the view FI pricing profile for the buyer program community manager entity of FIG. 5. FIG. 8-A is an exemplary screen image of the community buyers web page for the buyer program community manager entity of FIG. 5.

FIG. 8-B is an exemplary screen image of the list buyer program for the buyer program community manager entity of FIG. 5.

FIG. 8-C is an exemplary screen image of the buyer program tabs for the buyer program community manager entity of FIG. 5.

FIG. 8-D is an exemplary screen image of the edit buyer program for the buyer program community manager entity of FIG. 5.

FIG. 8-E is an exemplary screen image of the buyer program pricing screen for the buyer program community manager entity of FIG. 5.

FIG. 8-F is an exemplary screen image of the distribution screen for the buyer program community manager entity of FIG. 5.

FIG. 8-G is an exemplary screen image of the financial institution screen for the buyer program community manager entity of FIG. 5.

FIG. 8-H is an exemplary screen image of the supplier screen for the buyer program community manager entity of FIG. 5.

FIG. 9 is a diagram illustrating buyer program service provider web page features for the buyer program of FIG. 3.

FIG. 10-A is an exemplary screen image of the service provider home page for the buyer program service provider entity of FIG. 9.

FIG. 10-B is an exemplary screen image of the community directory for the buyer program service provider entity of FIG. 9.

FIG. 10-C is an exemplary screen image of the community tabs for the buyer program service provider entity of FIG. 9.

FIG. 10-D is an exemplary screen image of the list of community buyers for the buyer program service provider entity of FIG. 9.

FIG. 10-E is an exemplary screen image of the add buyer page for the buyer program service provider entity of FIG. 9.

FIG. 10-F is an exemplary screen image of the buyer program list for the buyer program service provider entity of FIG. 9. FIG. 10-G is an exemplary screen image of the add buyer program for the buyer program service provider entity of FIG. 9.

FIG. 10-H is an exemplary screen image of the buyer program (managing suppliers) page for the buyer program service provider entity of FIG. 9.

FIG. 10-J is an exemplary screen image of the add supplier page for the buyer program service provider entity of FIG. 9.

FIG. 10-K is an exemplary screen image of the buyer program system configuration for the buyer program service provider entity of FIG. 9.

FIG. 10-L is an exemplary screen image of the community financial institutions tab for the buyer program service provider entity of FIG. 9.

FIG. 10-M is an exemplary screen image of the community management add FI page for the buyer program service provider entity of FIG. 9.

FIG. 10-N is an exemplary screen image of the view supplier applications for the buyer program service provider entity of FIG. 9.

FIG. 10-P is an exemplary screen image of the supplier list for the buyer program service provider entity of FIG. 9.

FIG. 10-Q is an exemplary screen image of the add supplier page for the buyer program service provider entity of FIG. 9.

FIG. 10-R is an exemplary screen image of the FI list page for the buyer program service provider entity of FIG. 9.

FIG. 10-S is an exemplary screen image of the add FI page for the buyer program service provider entity of FIG. 9.

FIG. 11 is a diagram illustrating bank account management web page features for the buyer program service provider entity of FIG. 3.

FIG. 12-A is an exemplary screen image of the bank list for the service provider entity of FIG. 11.

FIG. 12-B is an exemplary screen image of the view bank details for the service provider entity of FIG. 11.

FIG. 12-C is an exemplary screen image of the pending bank account list for the service provider entity of FIG. 11.

FIG. 12-D is an exemplary screen image of the assign bank to account for the service provider entity of FIG. 11.

FIG. 12-E is an exemplary screen image of the validated banks for the service provider entity of FIG. 11.

FIG. 12-F is an exemplary screen image of the bank account profile for the service provider entity of FIG. 11.

FIG. 13 is a diagram illustrating financial institution web page features for the buyer program of FIG. 3.

FIG. 14-A is an exemplary screen image of the financial institution home page for the financial institution entity of FIG. 13.

FIG. 14-B is an exemplary screen image of the portfolio manager for the financial institution entity of FIG. 13.

FIG. 14-C is an exemplary screen image of the active program details edit program for the financial institution entity of FIG. 13.

FIG. 14-D is an exemplary screen image of the active buyer programs for the financial institution entity of FIG. 13.

FIG. 14-E is an exemplary screen image of the viewing available programs for the financial institution entity of FIG. 13.

FIG. 15-A is an exemplary screen image showing the tasks and alerts for the supplier entity of FIG. 4.

FIG. 15-B is an exemplary screen image showing the message details for the supplier entity of FIG. 4.

FIG. 15-C is an exemplary screen image showing the activate buyer program for the supplier entity of FIG. 4.

FIG. 15-D is an exemplary screen image showing the welcome and confirmation page for the supplier entity of FIG. 4.

FIG. 15-E is an exemplary screen image showing the edit auto advance rules page for the supplier entity of FIG. 4.

FIG. 15-F is an exemplary screen image showing the view auto advance rules page for the supplier entity of FIG. 4.

FIG. 15-G is an exemplary screen image showing the maturity date page for the buyer entity of FIG. 4.

FIG. 15-H is an exemplary screen image showing the auto maturity date rules page for the buyer entity of FIG. 4.

FIG. 16 is an exemplary screen image illustrating an added maturity cut off days example for the buyer program of FIG. 3.

FIG. 17 is an exemplary screen image illustrating a daily maturity limit example for the buyer program of FIG. 3.

FIG. 18 is an exemplary screen image illustrating the available to fund functionality for the buyer program of FIG. 3.

FIG. 19 is an exemplary screen image illustrating the available to fund functionality of FIG. 18 in expanded detail.

FIG. 20 is an exemplary screen image illustrating the summary tab for the worksheet of the available to fund functionality of FIG. 18.

FIG. 21 is an exemplary screen image illustrating the details tab for the worksheet of the available to fund functionality of FIG. 18.

FIG. 22 is an exemplary screen image illustrating the auto advance features of the worksheet of the available to fund functionality of FIG. 18.

FIG. 23 is an exemplary screen image illustrating the report criteria features of the buyer program of FIG. 3.

FIG. 24 is an exemplary screen image illustrating the buyer program view for pricing for the buyer program of FIG. 3.

### DETAILED DESCRIPTION OF PREFERRED EMBODIMENTS

Reference is now made in detail to the description of the embodiments as illustrated in the drawings. The invention may, however, be embodied in many different forms and should not be construed as limited to the embodiments set forth herein; rather, these embodiments are intended to convey the scope of the invention to those skilled in the art. Furthermore, all “examples” given herein are intended to be non-limiting.

The present invention relates generally to electronic commerce financing and, more particularly, to improved financial supply chain management systems and methods for enabling all parties to a “supply chain” (buyers, suppliers, and financial institutions) to collaborate across the accounts payable (A/P) and accounts receivable (A/R) processes to enable a supplier to sell receivables effectively to a financial institution based upon the financial strength of the buyer rather than the financial strength or credit risk of the supplier.

Supply Chain Finance System

The supply chain finance (SCF) system of the present invention is a closed loop financial system that integrates, within defined communities, buyers and associated suppliers and financial institutions. The SCF system consists of many buyers, suppliers, and financial institutions that belong to one or more separate communities. The SCF system is intended to supplement the existing relationships that already exist, outside of the SCF system, between buyers and their suppliers within standard supply chain relationships.

Within the SCF system, each of the parties to a community has access, preferably within a web-hosted environment, to a common and controlled set of financial and non financial supply chain information. In particular, the SCF system enables a buyer to upload electronic output from its Accounts Payable (A/P) system with approved payables data, such as payee, payable date, amount, etc. This A/P data is generally referred to A/P data or supplier invoice data; however, when such data is input into the SCF system, discrete A/P data is characterized as an irrevocable payment obligation on behalf of the buyer for the benefit of the supplier, as will be described in greater detail herein.

At any time, a supplier can log into the SCF system and view the amount and exact payment date of each payment obligation posted by one of its buyers. The present system then allows the supplier, optionally, to sell payment obligations prior to their maturity date at a discounted value. Unlike factoring, payments made by a financial institution based on a payment obligation are not loans using the accounts receivable as collateral, but rather actual sale of a financial instrument, a payment obligation, from the supplier to a participating financial institution.

Suppliers may choose to receive cash for any (or all) of these receivables at any point up until a configurable cut-off date just prior to the original maturity date of each payment obligation. Suppliers, thus, have the option of selling selected accounts receivable embodied in payment obligations from particular buyers rather than merely seeking loans based on individual or bundled accounts receivable.

Within the SCF system, payment cycles are reduced to as little as 48 hours from current terms, which can be as long as 60 days or more. In preferred embodiments, the SCF system is an automated, secure service that is preferably delivered by a virtual private network (VPN), eliminating manual and labor intensive processes.

Benefits

Buyers—The present SCF system enables investment grade and non-investment grade buyers to manage payment terms—without penalizing suppliers—by offering early payment of receivables at low financing rates that have been pre-established by a financial institution or a buyer's own self-funding program. Organizations recognize benefits such as:
1. Improving working capital efficiency
2. Increasing days payables outstanding (DPOs)
3. Creating additional early payment discounts
4. Improving supplier relationships
5. Becoming a low cost customer
   Additionally, many departments recognize the benefits of the SCF system, particularly procurement, treasury and accounts payable.

Suppliers—The SCF system provides suppliers with transaction visibility and payment certainty around approved receivables, reducing the amount of cash tied up in the order-to-cash cycle. Benefits of the solution include:
1. Increase operating capital—the SCF system links the flow of funds to the flow of transaction data and creates visibility into future cash flows. Unlike other alternative financing mechanisms, such as factoring or asset-based lending, the SCF system focuses on approved receivables, not assets such as inventory. As a supplier's A/R volume increases, more operating capital becomes available, and debt-to-equity ratios are vastly improved.
2. Reduce or eliminate early payment discounts—By receiving payments on demand, suppliers can reduce costs and eliminate early payment discounts.
3. No debt on balance sheet—Because the early payment received by suppliers within the SCF system is not a loan, no debt is incurred. More specifically, the early payment program settles the invoice so no debt is incurred.
4. Better balance sheets and stronger credit—The SCF system allows suppliers to maintain a healthier balance sheet, reduce days sales outstanding (DSOs), and improve cash positions. By establishing a consistently positive credit rating, suppliers may qualify for more advantageous terms from buyers and financial institutions.
5. Quick and easy funding—The SCF system is extremely flexible and automates the payables financing and settlement processes. Because the preferred embodiment of the system is web-hosted, no software installation is required and the system is quick and easy to learn and use.
6. Reduce disputes, collection and cash application costs—The SCF system has many benefits due to complete visibility into all invoices that have been paid.
7. Remittance advice—The SCF system allows buyers to provide online remittance details directly to suppliers—safely and securely—in any currency, anywhere, at any time.
8. Streamline A/R and A/P processes between buyers and suppliers—The SCF system allows suppliers to monitor the status of receivables on a daily basis, receive detailed transaction histories and update customer information easily.
9. Ability to discount individual receivables—The SCF system enables suppliers to sell selected payment obligations rather than seek loans for an arbitrary bundle of account receivable.

Financial Institution Benefits—With the SCF system, financial institutions are able to leverage the inefficiencies in the commercial asset based market—primarily receivables and payables-backed lending. Servicing risk and cost are significantly reduced, since the SCF system places the financial institution directly in the middle of the real-time flow of financial information between buyers and suppliers.

A summary of benefits to financial institutions include:
1. Reduced processing costs and improved efficiency. Current business process solutions are sub-optimal and result in high cost, excessive administrative overhead and unnecessarily higher risk to financial institutions. The SCF system enables financial institutions to meet client needs more effectively and at lower cost. Access to information is automated and real-time, thus improving the quality of information and reducing administrative time associated with monitoring the relationship.
2. Improved visibility and reduced risk. The financial institution has a more granular and forward view of credit, default and dilution risk. Information visibility and timeliness has always been the hallmark of risk and cost reduction in the capital markets and most capital markets innovations have come on the heels of such advances in information logistics.
3. Increased lending opportunities and improved profitability. The SCF system delivers significant and immediate competitive advantages to financial institutions by allowing them to deliver on-demand, transaction specific, financial services to clients. Since the SCF platform provides tangible cost savings and generates revenue among trading relationships, the SCF system allows financial institutions to be viewed as a valuable business partner as opposed to an indistinguishable provider of a commodity.
4. Additional revenue at no cost of sale. Through new and/or improved access to the supply chain financial services market, financial institutions gain additional revenue opportunities from new clients at no cost of sale. This not only means greater revenue potential from existing clients, but also that new client opportunities are now possible through additional services offering.
   Architecture and General Processes of the SCF System

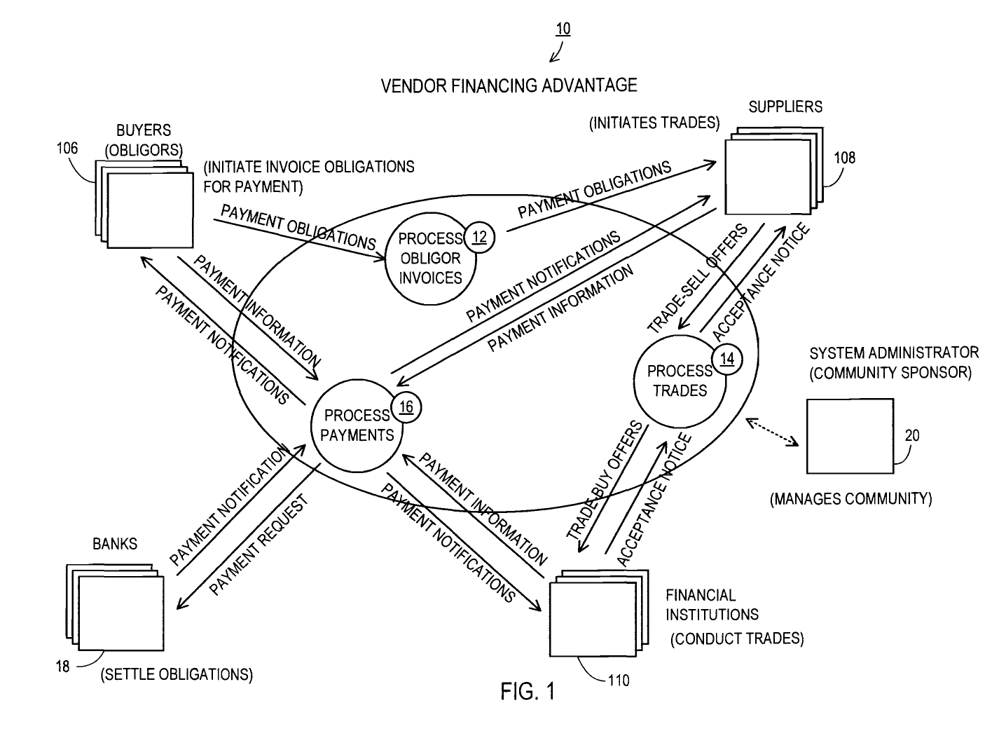

The following provides a logical view of the SCF system by detailing the process flow and describing each participant's role in this process. FIG. 1 describes the parties, components, processes, and information flow within a single community within the SCF system 10.

Preferably, the SCF system 10 is provided as a hosted computer system. Normally, no software needs to be installed on the computer system of any participating buyer 106, supplier 108, or financial institution 110. Preferably, for security purposes, all electronic communications to and from the SCF system 10 use encrypted transmissions over the public Internet, in conventional manner. It should be noted that the SCF system 10 enables cross-border transactions without the use of letters of credit.

The SCF system 10 provides services to groups of customers, each known as a customer community or community. A typical customer community consists of a single large buyer 106 of goods and services (and possibly its affiliated companies (i.e., multiple related buyers); collectively, “buyer”), the suppliers 108 to that buyer 106 (“suppliers”), and financial institutions 110 who may elect to purchase the payment obligations of the buyer 106 to suppliers 108 (“FIs” or “financial institutions”).

As more fully discussed hereinafter, the system administrator or operator 20 of the SCF system 10, or community managers 102 for specific communities enter into agreements with the buyer 106, each supplier 108, and with each financial institution 110. Preferably, each of these agreements is between the SCF system operator (or community manager) and one other party; there are no three-way or four-way agreements. Each financial institution 110 also enters into a receivables purchase agreement (“RPA”) with each supplier 108. The SCF system operator (or community manager) and the buyer 106 are not parties to the RPA.

The following is a list of participants in the SCF system 10 and a general description of their roles:
1. The community manager: Performs all community management tasks including the following:
   a. Sets-up buyer programs—Terms and conditions, rates, distribution of obligations and provides financial settlement initiation and clearing.
   b. Sets-up FIs.
   c. Reports—Develops and makes available various reports to the community participants.
   d. Allows suppliers that have self registered to associate with a buyer program.
   e. Sets-up and maintains users that have the right to set-up and maintain buyer programs/FIs.
   f. Provides an overall transaction management view.
2. Buyers 106: Buyers 106 submit electronic obligations into SCF system 10. Buyers 106 also provide bank account information and other company information as required to enable settlement of obligations to the bearer (FI or supplier) at the maturity date.
3. Suppliers 108: Suppliers 108 submit obligations provided by buyers 106 as trades (sale of obligations) to obtain financing. Suppliers 106 receive the obligation value when entering into a trade less applicable fees and interest. Suppliers 106 submit obligations for trade by bundling obligations into sell offers, which are then presented to financial institutions 110 as buy offers.
4. Financial institutions 110: Financial institutions 110 provide the funding liquidity to the buyer program(s) that they belong to. Financial institutions are system 10 users that accept and purchase buy offers from suppliers 108. The obligations contained in the buy offer will be paid to the financial institution 110 by buyers 106 on their maturity date at the full obligation value. When financial institutions 110 accept buy offers, they are legally obligated to pay the supplier 108 the trade value as stated on the trade offer at time of acceptance.
5. Banks 18: Banks 18 are the monetary institutions that perform the actual transfer of funds and notification of fund transfer to the SCF system 10. Once notified, the system 10 tracks all payments and performs all notifications to the respective system 10 parties, including maintenance of historical information.
   Processes

The processes associated with the SCF system 10 are described as follows.
1. Process payment obligations
   a. The processing of obligations 12 (invoices) typically begins when a payment obligation (PO) is received into a community of the SCF system 10. The PO is received directly from the buyer 106 in an electronic format. The obligation is a legal agreement from the buyer 106 to the bearer to pay the face value of the PO at a defined time (its “maturity date”), i.e., the PO is value and time definite and, in most cases, the buyer 106 can not change either once the PO is received by SCF system 10. The PO represents a financial instrument that is associated with one or more or a portion of one or more underlying accounts receivable. Such association may be based directly on the underlying agreement between the supplier and the buyer or it may be based solely on the underlying agreement between the buyer and the system operators, or some combination of both.
   b. The PO is matched against a supplier 108. If the payment is not matched or a problem exists in the record format or data fields, an exception is created and passed to the community manager and/or buyer 106 for further evaluation.
2. Process trades
   a. The processing of trades 14 occurs once the supplier 108 is matched, the SCF system 10 looks to see if the supplier 108 has auto advance criteria established for that buyer 106. If auto advance rules are established, a sell offer is created and submitted through the SCF system 10, otherwise the supplier 108 must manually create a sell offer using the system 10 functionality. The sell offer indicates the amount the supplier 108 will receive for the invoice, as well as fees and charges associated with the trade. It should be noted that a single sell offer may contain multiple obligations with differing maturity dates.
   b. After a sell offer has been created, it is distributed by the SCF system 10 as a buy offer to the appropriate financial institution(s) 110 for acceptance based on the established method selected for that buyer's 106 buyer program (as will be described in greater detail hereinafter).
   c. The maturity date for each obligation in the trade offer initiates payment to the payee (financial institution 110 or supplier 108) for the full amount of the invoice by the buyer 106. Payments from the buyer 106 to the bearer (financial institution 110 or supplier 108 when an obligation has not traded) is batched and settled at the end of each business day. As above, the necessary information is processed through the buyer program clearing bank account to facilitate payment.
   d. When payments are made by a bank 18 on behalf of any participant in SCF system 10, remittance advice notifications are sent from the bank to the SCF system 10 regarding the payment details. The remittance advice notifications are made up from the ANSI 820s and ANSI 824, which are passed back to the SCF system 10, where they are recorded and communicated to the appropriate parties.
   e. Once the buy offer has been accepted, the supplier 108 then receives notification that the sell offer has been accepted and the status of both the buy offer and the sell offer is changed to accepted. The financial institution 110 is then obligated to pay the supplier 108 the trade value amount (which is less than the value of the payment obligation due to charges imposed by the financial institution 110, the operator of the SCF system 10, and potentially others) contained in the buy offer.
3. Process payment
   a. The processing of payments 16 occurs once the buy offer has been accepted. Upon acceptance of the buy offer, the financial institution 110 is legally obligated to pay the supplier 108 the trade value amount of the buy offer. As stated in other places and as will be appreciated by those skilled in the art, what act constitutes an “acceptance” may be different for different financial institutions and agreed upon by the system. Acceptance of the buy offer initiates payment to the supplier 108 as well as establishing a legal obligation for the buyer(s) 106 to pay the financial institution the full value of all obligations on the buy offer.
   b. The SCF system 10 provides the necessary financial institution 110, supplier 108, and community account information to the payment system to enable the banks 18 to perform the required financial transactions to complete the trade. The supplier 108 receives the trade value of the buy offer and the specified bank account of the financial institution 110 is debited for the trade value along with any fees associated with the trade. The system operators 20 (e.g., community manager and the service provider) also receive payment for assessed fees, if any. Clearing accounts are used to transfer all funds. Additional fees may also be paid to other financial partners such as brokers, self-funded buyers or re-sellers, as non-limiting examples.
   c. The due date for each payment obligation in the trade initiates payment to the financial institution 110 for the full amount of the PO less any fees charged by the community manager and the service provider. As above, the necessary information is passed to the banks 18 to facilitate payment.
   d. When payments are made by the bank 18 on behalf of any participant in the SCF system 10, remittance advice notifications are sent from the bank to the SCF system 10 regarding the payment details. The remittance advice notifications ANSI 820s and ANSI 824 are passed back to the SCF system 10 where they are recorded and communicated to the appropriate parties.
   e. Suppliers 108 that do not elect to trade their obligations are also paid via the SCF system 10. In such cases, the transfer of funds occurs exactly as stated above, and the supplier 108 is paid the full obligation amount from the designated buyer bank account. A clearing account is used to transfer or disburse all funds. As described above and hereinafter, the concept of disbursing funds includes actual disbursement or transfer of funds or the providing of instructions or a request to the appropriate financial institution or bank to wire or transfer funds from one specified account to another in a specific amount and at a specified date/time.
      Buyer Program

The buyer program is a financial mechanism for establishing critical system processing rules from the SCF perspective. Rules are configured in the buyer program that determine the financial aspects associated with system trading and funding. The buyer program allows for configurable functionality such as (1) financial institution pricing profiles, (2) distribution of interest and fee splits between community participants, (3) distribution of buy offers to financial institutions, (4) currencies and time zone, (5) trading windows, (6) time-out values for trade acceptance, (7) participating suppliers and financial institutions, (8) trading limits that protect financial institutions from exceeding monetary thresholds, (9) interest rate display daily, monthly or annually, (10) automatic distribution of sell offers, (11) automatic generation of sell offers, (12) settlement gateways, (13) remittance advice reporting, (14) clearing accounts, (15) distribution of interest and fees to community participants and (16) supplier pricing, among others.

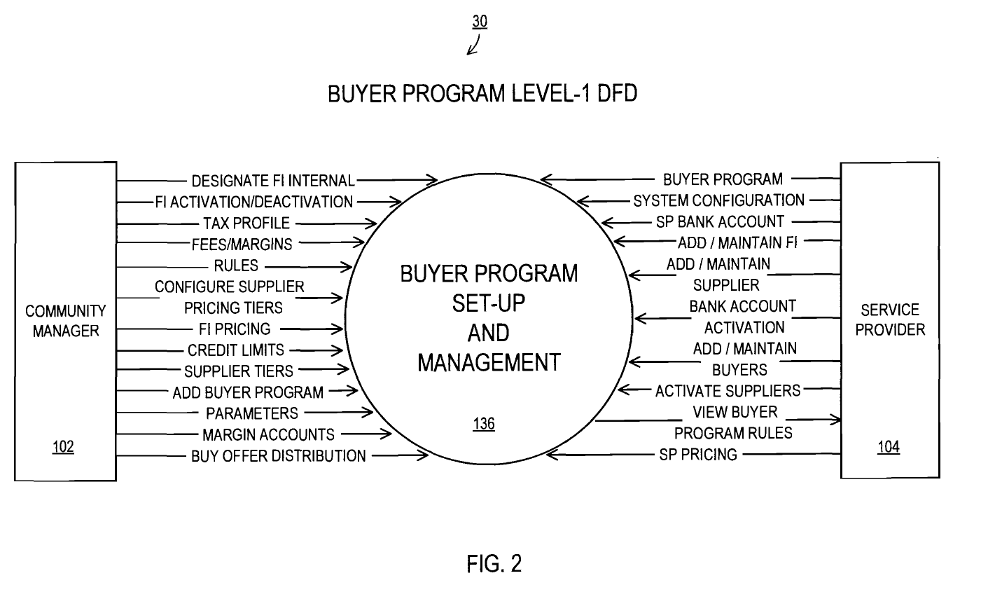

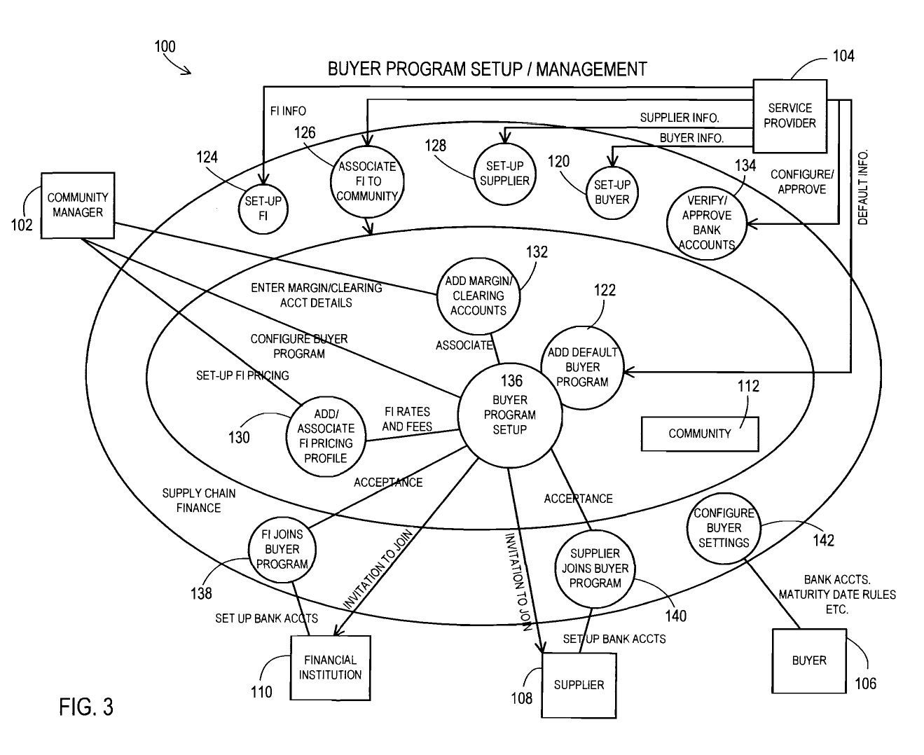

FIG. 2 is a buyer program data flow diagram 30 illustrating data flow transfer from the community manager 102 and the service provider 104 to and from a buyer program setup 136 and management process (see FIG. 3) for the supply chain finance system 10 of FIG. 1. Each data flow may contain one or more parameters, rules or other configuration items.

The buyer program 100 may be configured by a community manager 102 and a service provider 104. The division of duties between the community manager 102 and the service provider 104 are preferably separated with each having independent login components. Upon logging into the system 10, each entity may access the features and functionality directly related to that entity. The service provider 104 has access to the buyer program 100 details for support purpose, but may not modify any financial related fields. The service provider 104 also manages several key buyer program 100 parameters that are operationally related to and necessary for the set-up and operation of the buyer program 100.

In FIG. 2, the data flow between the service provider 104 and the buyer program 100 via buyer program set-up 136 represents those processes that are primarily performed as part of the set-up and system management of a buyer program 100 and those entities associated with the program. They include functionality such as (1) configuration of the buyer program system parameters, (2) service provider (SP) bank account setup and management, (3) adding and maintaining the FI entity, (4) adding and maintaining the supplier entity, (5) viewing bank account activation requests and confirming bank account information, (6) adding and maintaining the buyer entity, (7) activating suppliers to buyer programs once the supplier entity has been set-up, (8) viewing buyer program rules should configuration issues occur that require the service provider's attention, (9) establishing and maintaining the service provider pricing and fee distribution.

In FIG. 2, the data flow between the community manager 102 and the buyer program 100 represents those processes that are primarily performed after the service provider 104 has laid the groundwork for the buyer program 100. They are processes that are independent of those performed by the service provider 104 yet are dependent upon the role of the service provider 104 in the initial set-up and ongoing management of the entities that participate in the program. They include functionality such as (1) designating internal FIs for buyer programs, (2) activating and deactivating FIs to buyer programs, (3) setting up and maintaining tax profiles where applicable, (4) establishing fees and margins for all buyer programs, (5) setting various roles that control how the buyer program processes purchase orders and payments, (6) configuring suppliers into their respective pricing tiers, (7), setting up the default buyer program and related pricing tiers, (8) configuring parameter that control minimum and maximum acceptance levels for credit limits, cut off days etc., (9) setting up and assigning bank accounts, (10) distributing buy offers what require manual distribution.

Buyer Program Set-Up

FIG. 3 is an overview of an exemplary process for the setup and management of a buyer program 100 for financial supply chain management. Setting up and maintaining a buyer program 100 is a series of processes. Although the processes are typically performed in a specific order during initial setup of the buyer program 100, the same processes are also utilized during day-to-day management of the buyer program 100 and may thus be performed in any sequence necessary. A series of setup tasks correspond to each process. Some processes are performed by the service provider 104 while other processes are performed by the community manager 102. Supplier 108, buyer 106 and financial institution 110 entities are also involved during the setup process. It should be understood that the steps for setting up the buyer program 100 may differ from this exemplary embodiment. Some steps may be omitted or additional steps may be included. Additionally, the steps need not necessarily conform to the order given in this non-binding example.

Default Buyer Program Set-Up—Service Provider

A service provider 104 module is used to set up and configure the SCF platform. The SCF platform includes communities, and each community 112 includes one or more buyer programs 100. Buyer program 100 related components include communities 112, suppliers 108, buyers 106, financial institutions 110, default buyer programs and bank accounts.

A service provider 104 setup scenario for a buyer program 100 typically begins with the set-up buyer 120 step. The service provider 104 enters buyer 106 information such as name, address, contact information and user ID.

The add default buyer program 122 step enters parameters that are system 10 related and control trading and funding activities. Other parameters for the new buyer program 100 are included for initializing the currency, service provider bank account, service provider pricing and time zone.

The set-up FI 124 step adds a first time financial institution 110 to the community 112. This step does not apply if an existing financial institution 110 is being used by the buyer program 100. The associate FI to community 126 step links the financial institution 110 to a buyer program 100. At this point, the financial institution 110 does not actually participate, as it has not yet received an invitation to join the buyer program 100.

The set-up supplier 128 step adds and activates suppliers 108 so that they may be associated with the buyer program 100. A buyer 106 may have a large number of suppliers 108 that are not currently on the SCF platform. Suppliers 108 must be added and activated in order to be associated with the buyer program 100. A supplier 108 is added by adding company information and the initial supplier admin user ID. User ID information is typically communicated to the supplier 108 via email. Of course, suppliers 108 that are already added or associated with the buyer program 100 need not be added again. The service provider 104 approves the added suppliers 108 via a web interface before the suppliers 108 can be added to a buyer program 100. Once, the suppliers 108 have been added (if necessary), the service provider 104 accesses the default buyer program and associates the supplier 108 to the buyer program 100. Of course, a supplier 108 that has been previously added may also be associated to the buyer program 100.

In the verify/approve bank accounts 134 step, the service provider 104, verifies that the bank account information and authorization are correct. This step is not normally performed using the web interface; however, once this step has been successfully completed the service provider 104 configures and activates the bank account using the SCF system 10.

Default Buyer Program Set-Up—Community Manager

The community manager 102 performs default buyer program set-up 136 and is responsible for configuring and updating buyer programs 100. Before suppliers 108 can trade, the initial setup configures and activates the buyer program 100 with at least one supplier 108 and one financial institution 110 active. Once the buyer program 100 is active, the community manager 102 continues to monitor and manage the program using tools provided on the SCF platform.

A community manager 102 setup scenario for a default buyer program 100 begins with the add/associate FI pricing profile 130 step. The community manager 102 has access to an FI pricing profile list 204. The FI pricing profile list 204 provides access to the details of the FI pricing profiles 208 and rate history 206. The FI pricing profile 208 contains the pricing provided to the financial institution 110 as part of the funding process. Included are rates, fees and margin basis points that the financial institution 110 receives when accepting a buy offer. It should be noted that if a suitable FI pricing profile 208 exists, then the add/associate FI pricing profile 130 step may be skipped.

The add margin/clearing accounts 132 step will add margin and/or clearing accounts if they do not yet exist. The community manager 102 uses the margin/clearing account feature to add new accounts. Of course, if the margin/clearing accounts already exist, then the add margin/clearing accounts 132 step may be skipped.

Parameters within the buyer program 100 are initialized during buyer program set-up 136. These parameters are discussed in further detail below and occur within the buyer program tab, the pricing tab, the distribution tab, the financial institutions tab, the supplier tab and the set-up supplier pricing tiers tab.

During buyer program set-up 136, buyer program tab parameters including company details, buyer program details, buyer program parameters, restrict auto advance rules, community manager details and interest calculation rules are initialized.

During buyer program set-up 136, pricing tab parameters including void if not traded flag, associate the FI pricing profile, net community margin, supplier transaction fee, target credit capacity, daily maturity limit, cut off days, maturity cut off days, reserve, margin account, trading clearing account, maturing clearing account, rate display, tax profile, minimum amount (sell offer) and maximum amount (sell offer) are initialized.

During buyer program set-up 136, distribution tab parameters including rotation and manual are initialized. The rotation parameter is initialized when more than one financial institution 110 is included in the buyer program 100. The manual parameter is initialized when the community manager 102 distributes buy offers.

During buyer program set-up 136, financial institutions tab parameters including deactivate FI, add FI and modify rotation sequence are initialized.

During buyer program set-up 136, the supplier tab parameters regarding the capability of the community manager 102 to move suppliers 108 between pricing tiers.

During buyer program set-up 136, add buyer program capability allows the community manager 102 to set-up supplier pricing tiers. The supplier pricing tiers allow for further defining the buyer program 100 into buyer program pricing tiers 214. The community manager 102 may organize suppliers 108 into separate tiers and assign different rates and fees to each tier.

It should be noted that aside from the pricing tab and the financial institution tab, buyer program pricing tier 214 parameters are typically inherited from the default buyer program 100.

Buyer Program Set-Up—Financial Institution

Once the service provider 104 has associated the financial institution 110 to the buyer program 100, the financial institution 110 receives an invitation to join. As part of the sign-up process, the financial institution 110 will use the portfolio manager 503 user interface (discussed below) to join the buyer program 138 and to set important buyer program 100 parameters, including bank account information, contact information, duplicate payment obligation and community manager processing, credit memo and payment obligation maturity correction, credit limits, auto accept rules and interest calculation rules.

Buyer Program Set-Up—Supplier

Once the service provider 104 has associated the supplier 108 to the buyer program 100, the supplier 108 receives an invitation to join. As part of the sign-up process, the supplier 108 will use the activate buyer program user interface (discussed below) to join the buyer program 140. Additionally, the supplier 108 performs any administrative tasks such as auto advance and bank account set-up.

Buyer Program Set-Up—Buyer

The buyer 106 does not have to register for the buyer program 100. Several setup tasks are necessary for the buyer 106 and are set via configure buyer settings 142, including set maturity dates, auto correct maturity dates and bank accounts.

Buyer Program Entities

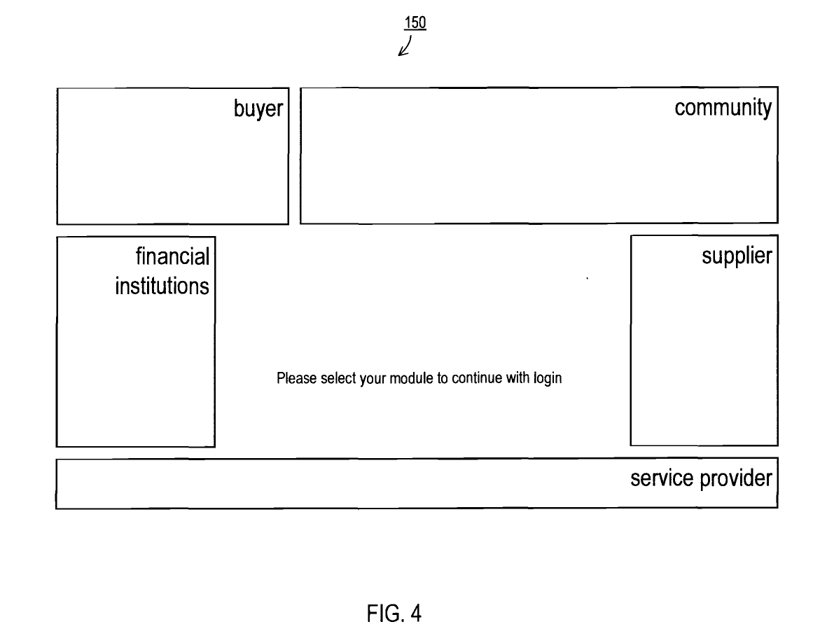

FIG. 4 is an exemplary user web page of the buyer program entities 150 and illustrating the entity log-in feature of the buyer program 100. The buyer program entities 150 for the SCF platform allows for separation of duties for each entity involved in the setup and management processes. A separate user interface exists for each community entity. A user may select the components for buyer 106, community 112, financial institutions 110, supplier 108 and service provider 104. The web page interface for each entity as it relates to the buyer program 100 are discussed below and describe the unique buyer program 100 components as utilized in the SCF platform.

Community Manager

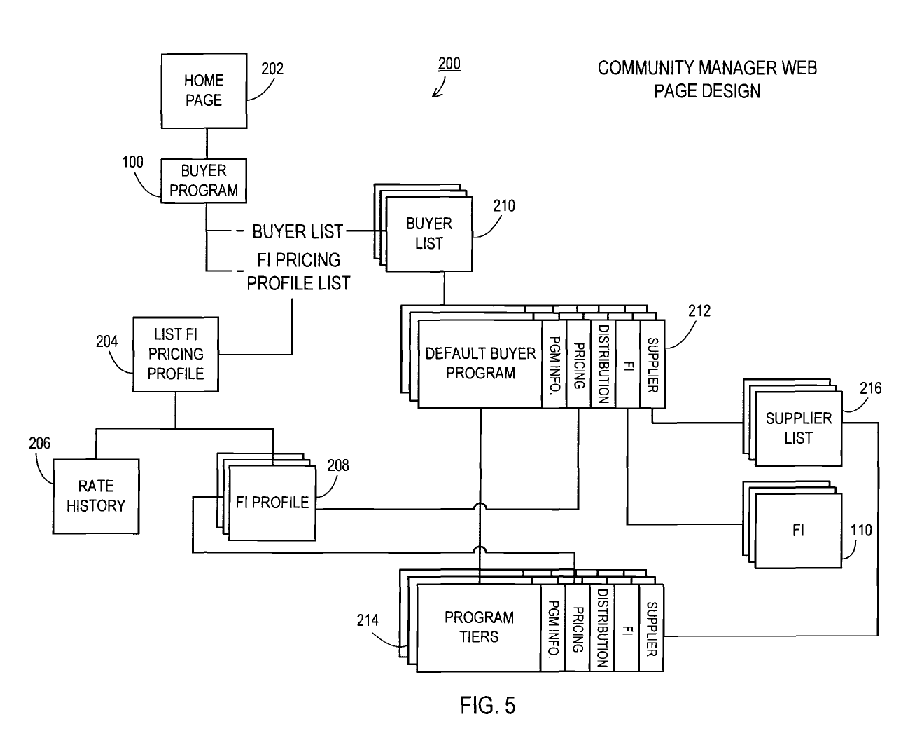

FIG. 5 is a diagram illustrating buyer program community manager web page features 200. The community manager home page 202 contains a buyer program buyer list 210 and summary buyer information that pertains to all buyer programs 100 for that buyer 106. Additionally, the community manager 102 may access the buyer programs 100 for each buyer 106 displayed or add a buyer program 100 for the desired buyer 106.

Buyers 106 are given in the buyer program buyer list 210 and may have multiple buyer programs 100 and have the capability to organize suppliers 108 in the supplier list 216 into different buyer program pricing tiers 214 for the same buyer 106. Buyer program 100 capabilities also provide for association of a unique FI pricing profile 208 to any buyer program pricing tier 214 within a buyer program 100.

The community manager 102 may add FI pricing profiles 208 and view rate history 206. Additional pricing capability related to the buyer program pricing tiers 214 may also be added. Buyer program 100 capabilities also provide for association of a unique FI pricing profile 208 to any buyer program pricing tier 214 within a buyer program 100.

From the buyer program 100, the community manager 102 can view a supplier list 216 containing suppliers 108 that are available to the buyer program 100. From the buyer program interface 212, the community manager 102 can group suppliers 108 into buyer program pricing tiers 214 so that suppliers 108 having been assigned to that profile receive specific financial pricing considerations including but not limited to cut off days before maturity, FI base rate profile, gross community margin, total supplier tier pricing, fixed rate selection, net community margin, supplier transactions fee.

Further details regarding the community manager 102 functionality are discussed below in conjunction with the exemplary screen images for that particular functionality.

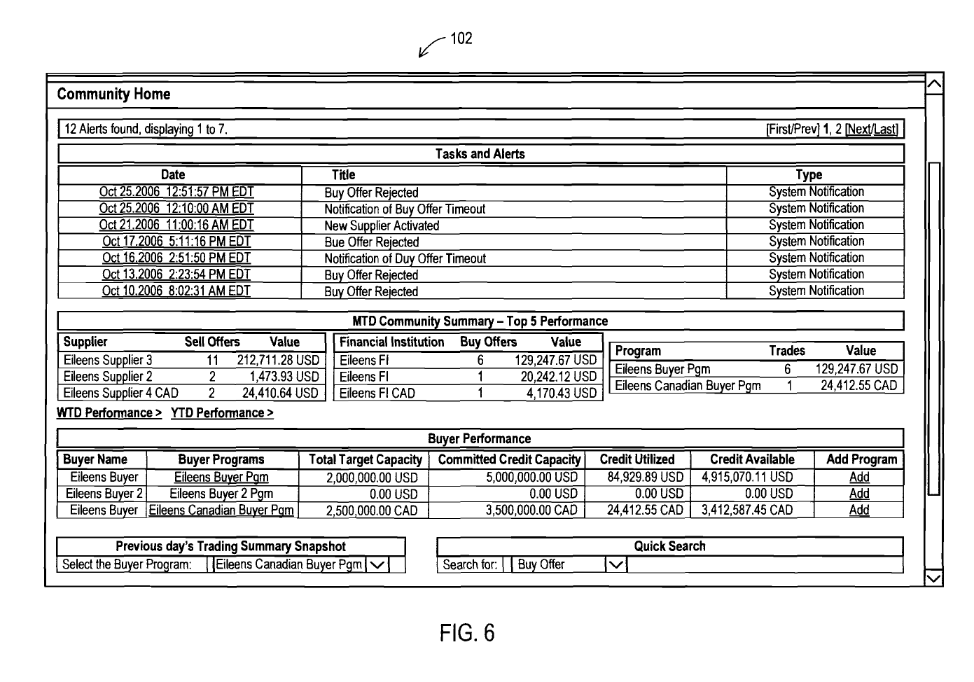

FIG. 6 is an exemplary screen image of the community manager home page 218. Summary buyer information pertaining to all buyer programs 100 for that buyer 106 is presented. In addition, the community manager 102 may access the list of buyer programs for each buyer 106 displayed or add a buyer program 100 for the desired buyer 106. The summary information presented includes (1) a table of tasks and alerts, (2) MTD community summary containing performance summaries of buy offers, sell offers and trades, (3) buyer performance summary, (4) previous day's trading summary snapshot and (5) a quick search capability.

Buyer performance displayed below the MTD community summary enables visibility and access to the buyer programs 100 for that particular buyer 106. The total number of sell offers and the cumulative value of those offers are displayed for each supplier 108. The total number of buy offers and the cumulative value of those offers are displayed for each financial institution 110. The total number of trades and the cumulative value of those trades are given for each buyer program 100.

The section for buyer performance presents summary information for a buyer 106 including buyer name, buyer programs, total target capacity, committed credit capacity, credit utilized and credit available. An add program selection allows for adding buyer programs 100 for the selected buyer 106.

Parts of the summary information presented on the community manager home page may be shown as hyperlinks indicating that further information may be accessed regarding that particular information. For example, buyer programs 100 are presented in the buyer performance section. Selecting one of the buyer programs 100 will open information about that particular buyer program 100.

FI Pricing Profile

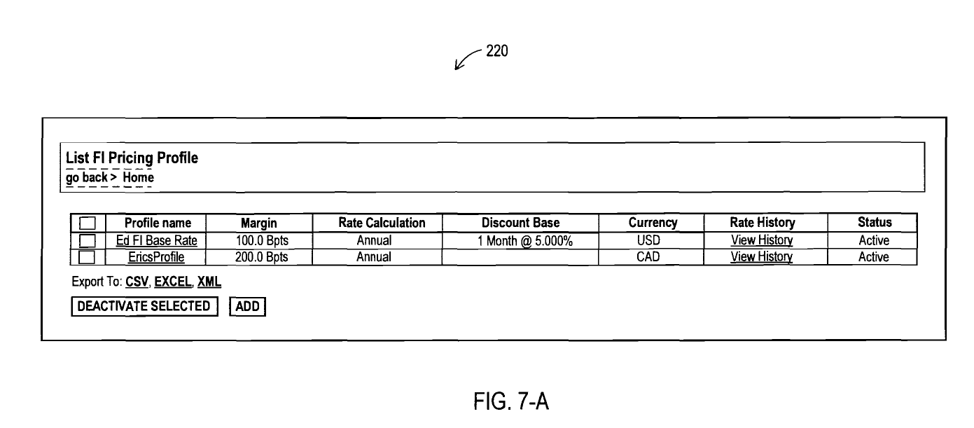

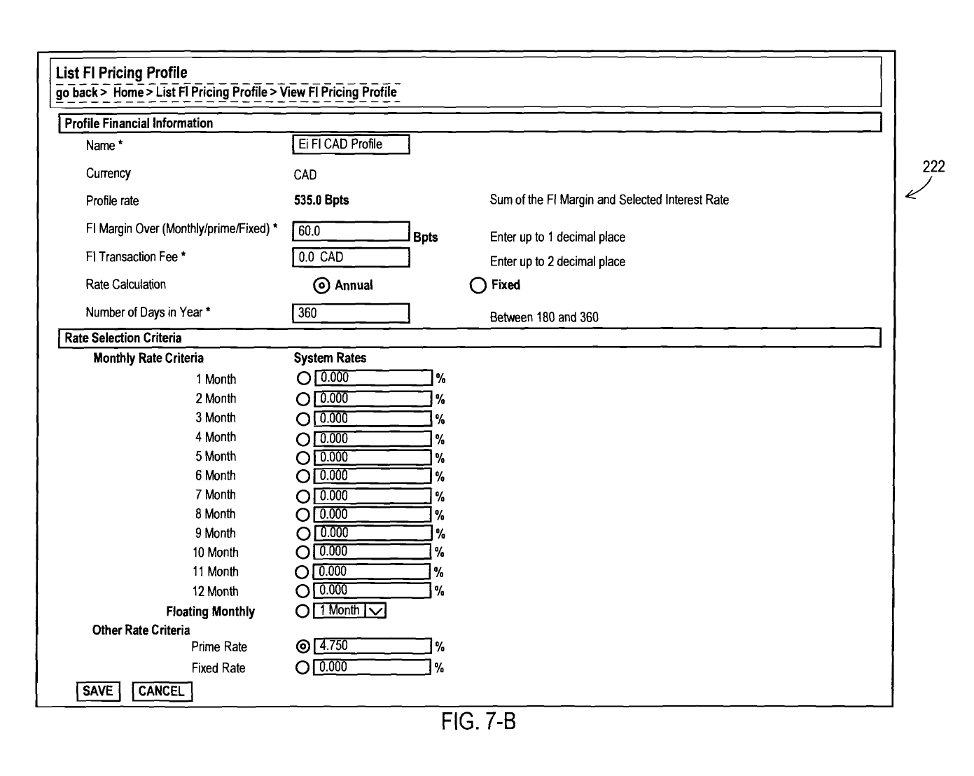

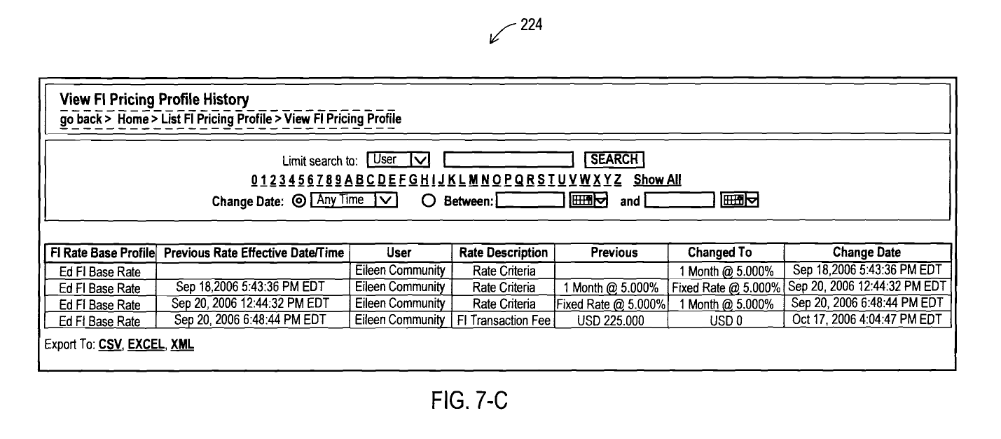

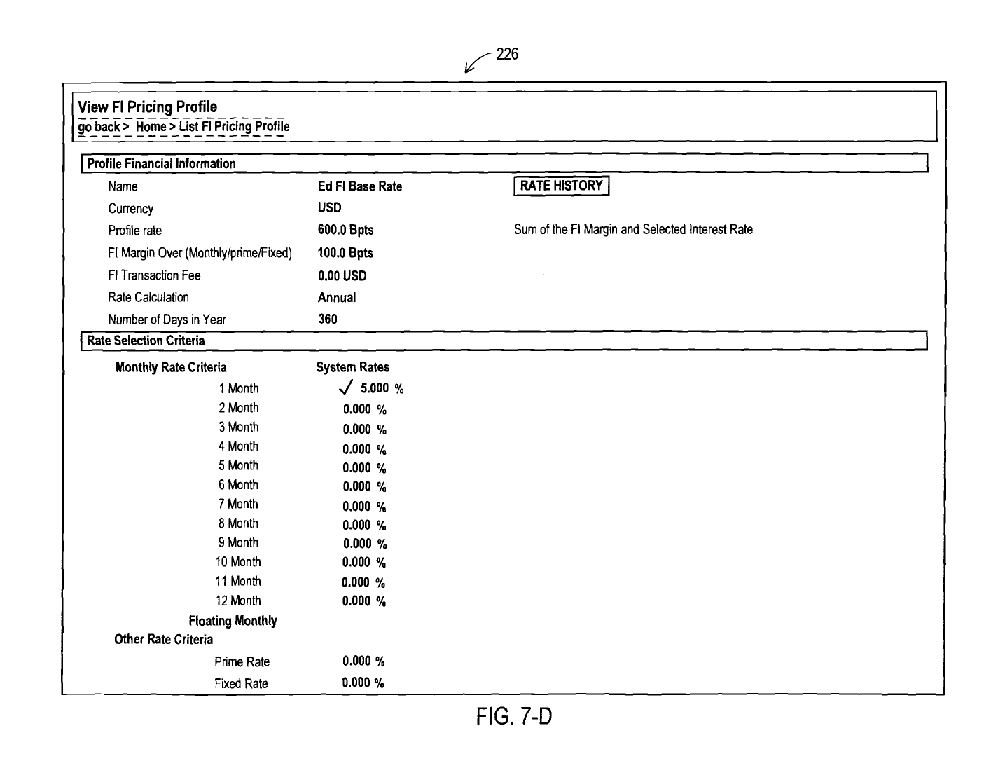

FIG. 7-A is an exemplary screen image of the list FI pricing profile 220 functionality. The FI pricing profile provides the buyer program 100 with the rates and fees associated with the financial institutions 110 participating in the buyer program 100. The FI pricing profile is associated to the buyer program 100 by the community manager 102.

The list FI pricing profile web page is accessed from the buyer program 100 pull down menu. The list page enables the community manager 102 to view an FI pricing profile list 204, access and change profile details and add a new FI pricing profile 208.

An FI pricing profile 208 may be added by selecting add button on the list FI pricing profile web page. The FI pricing profile 208 allows the community manager 102 to set up a single pricing profile and use it across any number of buyer programs 100. The pricing profile is discussed in greater detail below.

FIG. 7-B is an exemplary screen image of the edit FI pricing profile 222 functionality. The edit FI pricing profile web page is accessed from the list FI pricing profile web page via selecting the particular FI pricing profile 208 from the list. Profile financial information and rate selection criteria may be specified.

Profile financial information includes the name of the profile, the currency specified, the profile rate in basis points, the FI margin over (monthly/prime/fixed) in basis points, the FI transaction fee, the rate calculation (annual or fixed) and the number of days in year for the rate calculation.

Rate selection criteria specifies the interest rate for each month (1 month, 2 month, etc.) and other rate criteria such as prime rate.

FIG. 7-C is an exemplary screen image of the view FI pricing profile history 224 functionality. Rate history 206 is maintained of all changes to the FI pricing profile and can be accessed from the list of FI pricing profiles (see FIG. 7-A). The rate history 206 may also be accessed from the view FI pricing profile page (see FIG. 7-D below).

The rate history 206 displays the previous rate and the changed to rate for all rate categories. History entries also include date/time stamp and the name of the user initiating the change. A search capability is also available.

FIG. 7-D is an exemplary screen image of the view FI pricing profile 226 functionality. Information regarding profile financial information and rate selection criteria is displayed. The FI pricing profile information, as set in the edit FI pricing profile web page (see FIG. 7-B), is displayed. As noted above, the FI pricing profile history may be accessed via the rate history 206 selection.

If the FI pricing profile is changed, then pricing for all buyer programs 100 related to that pricing profile is also changed. The FI pricing profile is currency specific and is assigned to a particular buyer program 100 when the buyer program 100 currency setting matches the FI pricing profile setting. The FI pricing profile provides the FI pricing for the buyer program 100 and determines the interest rate, FI fees (if any) and the FI margin.

As noted above, the profile financial information includes the name of the profile, the currency specified, the profile rate in basis points, the FI margin over (monthly/prime/fixed) in basis points, the FI transaction fee, the rate calculation (annual or fixed) and the number of days in year for the rate calculation. The FI pricing profile is currency specific and matches that of the associated buyer program 100. The profile rate is specified in basis points and is the sum of the FI margin and the rate selection criteria. The FI margin over is the margin that the financial institution 110 will receive over the monthly/prime/fixed rate that is selected. For example, if the fixed rate is set at 6% and the FI margin over is 100 basis points, then the profile rate will be 700 Bpts (basis points). The FI transaction fee is charged to the financial per transaction. The FI transaction fee is a flat fee that is distributed across the number of invoices in the trade. The rate calculation can be annual or fixed. For an annual rate calculation, the rate is spread across the total number of days remaining to maturity. For a fixed rate calculation, the rate is applied against the entire amount and the days to maturity are not considered. The number of days in year is used to specify the number of days when calculating an annual rate.

The rate selection criteria specifies the interest rate for each month (1 month, 2 month, etc.) and other rate criteria such as prime rate. The monthly rate criteria provides for 12 months of interest rates. When the month is checked, the interest rate for that month is applied regardless of the number of days remaining to maturity. Selecting the floating monthly option allows the rate to change based on the days to maturity. For example, if the payment obligation is over 90 days old but less than 120 days old, then it will receive the 4 month rate. If one or more months are left blank then the next non-blank month will be used. (For example, if 1 month has a rate of 3%, 2 month is blank, and 3 month has a rate of 4%, then any payment obligation over 30 days and less than 90 days to maturity will receive the 3 month rate.)

The other rate criteria fields are for entering the prime rate and a fixed rate. Only one of the two may be selected and the fields are mutually exclusive with the monthly rate criteria.

Buyer List

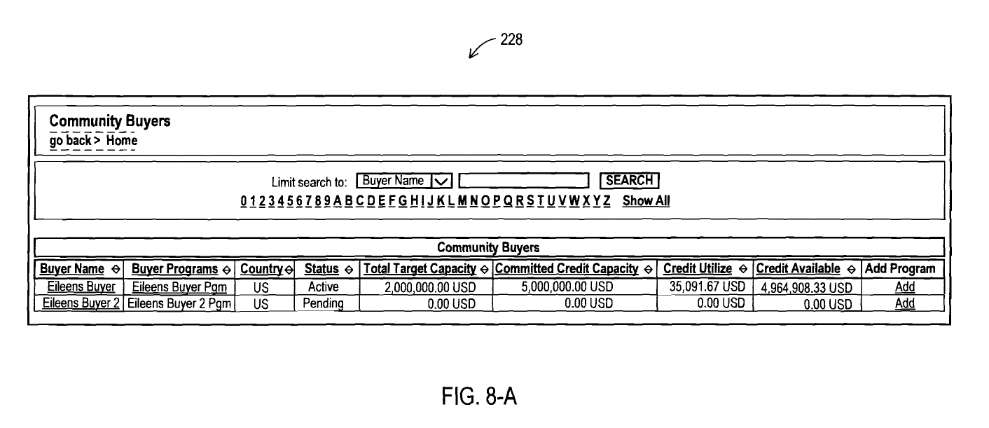

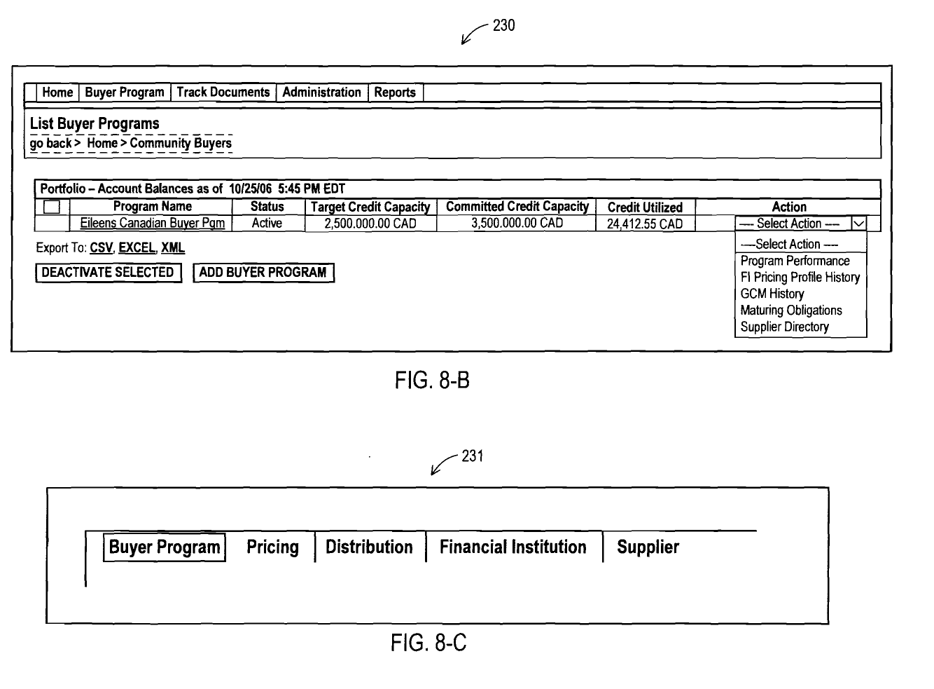

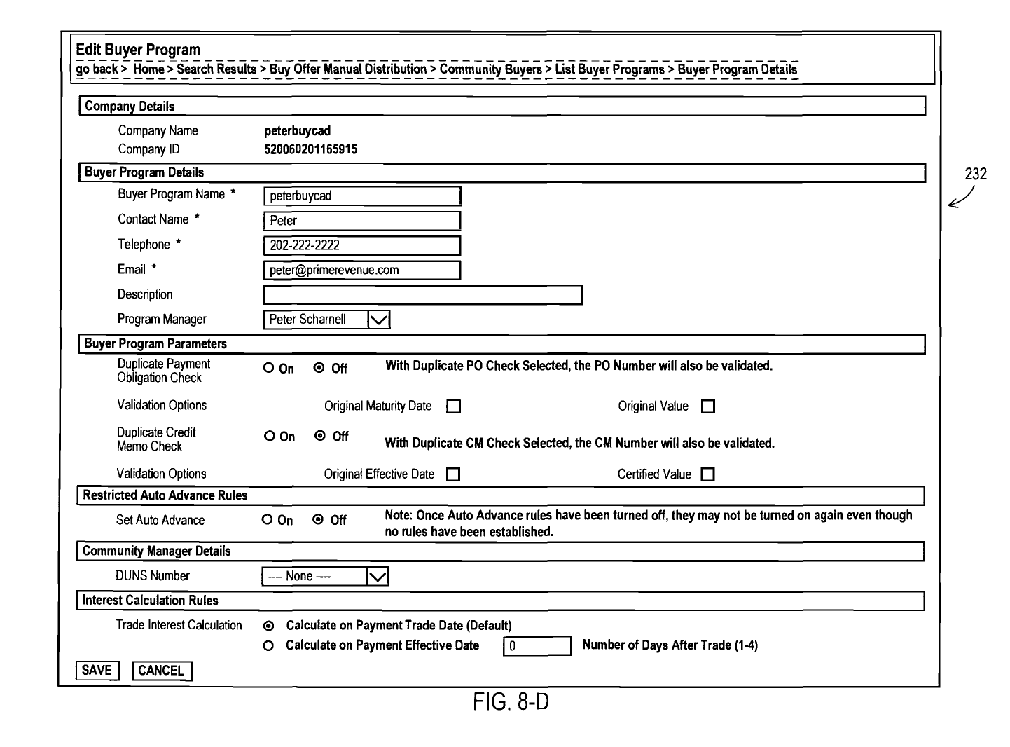

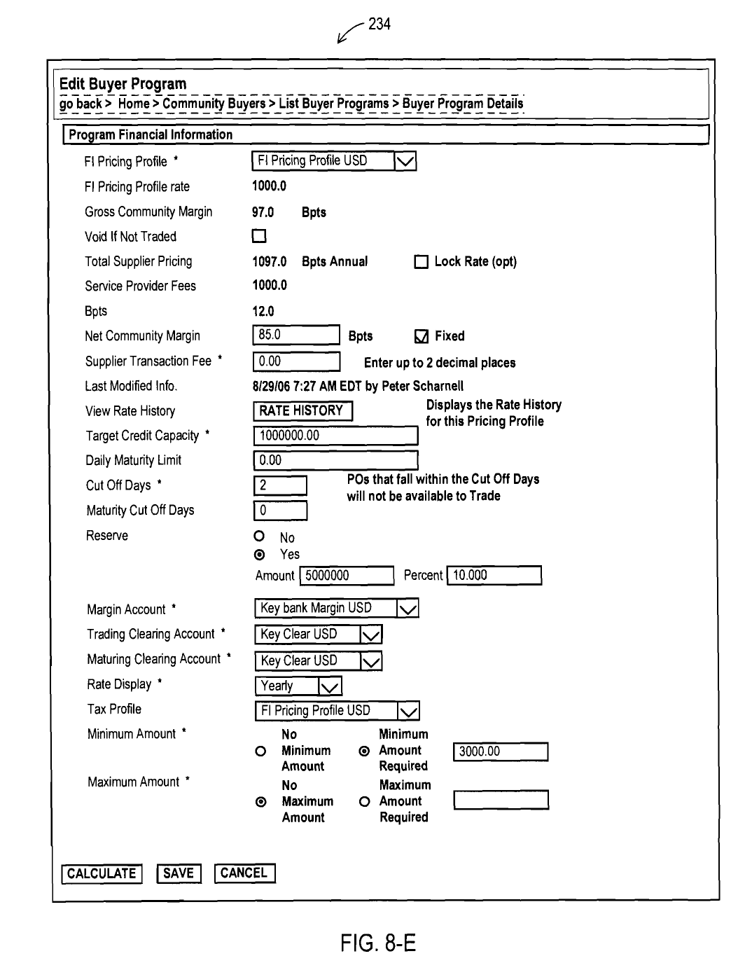

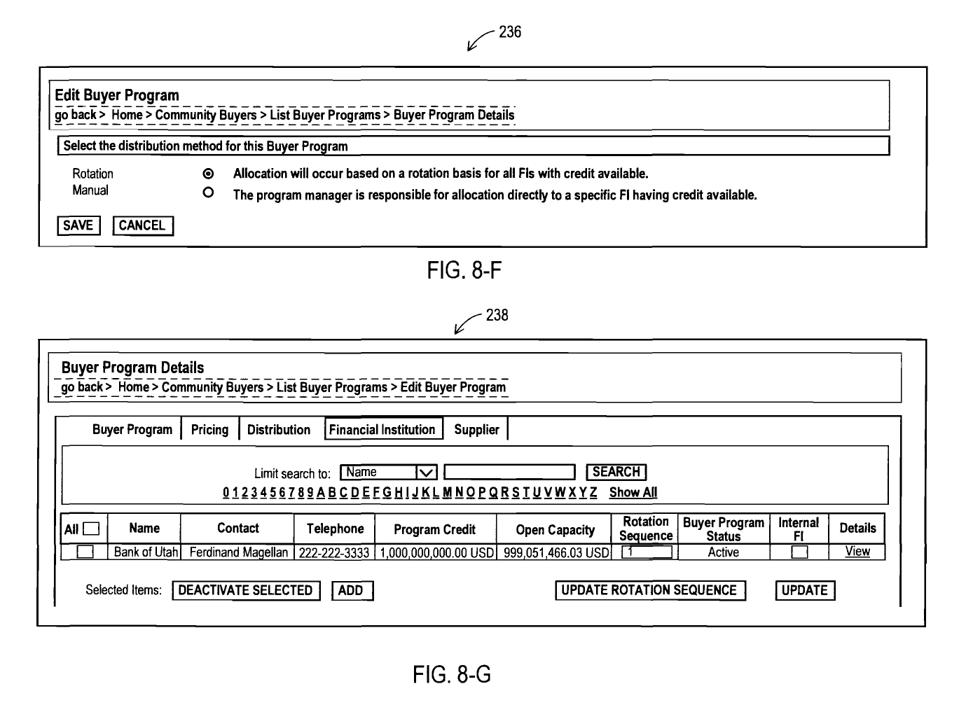

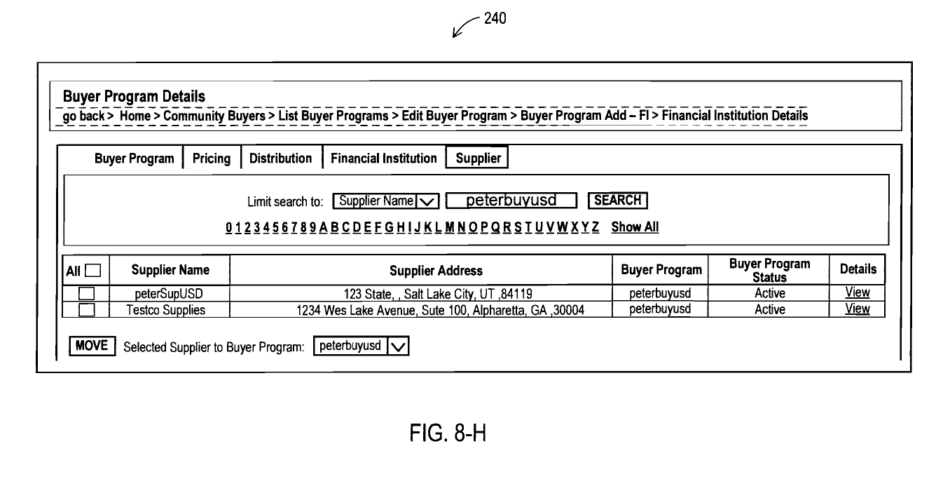

FIG. 8-A is an exemplary screen image of the community buyers web page 228 and contains a list of buyers 106 and the associated default buyer program 100 for each. Summary information for the buyer 106 and the associated buyer program 100 is provided including the country of origin, status (active, pending, etc.), total target capacity, committed credit capacity, credit utilized and credit available. Additional buyer programs 100 may be added for each buyer 106.

Buyer Programs List

FIG. 8-B is an exemplary screen image of the list buyer programs web page 230. The buyer program list page may be accessed from the community buyer list page (see FIG. 8-A) or from the community manager home page (see FIG. 6). The buyer programs list page enables the community manager 102 to (1) search and find default buyer programs 100, (2) view buyer program 100 and buyer program pricing tier 214 details, (3) deactivate buyer programs 100 and buyer program pricing tiers 214 (4) add buyer programs 100 and buyer program pricing tiers 214.

Buyer Program

When a buyer program 100 is first added, it is a default buyer program 100. A buyer 106 may have multiple default buyer programs 100. Each of the multiple default buyer programs 100 may have a different specified currency and some or all of the multiple default buyer programs 100 may have the same currency. The default buyer program 100 may be further subdivided into sub-programs or buyer program pricing tiers 214. The community manager 102 may utilize pricing tiers to organize suppliers 108 under different pricing profiles for the same buyer 106.

Multiple Buyer Programs for a Buyer

The default buyer program 100 has features not available to a buyer program pricing tier 214, and are used to (1) manage the financial institutions 110 participating in the buyer program 100, (2) manage the financial institution 110 distribution criteria, (3) provide default pricing information to buyer program pricing tiers 214 at the time they are added and (4) join financial institutions 110 to the default buyer program 100. Buyer program pricing tiers 214 are the other buyer programs 100 that are added to the customer's initial default buyer program 100. It should be noted that the service provider 104 adds the initial default buyer program 100 and the community manager 102 updates that program and, if needed, adds buyer program pricing tiers 214 as sub-programs under the default buyer program 100.

When first added, buyer program pricing tiers 214 contain the default buyer program 100 financial institutions 110, distribution and pricing. Buyer program pricing tiers 214 may view only financial institution 110 information and distribution type. Suppliers 108 may be moved to and from buyer program pricing tiers 214 to default buyer programs 100. Pricing information may be changed on any or all buyer program pricing tiers 214.

Configuring the Default Buyer Program

FIG. 8-C is an exemplary screen image of the buyer program tabs 231 representing the areas of the buyer programs 100. A default buyer program 100 can be accessed from the community manager home page, from the community buyer list or the buyer program list through the buyer program interface 212. The buyer program 100 is segmented into five areas or tabs containing information related to (1) buyer program information, (2) pricing, (3) distribution, (4) financial institution and (5) supplier. The buyer program information contains general information about the buyer program 100. The pricing tab is used to apply fees and rates when trades occur. The distribution area is used to determine how trades are distributed to the various financial institutions 110 participating in the buyer program 100. The financial institution tab provides for changing financial institution 110 information in initial or default buyer programs 100. The supplier tab provides for adding suppliers 108 to a buyer program 100 or assigning suppliers 108 to other buyer programs 100.

Configuring the default buyer program 100 is performed by completing information in each of the five tabs discussed above. Information about the buyer program 100 is entered by a user and configuration is complete when the relevant information for each tab has been entered and then selecting the next button after the information has been entered. The buyer program 100 is not configured properly until the required information in the buyer program tab is completed and the next button is pressed. The back button may be used to toggle through the tabs. It should be noted also that the community manager 102 may begin configuring a buyer program 100 and exit at any time after completing the buyer program tab. If the buyer program tab has been completed, then the community manager 102 may return later to complete the configuration. The buyer program 100 is considered active when the community manager 102 has added a financial institution 110 to the buyer program 100.

Editing the Buyer Program

FIG. 8-D is an exemplary screen image of the edit buyer program screen 232. Having selected the buyer program tab, the user may then edit information relating to the buyer program 100. The company information for the particular buyer 106 is shown at the top of the screen. The user may edit the (1) buyer program details, (2) buyer program parameters, (3) restricted auto advance rules, (4) community manager details and (5) interest calculation rules.

The buyer program details include the contact information for the buyer program 100, and include the buyer program name, a contact name, a telephone number, an email address, an optional description and an optional program manager. It should be noted that the program manager appears in a pull down menu, allowing for the possibility that a single program manager may manage multiple buyer programs 100.

The buyer program 100 parameters determine whether checks for duplicate payment obligations and duplicate credit memos will be performed. If the duplicate payment obligation check is turned on, then the system 10 will check for duplicate payment obligations during import. The system 10 will check for duplicate payment obligation numbers and will validate against the validation option that is selected. The validation option for duplicate credit memo check will be either original effective date or certified value. When more than one validation option is chosen, the payment obligation must match on all options chosen in order to be rejected. For example, if duplicate payment obligation check is on and original effective date is checked, then a payment obligation will be rejected if it has the same payment obligation number and effective date. If only one of the two is the same, then the payment obligation will be imported.

If the duplicate credit memo check is turned on, then the system 10 will check for duplicate credit memos during import. The system 10 will validate against the validation option that is selected. The validation option for the duplicate payment obligation validation will be either original maturity date or original value. When more than one validation option is chosen, the credit memo must match on all options in order to be rejected. For example, if duplicate credit memo check is on and original maturity date is checked, a credit memo will reject only if it has the same credit memo number and maturity date. If only one of the two is the same, then the credit memo will be imported.

The restricted auto advance rules set parameters for the automatic creation of buy orders. If auto advance is set to “On”, then the auto advance fields can be modified. As is shown in FIG. 8-D, if the auto advance is set to “Off”, then the rules do not appear on the screen. The auto advance rules provide for a minimum amount, a maximum amount, date (any day, within range of maturation, specific dates), payment obligation amount (up to 10 search criteria contained in the payment obligation number) and schedule dates (every day or specific dates). It should be noted that the auto advance option can be set to “On” for an initial or default buyer program 100 (the first buyer program 100 entered for the buyer 106), otherwise the auto advance option is “Off”. Subsequent pricing profiles (based on the default) may enter additional restrictions or may set the option to “Off”. Once turned off for any buyer program 100, the auto advance option can not be turned back on. (For more details, see “Enhanced auto advance features” in the “Additional Features of the Buyer Program” section below.)

The community manager details provides for selecting the DUNS number.

The interest calculation rules determine the date that the system 10 utilizes for calculation of interest for a trade. Selecting the payment trade date is the default, and causes the system 10 to calculate interest as of the trade date. Selecting the payment effective date provides for interest to be calculated as of a specified number of dates after the trade date. The number of days after trade (1-4) is entered in the box shown and is required if the payment effective date is selected.

FIG. 8-E is an exemplary screen image of the buyer program pricing screen 234 of the buyer program 100. The user is allowed to modify program financial information such as the FI pricing profile, FI pricing profile rate, gross community margin, void if not traded, total supplier pricing, service provider fees, Bpts, net community margin, supplier transaction fee, last modified info, view rate history 206, target credit capacity, daily maturity limit, cut off days, maturity cut off days, reserve, margin account, trading clearing account, maturing clearing account, rate display, tax profile, minimum amount and maximum amount.

The FI pricing profile is selected from a dropdown list. FI pricing profiles are established during the FI pricing profile setup in the community manager 102 module.

The established FI pricing profile rate shown is the sum of the FI margin and the FI rate.

The gross community margin shown is the sum of the net community margin and the service provider basis points (Bpts).

Selecting the void if not traded box will cause all payment obligations to be voided that are not traded on the day that they are uploaded to the system 10. The default value is for the void if not traded box to be unselected.

Total supplier pricing is the sum of the FI pricing profile rate and the gross community margin. Selecting the lock rate checkbox will cause the rate to be locked.

The service provider fees are derived from the community pricing profile assigned to that community 112 to which the buyer program 100 belongs. The service provider fees shown are the established service provider basis points. The amount is estimated and based on the service provider pricing tiers. Service provider pricing tiers are established through the community pricing profile functionality in the service provider 104 module.

The net community margin is either a fixed amount or determined by an algorithm based on the gross community margin, FI pricing profile rate and the service provider fee. If the fixed check box is selected, then the net community margin can be entered as a fixed value. (For more details, see “Fixed net community margin” in the “Additional Features of the Buyer Program” section below.)

An optional supplier transaction fee is entered in the box shown and may be entered with up to two decimal places. The supplier transaction fee is a fixed amount per transaction and is charged at the time of the trade.

The last modified info shows the date, time and user name of the most previous modification of the pricing profile.

Selecting the rate history button causes the rate history 206 for the pricing profile to be displayed. Rate history 206 captures the details of all rate changes.

The target credit capacity for the buyer programs 100 is entered in the box shown. The amount entered does not affect system events but is for informational purposes only. The value entered represents the available credit capacity goal as determined by the community manager 102.

The daily maturity limit is entered as a dollar amount in the box shown and represents the maximum value of payment obligations that can mature in a single day. The supplier 108 can not submit a sell offer containing payment obligation(s) maturing on any day that would exceed this limit. Excess payment obligations are modified to mature on the next business day. If a value of zero is entered, the maximum value allowed to mature in a day is unlimited. (For more details, see “Daily maturity limit” in the “Additional Features of the Buyer Program” section below.)

The cut off days for a sell offer are entered in the box shown. The system 10 will validate the number of maturity days of payment obligations within a sell offer before generating it into a buy offer. The payment obligation maturity dates within a trade must be greater than this number of cut off days. Payment obligations that fall within the cut off days are not available to trade and are not visible on the available to fund page.

Maturity cut off days for trading are entered in the box shown. The system 10 validates that the number of maturity days of any payment obligations are less than or equal to this value before displaying them on the available to fund screen. (For more details, see “Added maturity cut off days” in the “Additional Features of the Buyer Program” section below.)

The reserve for the buyer program 100 may be selected (yes) or not selected (no). An amount (dollar or other currency) or a percentage is entered in the box if the reserve is selected. It should be noted that the reserve functionality combines with credit memos to prevent the buyer 106 from going into a net negative balance with their suppliers 108 due to trading. The reserve allows either an amount or percentage of invoices for a supplier 108 to be held back so that they can not be traded. The non-traded amount is used to offset credit memos that may come in for that supplier 108 throughout the month.

A margin account may be selected from a pull down menu of bank accounts for the buyer program fees. Margin accounts are established as part of the bank account setup by the community manager 102. To be available for selection, the bank account must also be validated by the service provider 104.

A trading clearing account for the buyer program 100 must is selected from a pull down menu of bank accounts for the buyer program 100. Clearing accounts are established as part of the bank account setup by the community manager 102. To be available for selection, the bank account must also be validated by the service provider 104.

A maturing clearing account is established for the buyer program 100 and selected from a pull down menu of bank accounts. Clearing accounts are established as part of the bank account setup by the community manager 102. (For more details, see “Clearing accounts” in the “Additional Features of the Buyer Program” section below.) To be available for selection, the bank account must also be validated by the service provider 104.

The rate display for the supplier 108 is selected from a pull down menu. Choices include a daily, monthly or yearly display rate. This field determines how the supplier 108 sees the discount rate during trading.

A tax profile for the buyer program 100 is selected from a pull down menu. Tax profiles are set up by the service provider 104 using an out of system 10 process. Tax profiles that are set up by the service provider 104 are available for selection. (For more details, see “Tax reporting functionality” in the “Additional Features of the Buyer Program” section below.)

A minimum amount required for a trade may be selected. If a minimum amount is required by selecting the option, then that amount may be entered in the box shown. The no minimum amount should be selected if no minimum trade amount is desired. If a minimum amount is entered, then no sell offers may be submitted less than this amount.

A maximum amount required for a trade may be selected. If a maximum amount is required by selecting the option, then that amount may be entered in the box shown. The no maximum amount should be selected if no maximum trade amount is desired. If a maximum amount is entered, then no sell offers may be submitted greater than this amount.

The calculate button is provided to enable the user to calculate the rates and perform an integrity check prior to initiating the change. Once the user is satisfied with the rates entered, the “submit” button can be selected to initiate the change.

FIG. 8-F is an exemplary screen image of the distribution screen 236. The distribution screen is selected by selecting the distribution tab shown in FIG. 8-C. The method is selected for distributing buy offers to the financial institution 110. The distribution methods available are rotation or manual. It should be noted that for single financial institution 110 buyer programs 100, the rotation option should be selected. Selecting the manual option causes the community manager 102 to be responsible for allocating sell offers to specific financial institutions 110. It should also be noted that the rotation option can only be changed in an initial or default buyer program 100—the first buyer program 100 entered for the buyer 106—through the buyer program interface 212. Subsequent buyer program pricing tiers 214—those based on the default buyer program 100—will inherit this value from the default. (For more details, see “Buy offer distribution methods” in the “Additional Features of the Buyer Program” section below.)

FIG. 8-G is an exemplary screen image of the financial institution screen 238. The financial institution screen is displayed by selecting the financial institution tab shown in FIG. 8-C. The financial institution tab provides the community manager 102 with the capability to manage the financial institutions 110 associated with that buyer program 100. From the financial institution 110 page, the community manager 102 can deactivate one or more FIs, add an FI to the buyer program 100, change the rotational sequence, designate a single internal FI and view FI details.

Changing the financial rotation sequence controls the distribution of buy offers to the financial institutions 110.

Selecting the checkbox in the internal FI column corresponding to a particular financial institution 110 provides for making or changing a financial institution 110 to an internal FI. Internal FIs are self funding buyers. An internal FI is a buyer 106 acting as a financial institution 110 when accepting trades from their suppliers 108. (For more details, see “Internal/external financial institutions” in the “Additional Features of the Buyer Program” section below.)

Details for a financial institution 110 may be viewed by selecting the view hyperlink in the details column.

A financial institution 110 for the buyer program 100 may be deselected by selecting the checkbox in the “all” column next to the financial institution 110 to be deactivated and then selecting the “deactivate selected” button. Selecting the checkbox next to “all” will cause all the checkboxes next to the respective financial institutions 110 to be checked. Selecting the “deactivate selected” button would then cause all financial institutions 110 for this buyer program 100 to be deactivated.

A financial institution 110 may be added to the buyer program 100 by selecting the “add” button. A list of available financial institutions 110 will be presented. Financial institution(s) 110 may be selected by selecting the check box corresponding to the financial institutions 110 to be added. Selecting the accept button will cause the selected financial institutions 110 to be added to the buyer program 100. The financial institution 110 receives an alert from the SCF system 10 notifying the financial institution 110 that they have been invited to join the buyer program 100. The financial institution 110 will not be active in the buyer program 100 until accepting the invitation and registering with the buyer program 100. It should be noted that the community manager 102 can only assign financial institutions 110 that have been setup within the service provider 104 and then assigned to the community 112 by the service provider 104. It should also be noted that financial information can only be changed on an initial or default buyer program 100—the first buyer program 100 entered for the buyer 106. Subsequent pricing profiles—those based on the default—inherit the financial institution 110 information from the default.

FIG. 8-H is an exemplary screen image of the supplier screen 240. The supplier screen is selected by selecting the supplier tab shown in FIG. 8-C. The supplier tab enables the community manager 102 to organize the buyer program 100 suppliers 108 into buyer program pricing tiers 214. The primary function of the supplier tab is to move a supplier(s) 108 between the default buyer program 100 (via the buyer program interface 212) and buyer program pricing tiers 214 and to view the supplier details.

Service Provider

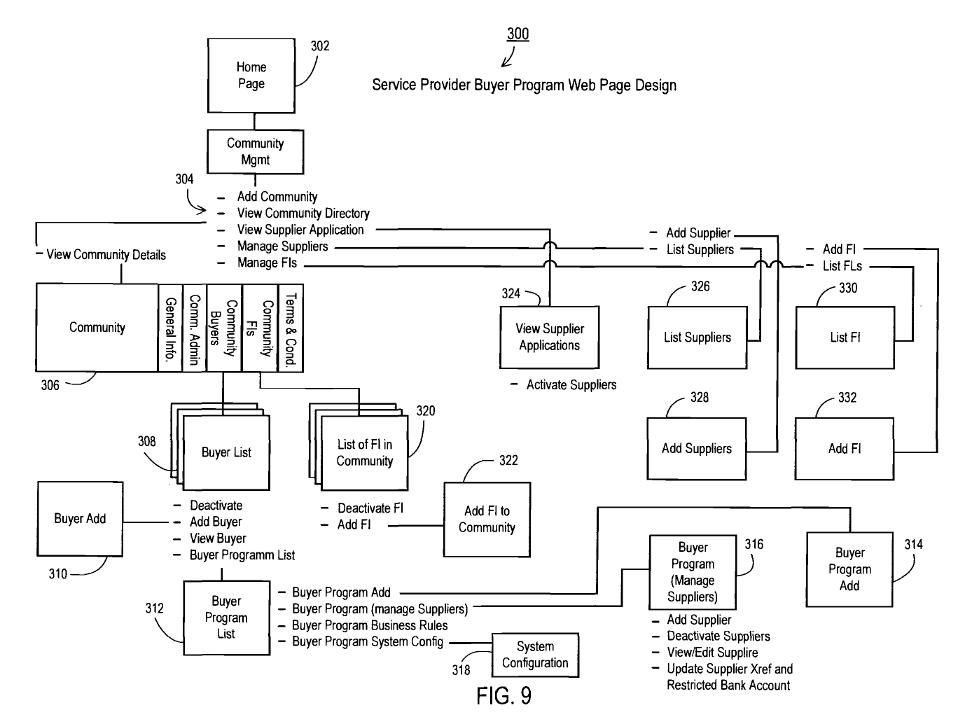

FIG. 9 is a diagram illustrating buyer program service provider web page features 300. The buyer program service provider home page 302 provides for performing buyer program 100 related tasks. From the service provider interface 304, the service provider 104 can add communities 112, add buyers 106 to a community 112, add the default buyer program 100 for the new buyer 106, configure the buyer program system related parameters, add financial institutions 110, add suppliers 108, view and approve supplier applications, associate suppliers 108 to buyer programs 100, and view and manage bank account applications.

More specifically, the service provider 104 can add communities 112, view community details through the community interface 306, view and approve supplier applications 324, manage suppliers 108 and manage financial institutions 110. (For more details, see “Multiple communities within the SCF platform” in the “Additional Features of the Buyer Program” section below.)

From the community interface 306, the service provider 104 may access the community buyer list 308 and the list of FIs in the community 320. From the community buyer list 308, the service provider 104 may deactivate buyer(s), buyer add 310, view buyer details and access the buyer program list 312. From the buyer program list 312, the service provider 104 may perform buyer program add 314, access buyer program (manage suppliers) 316, access buyer program business rules and perform buyer program system configuration 318. Managing suppliers 108 through the buyer program (manage suppliers) 316 interface allows the service provider 104 to add suppliers, deactivate suppliers, view and edit suppliers, update supplier cross-references and restricted bank accounts. From the list of FIs in the community 320, the service provider 104 may deactivate financial institutions 110 and add FI to the community 322.

The view supplier applications 324 interface allows the service provider 104 to view supplier information and activate suppliers 108.

The service provider 104 manages suppliers 108 through the list suppliers 326 interface and the add supplier 328 interface. The service provider 104 manages financial institutions 110 through the list FI 330 interface and the add FI 332 interface.

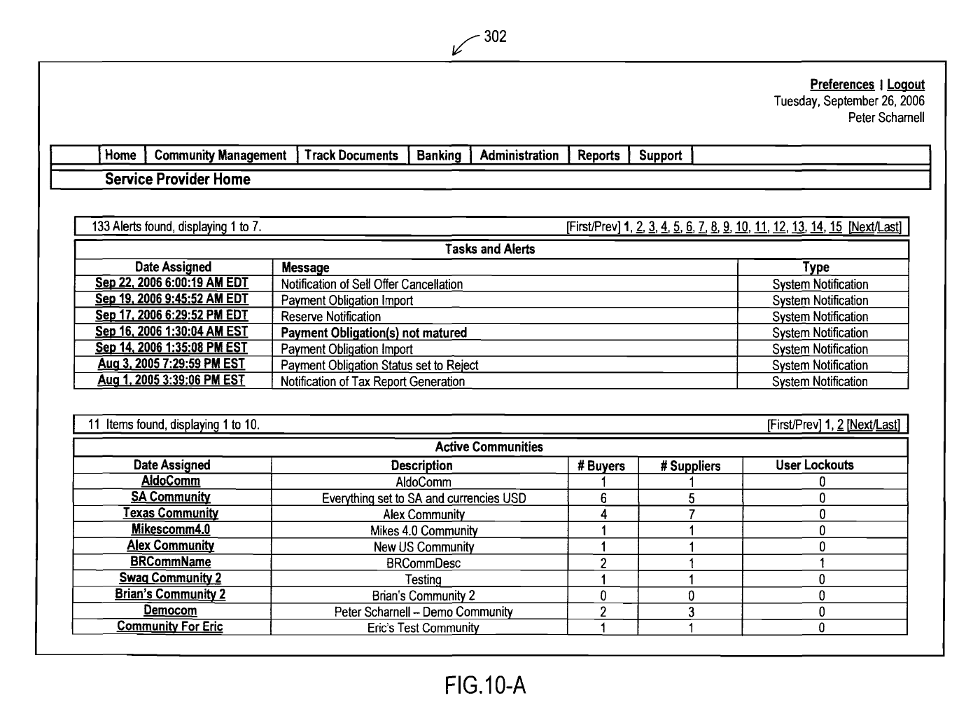

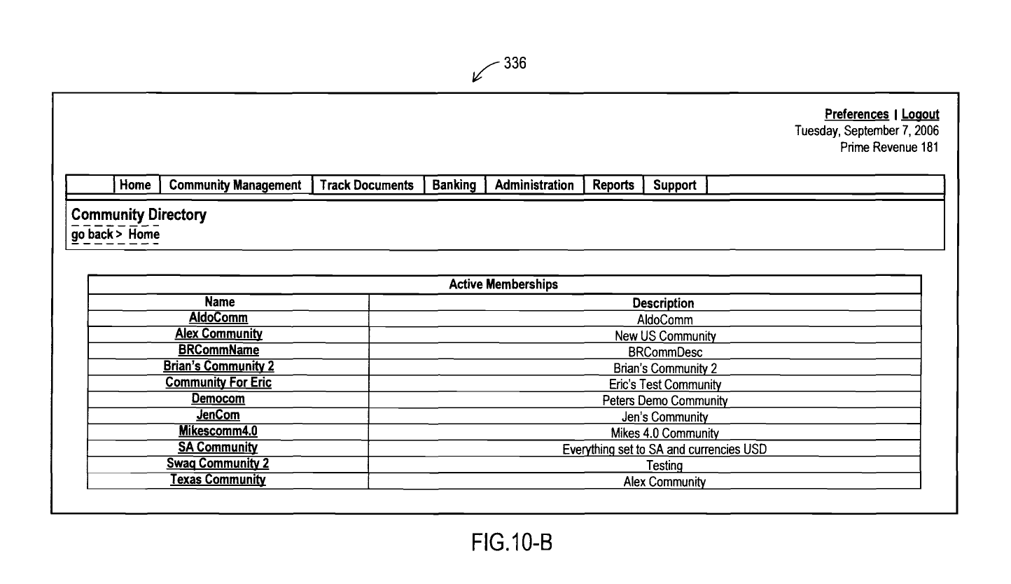

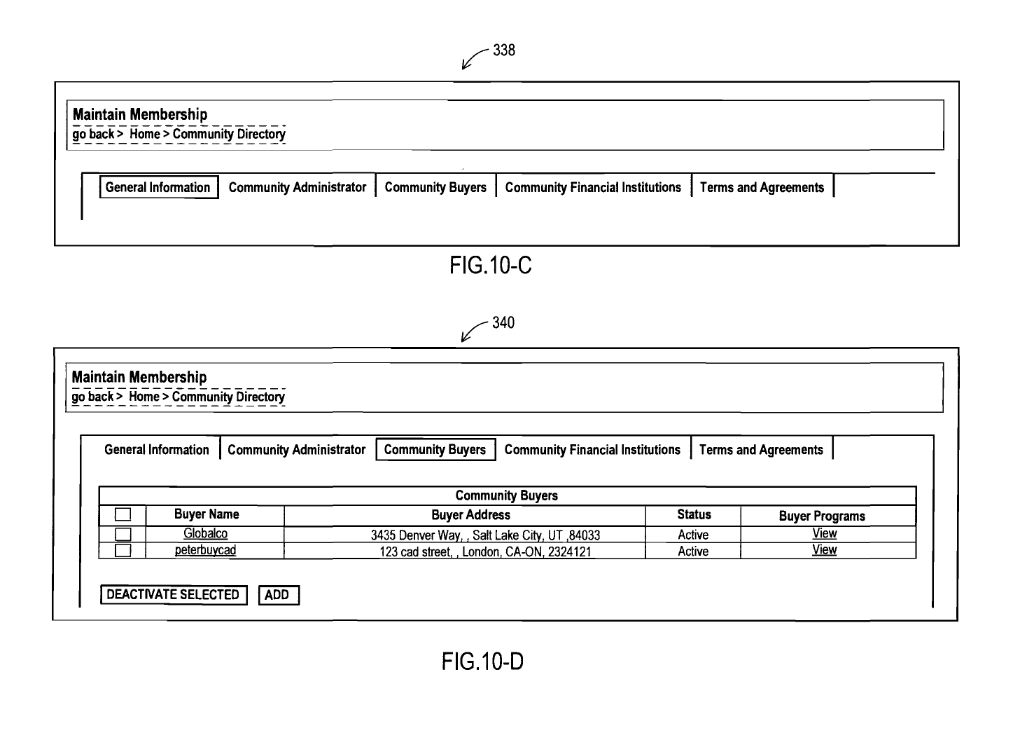

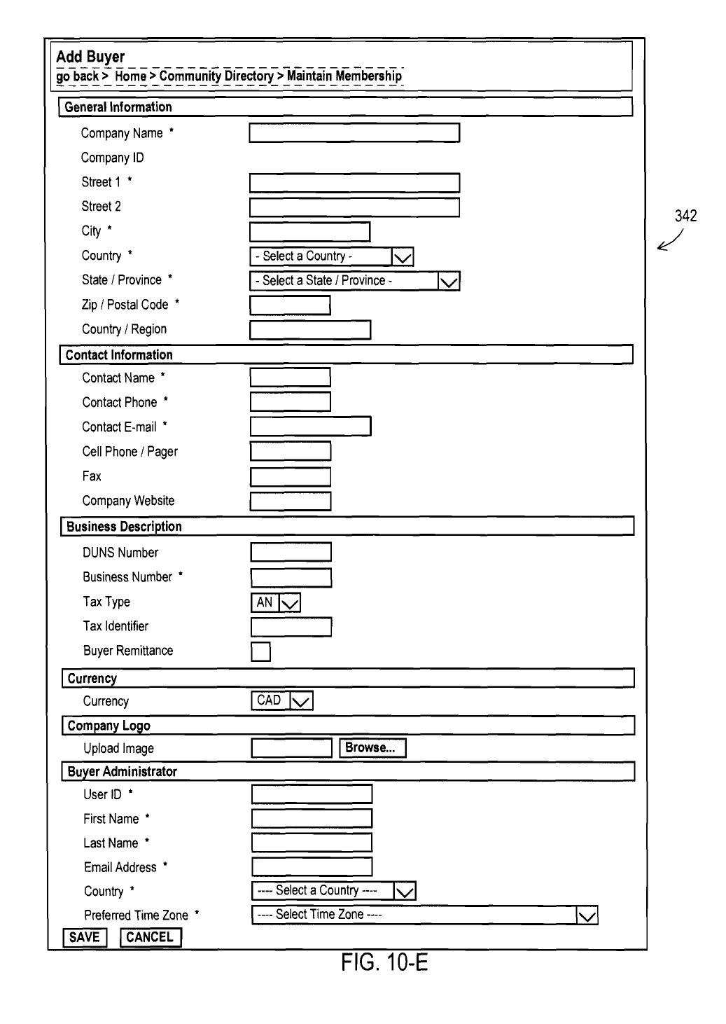

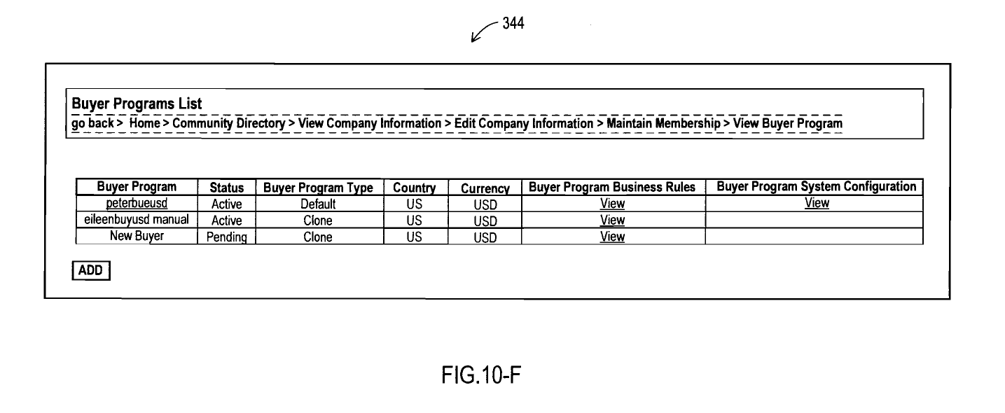

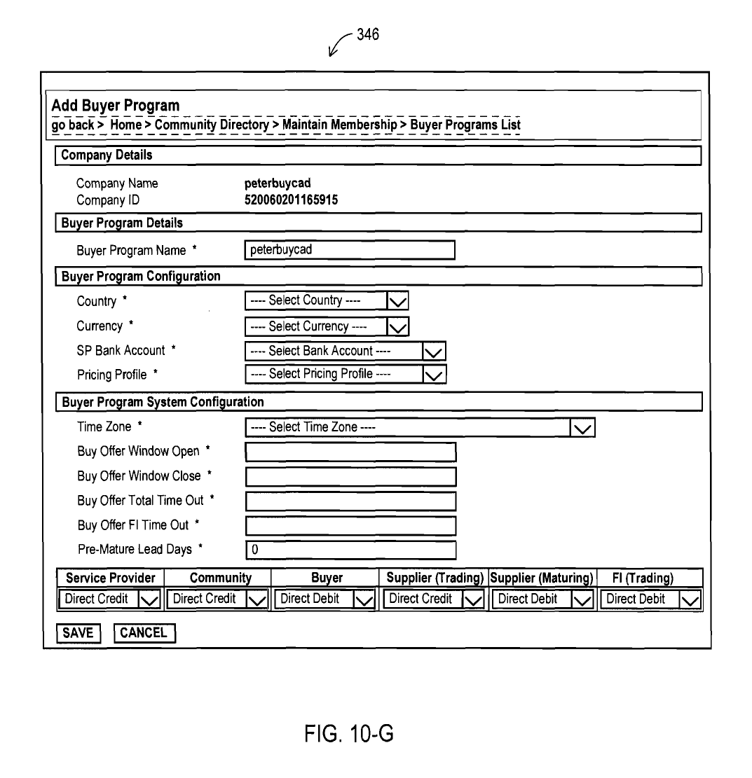

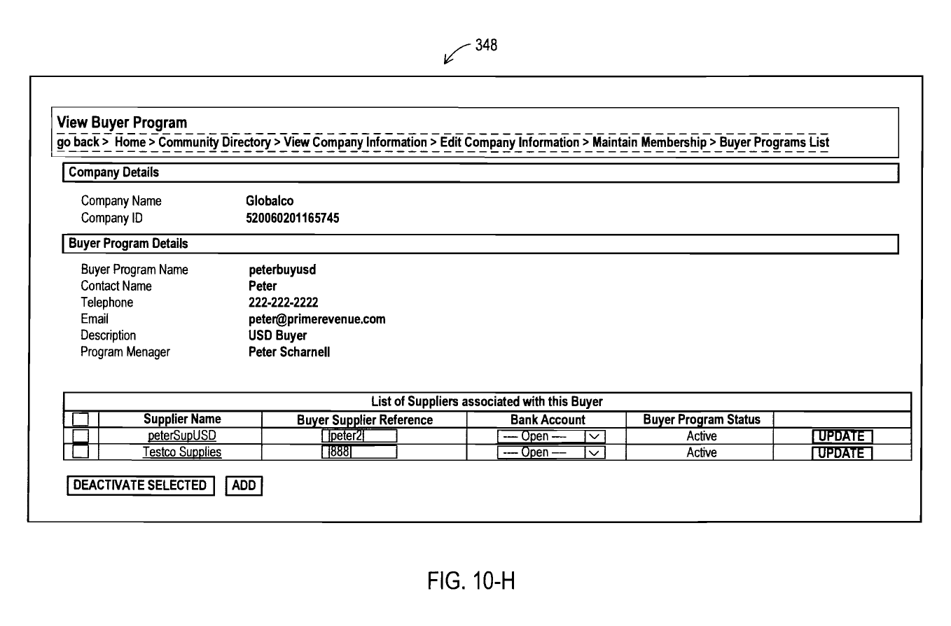

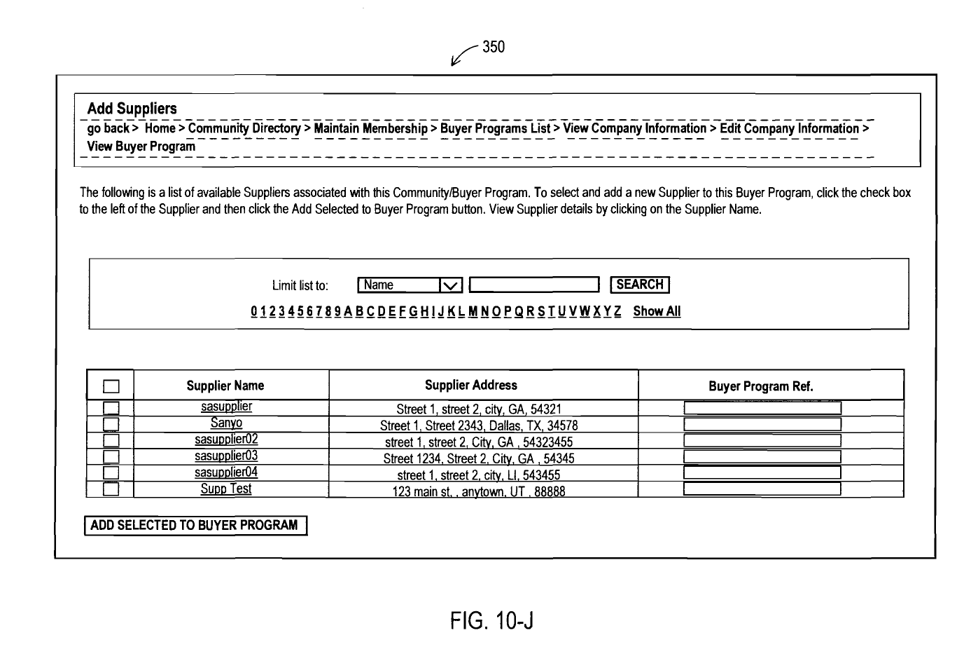

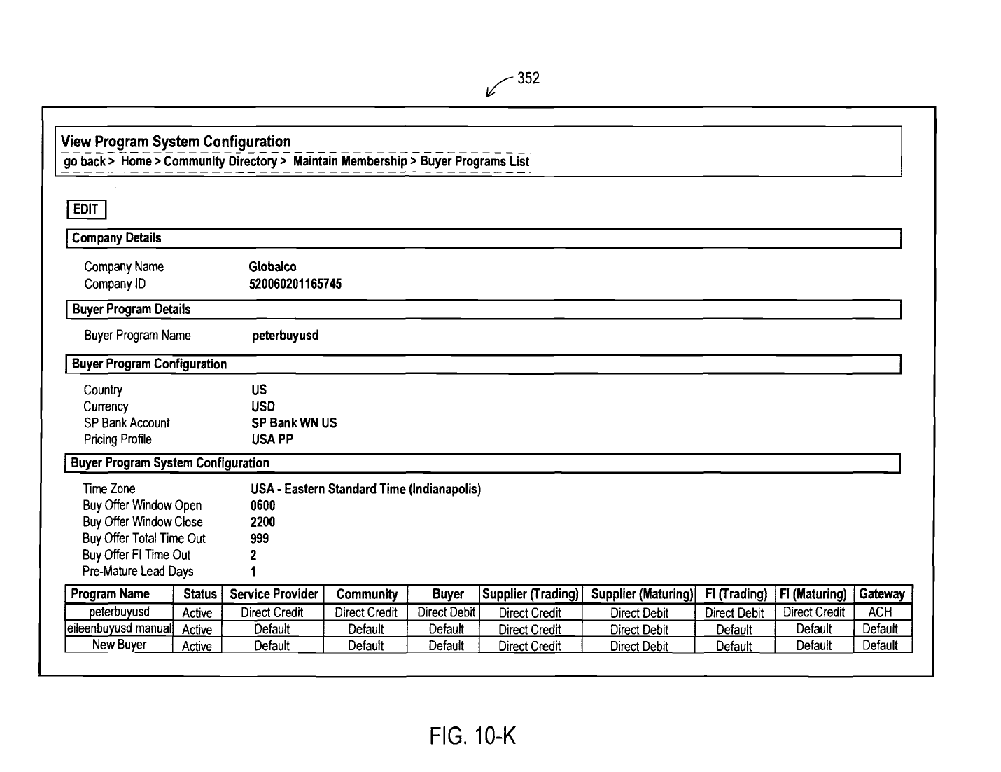

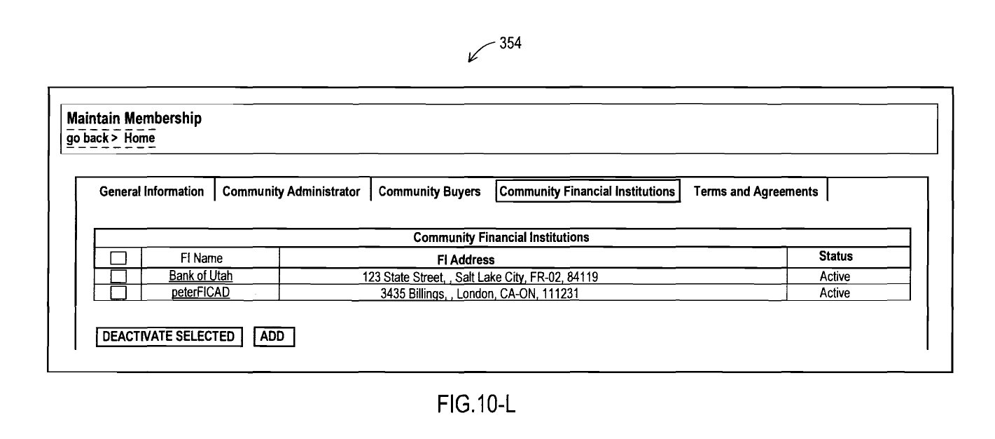

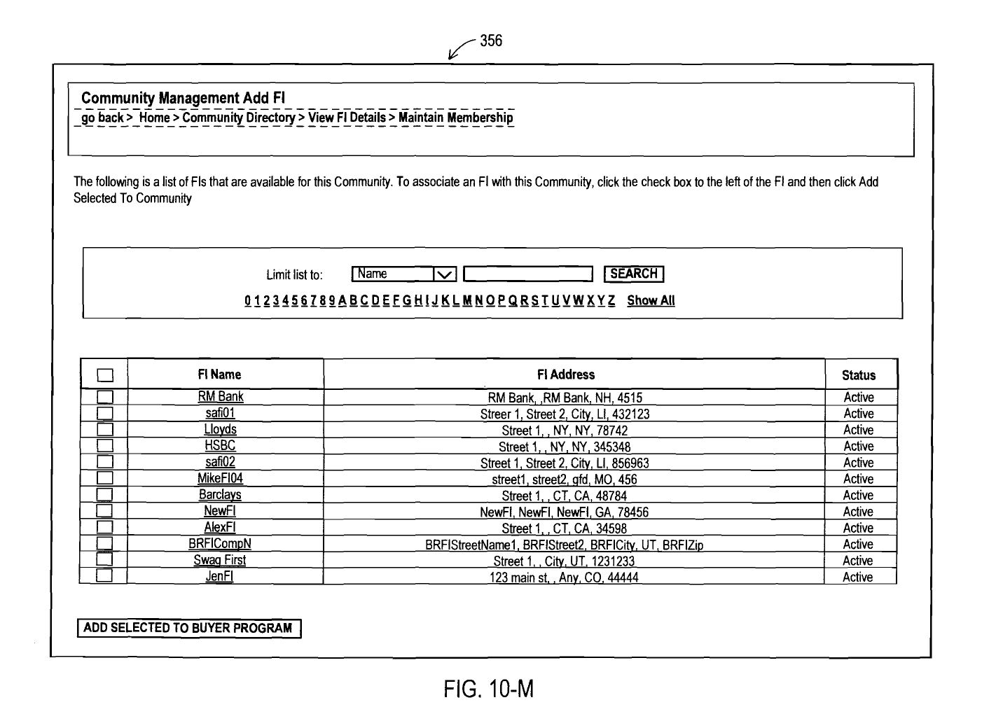

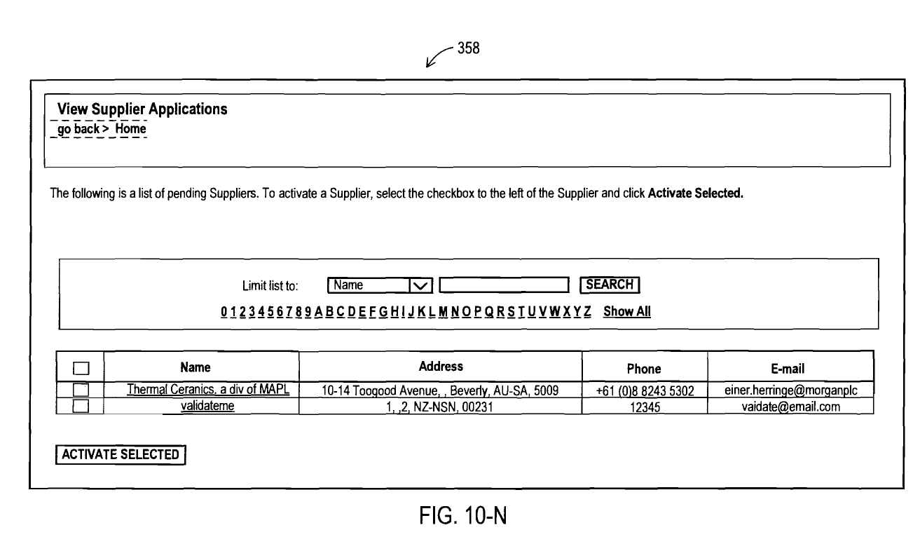

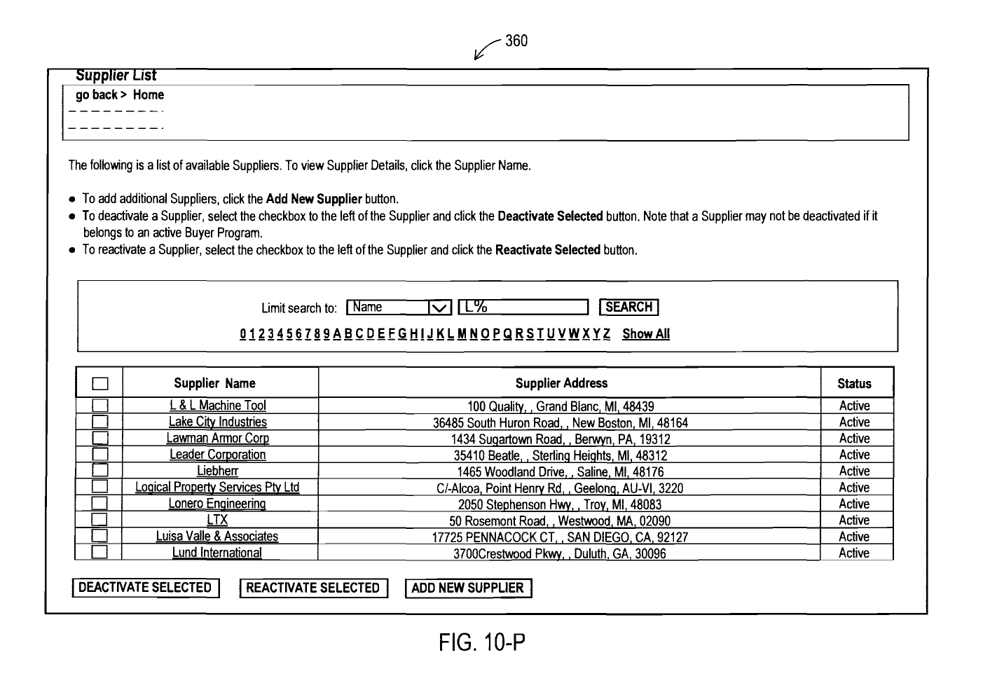

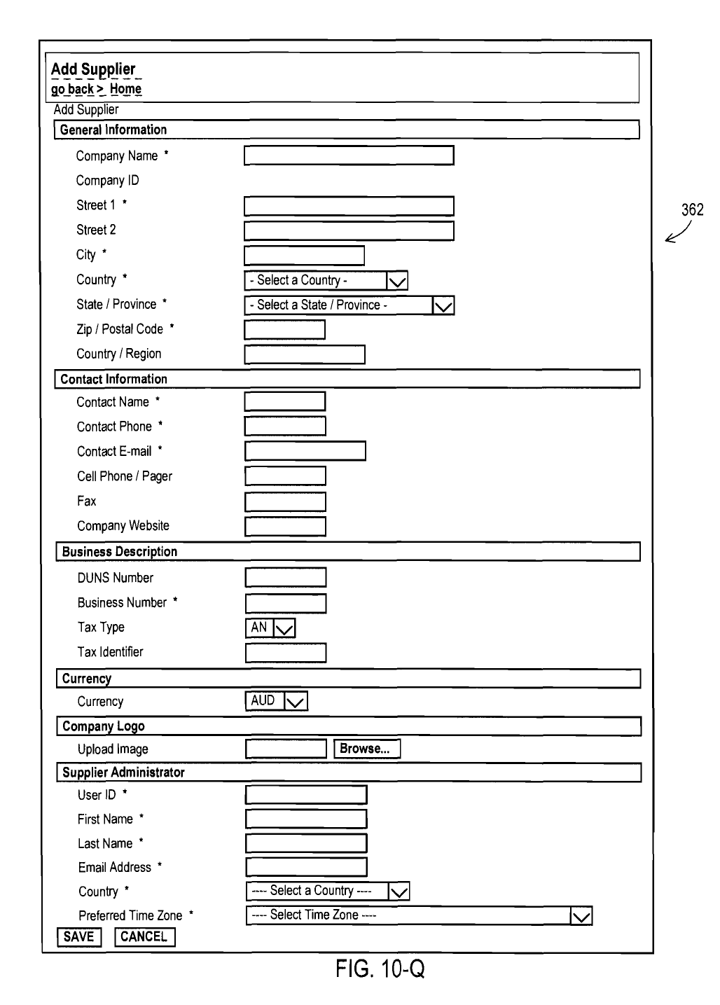

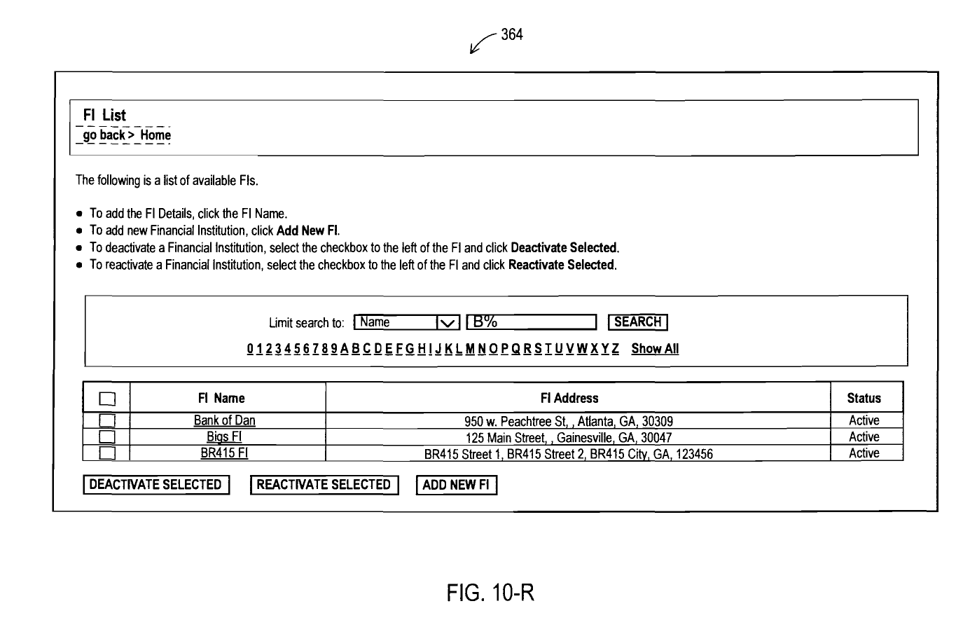

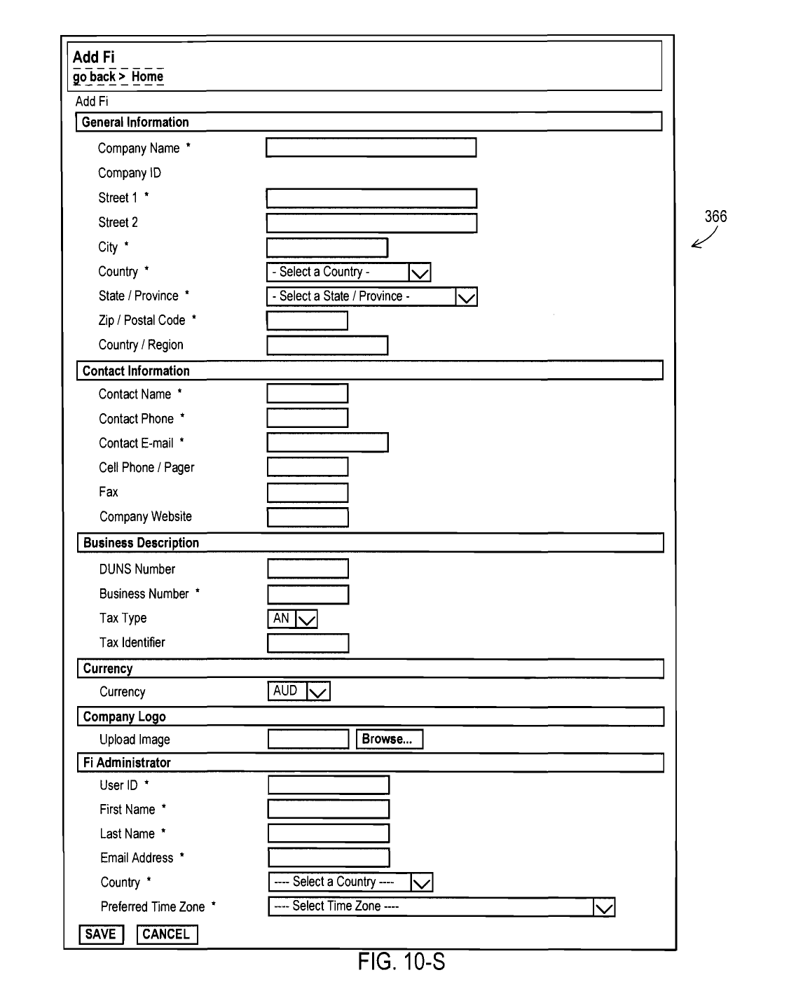

FIG. 10-A is an exemplary screen image of the service provider home page 302. The service provider home page provides for performing buyer program 100 related tasks. Access is provided to important information regarding community 112 activities, as well as links to more detailed buyer program 100 information. The service provider home page provides tasks and alerts, and a list of active communities.

The tasks and alerts provide a listing including notifications, payments and other alerts. For example, a payment obligation import might have occurred at a certain time as a system notification. The date of the message is provided as well as the type of notification.

The active communities allows for viewing a list of communities by the order in which they were added to the system 10, and also provides for hyperlink to additional communities. Summary information is provided for each community 112 including the name, description, number of buyers, number of suppliers and user lockouts.

FIG. 10-B is an exemplary screen image of the community directory page 336. The community directory is accessed from the community management pull down menu. Communities can be viewed and managed from the community directory list page.

A buyer program 100 for a specific community 112 is accessed from the service provider 104 by locating the desired community 112 containing the buyer program 100 and locating the community 112 in the community directory. Selecting the hyperlink will access the specific buyer program 100.

FIG. 10-C is an exemplary screen image of the community information page 338. There are five tabs on the community information page including general information, community administrator, community buyers, community financial institutions and “terms and agreements.” The general information tab is the default selection.

Buyer program 100 information can be accessed from the community buyers tab and the community financial institutions tab. Community buyers provide a list of community buyers and the service provider 104 manages the system 10 rules for the buyer program 100. The community financial institutions tab provides a list of financial institutions 110. From the financial institutions list, the service provider 104 may add a new financial institution 110 or deactivate a financial institution 110.

FIG. 10-D is an exemplary screen of a list of community buyers 340 from selecting community buyers tab on the community information page. A buyer list associated with that community 112 is displayed. From the list of buyers, the service provider 104 can deactivate a buyer 106, view the buyer 106 company information, view a list of buyer programs 100 for the selected buyer 106 and add a buyer 106.

FIG. 10-E is an exemplary screen of the add buyer page 342. Adding a buyer 106 is the first step to adding a buyer 106 to the community 112 and thus begins the process for adding a buyer program 100. Adding a buyer 106 to the buyer program 100 is initiated by selecting the add button on the buyer list page in FIG. 10-D causing the add buyer page to be displayed.

Buyer information includes general information, contact information, business description, currency, company logo and buyer administrator. General information includes the company name, ID and address. Contact information includes name, phone, email, cell phone, fax and website.

Business description allows for DUNS number, business number, tax type, tax identifier for the buyer and buyer remittance. The tax type is selected from a pull down menu. Setting the buyer remittance flag will designate that the buyer 106 will receive remittance advices electronically via the system 10. It should be noted that the display information and required fields will differ depending upon the country code selected.

The preferred currency utilized by the buyer 106 is selected from a pull down menu.

A company logo may also be specified by a path to the logo file. The company logo displays on community screens. The directory path may be entered directly, or the browse button may be selected to locate the company logo file.

Buyer administrator information includes user ID, name, email address, country and preferred time zone for the primary buyer administrator. The person listed has full access to this buyer 106 within the buyer module. It should be noted that each buyer 106 added will have a status of “pending” until the service provider 104 has created buyer program configuration and the community manager 102 has configured the default buyer program 100. The buyer 106 status will change to “Active” after the buyer program 100 is created.

FIG. 10-F is an exemplary image of the buyer program list page 344. The buyer program list displays the name of the buyer program 100, status, buyer program type, country, currency, and links to view business rules and system configuration. From the buyer program list page, the service provider 104 can view and manage a list of suppliers associated with the buyer program 100, view the buyer program business rules, view and edit the buyer program system configuration parameter, and add a buyer program 100. Viewing the buyer program business rules is a view only mode and provides the service provider 104 with a view of the buyer program business rules as set by the community manager 102.

FIG. 10-G is an exemplary screen image of the add buyer program page 346. The service provider 104 may add one or more buyer programs 100 for each buyer 106. Each buyer program 100 added from this page will be a default buyer program 100 in the community manager 102 interface. The company details are presented along with the company ID at the top of the screen. The buyer program details, buyer program configuration, buyer program system configuration, and bank account category payment type are specified when adding a buyer program 100.

The buyer program name is the name of the buyer program 100.

Buyer program configuration includes country, currency, SP bank account and pricing profile. Country specifies the country in which the buyer program 100 will be utilized. The currency specified is the currency in which the payment obligations for the buyer program 100 will be traded and matured. (For more details, see “Currency at default buyer program” in the “Additional Features of the Buyer Program” section below.) An SP bank account is selected for the service provider 104 to utilize for this buyer program 100. A community pricing profile is selected for this particular buyer program 100.

Buyer program system configuration includes time zone, buy offer window open, buy offer window close, buy offer total time out, buy offer FI time out and pre-mature lead days. A time zone is selected in which this buyer program 100 will be administered. The time zone is selected when adding the program and can not be modified.

Buy offer window open specifies the time of day during which buy offers are available. Buy offer window close specifies the time of day when buy offers are closed to purchase for the day. Buy offer total time out specifies the time (typically hours) until a buy offer times out, and is measured from the time a supplier 108 submits it. This time can include waiting for community manager distribution of the buy offer, as well as financial institution 110 approval. Buy offer FI time out specifies the hours until a buy offer times out while waiting for financial institution 110 approval.

Pre-mature lead days specifies the number of days in the future for which the system 10 will generate payment instructions.

A bank account category payment type specifies selection of a payment type for each bank account category. Payment types refer to the payment output file type that is processed prior to distributing it to the assigned gateway. Bank account categories include service provider, community, buyer, supplier (trading), supplier (maturing), FI (trading) and FI (maturing). Supplier trading and supplier maturing can be modified for subsequent buyer programs 100. Payments are distributed to the community members via the gateway. The gateway is associated with the country and bank configuration being utilized.

FIG. 10-H is an exemplary view of the view buyer program page (managing suppliers) 348. Company details and buyer program details are presented along with a list of suppliers. The service provider 104 utilizes the view buyer program (manage suppliers) to maintain the suppliers 108 in a buyer program 100. The service provider 104 performs tasks including viewing/editing suppliers, adding suppliers, deactivating suppliers and updating suppliers.

Supplier names are presented in a column and include hyperlinks to the supplier company information. Selecting the hyperlink allows for viewing and/or editing the supplier company information.

A supplier 108 may be added by selecting the “add” button. Adding a supplier 108 is discussed in more detail regarding FIG. 10-J below.

A supplier 108 may be deactivated by selecting the check box beside the desired supplier 108 and then selecting the “deactivate selected” button. It should be noted that a supplier 108, once deactivated, is unable to create sell offers for this buyer 106. Deactivation does not occur until the following day. Un-traded payment obligations will still be settled to the supplier 108 upon maturity.

Supplier cross-references and restricted bank accounts may be updated. The supplier reference number is a reference number(s) associating uploaded payment obligations to a supplier 108 for a buyer 106. If a single reference number is entered, the system 10 places the reference number between pipes (“|”). It should be noted that the buyer 106 may have any number of reference numbers for a given supplier 108. Each reference number is delineated by the pipe (“|”) sign.

A restricted bank account restricts the supplier 108 from receiving payments into any other bank account. If the account is left open, the supplier 108 may utilize bank accounts as assigned in the supplier module. Restricted bank accounts are entered via the administration menu.

FIG. 10-J is an exemplary screen image of the add supplier page 350. A list of available suppliers 108, including addresses, associated with the community 112 and buyer program 100 is displayed. The list may be modified and/or narrowed by entering search criteria to filter the results. Selecting show all will enable viewing of the entire list of suppliers 108. Selecting the check box to the left of the supplier 108 marks the supplier 108 for addition to the buyer program 100. A reference number may be added for the supplier 108. Selecting the “add selected buyer program” button will add the supplier 108 to the buyer program 100. The system 10 will return to the view buyer program page and will display the list of suppliers 108 with the newly added suppliers 108 included. It should be noted that the status of new suppliers 108 will remain pending until the supplier 108 joins the buyer program 100. Once the supplier 108 has joined, the status is changed to “active.” (For more details, see “Cross community suppliers” in the “Additional Features of the Buyer Program” section below.)

FIG. 10-K is an exemplary screen image of the buyer program system configuration page 352. From the buyer programs list page (see FIG. 10-F) the view hyperlink in the buyer program system configuration column is selected for the desired buyer program 100. The system configuration for the default buyer program 100 in a community 112 can only be changed on an initial or default buyer program 100. Subsequent buyer programs 100—those based on the default—inherit the system configuration information from the default program.

The view program system configuration page (FIG. 10-K) is displayed and the edit button is selected to present the edit default buyer program page. The time zone, currency and country code are not modifiable.

FIG. 10-L is an exemplary screen image of the community financial institutions tab for maintaining membership 354. The list of financial institutions 110 is displayed. From the community financial institutions tab, the service provider 104 user can view FI details, deactivate a financial institution 110 and add a financial institution 110 to the community 112.

To view FI details, the financial institution 110 hyperlink is selected in the FI name column for the desired financial institution 110. The FI company information is displayed but may not be edited.

A financial institution 110 may be deactivated by selecting the check box beside the desired financial institution 110 and then selecting the “deactivate selected” button. The financial institution 110 is then removed from the community financial institution listing. It should be noted that once the financial institution 110 has been deactivated, that financial institution 110 is unable to accept any buy offers excepting those on that financial institution's 110 trading desk which can now be rejected. Payment obligations will be settled to the financial institution 110 upon maturity.

Selecting the “add” button will cause a financial institution 110 to be added to the community 112. The community management add FI page will open as discussed below.

FIG. 10-M is an exemplary screen image of the community management add FI page 356. A list of financial institutions 110 is displayed that are available for the community 112. The list may be modified and/or narrowed by entering search criteria to filter the results. Selecting show all will enable viewing of the entire list of financial institutions 110. To view a financial institution 110, the hyperlink in the FI name column for the desired financial institution 110 may be selected. The financial institution 110 company information is displayed but can not be edited.

Selecting the check box to the left of the financial institutions 110 marks the financial institutions 110 for addition to the community 112. Selecting the “add selected to community” button will add the financial institutions 110 to the community 112. To cancel and return without selecting a financial institution 110, the maintain membership link in the breadcrumb trail at the top of the page may be selected. It should be noted that the status of these newly added financial institutions 110 is active and can be associated to a buyer program 100 by a community manager 102 at this time, however the financial institution 110 is prevented from joining the buyer program 100 until it has an active bank account. (For more details, see “Cross community financial institutions” in the “Additional Features of the Buyer Program” section below.)

FIG. 10-N is an exemplary screen image of the view supplier applications page 358 for the supplier enablement process. The service provider 104 may view and act upon new supplier applications. Once a supplier 108 is entered into the system 10, they must be approved before being assigned to a buyer program 100. Once activated, the supplier 108 may elect to participate in the buyer program 100.

A list of pending suppliers is displayed. The list may be modified and/or narrowed by entering search criteria to filter the results. Selecting show all will enable viewing of the entire list of supplier applications. To view supplier details, the hyperlink for the desired supplier 108 may be selected. Selecting the check box next to one or more suppliers 108 marks those suppliers 108 for activation. Selecting the “activate selected” button will activate the supplier(s) 108.

FIG. 10-P is an exemplary screen image of the supplier list page 360. The supplier list page provides the service provider 104 with the capability to add and manage suppliers 108 across all communities. The supplier list provides the supplier name, supplier address and status. From the supplier list page the community manager 102 can find suppliers 108, deactivate suppliers 108, reactivate suppliers 108, add new suppliers 108 and view supplier details. The search function can be utilized to find new suppliers 108.

The check box next to the desired supplier(s) is checked to deactivate one or more suppliers 108. Then selecting the “deactivate selected” button will deactivate the suppliers 108 across all buyer programs 100.

The check box next to the desired suppler(s) is checked to reactivate one or more suppliers 108. Then selecting the “reactivate selected” button will allow the supplier 108 to rejoin the buyer programs 100 when an invitation is extended.

A new supplier 108 is added by selecting the “add new supplier” button (see FIG. 10-Q).

The supplier name hyperlink may be selected to view and edit supplier company information.

FIG. 10-Q is an exemplary screen image of the add supplier page 362. The add supplier page 362 may be accessed from the supplier list page—see FIG. 10-P above—or selecting the add supplier option from the community management pull down menu. Adding a supplier 108 at the add supplier page 362 involves adding general information, contact information, business description, currency, company logo and supplier administrator for each supplier 108.

General information includes the name and address for the supplier 108.

Contact information includes the name, phone, email, cell phone, fax for the supplier contact and the company website.

The business description includes the DUNS number, business number, tax type and tax identifier for the supplier 108. The display information and required fields will differ depending upon the country code selected.

Currency selection is provided through a pull down menu for selecting the preferred currency that the supplier 108 utilizes.

A company logo may also be specified by a path to the logo file. The company logo displays on community screens. The directory path may be entered directly, or the browse button may be selected to locate the company logo file.

Supplier administrator information includes the user ID, name, email address, country and preferred time zone for the primary supplier administrator. The person listed will have full access to this supplier 108 within the supplier module.

FIG. 10-R is an exemplary screen image of the FI list page 364 for supplying a list of financial institutions 110. The service provider 104 may add and manage financial institutions 110 across the communities 112. Managing financial institutions 110 includes the finding of financial institutions, deactivating financial institutions, reactivating financial institutions, adding new financial institutions and viewing financial institution details.

The search function is utilized for finding financial institutions 110. The list may be modified and/or narrowed by entering search criteria to filter the results. Selecting show all will enable viewing of the entire list of financial institutions 110. Selecting the check box to the left of the financial institution 110 marks the financial institution 110 for activation or deactivation. After selecting the desired financial institution(s) 110, selecting the “deactivate selected” button will deactivate the financial institution 110 across the buyer programs 100, and selecting the “reactivate selected” button allows the financial institution(s) 110 to rejoin buyer programs 100 when an invitation is extended.

Details of each financial institution 110 may be viewed and/or edited by selecting on the hyperlink of the financial institution 110 name under the FI name column.

A new financial institution 110 may be added by selecting the “add new FI” button. Details for adding a new financial institution 110 are discussed in FIG. 10-S below.

FIG. 10-S is an exemplary screen image of the add FI page 366 for adding financial institutions 110. The add FI page may be accessed from the FI list page or selecting the “add FI” option from the community management pull down menu. Adding a financial institution 110 involves providing general information, contact information, business description, currency, company logo and the FI administrator.

General information includes the name and address for the financial institution 110.

Contact information includes the name, phone, email, cell phone, and fax for the financial institution 110 contact, and the company website.

The business description includes the DUNS number, business number, tax type and tax identifier for the financial institution 110. The display information and required fields will differ depending upon the country code selected.

Currency selection is provided through a pull down menu for selecting the preferred currency that the financial institution 110 utilizes.

A company logo may also be specified by a path to the logo file. The company logo displays on community screens. The directory path may be entered directly, or the browse button may be selected to locate the company logo file.

Financial institution administrator information includes the user ID, name, email address, country and preferred time zone for the primary financial institution administrator. The person listed will have full access to this financial institution 110 within the financial institution 110 module.

Bank Account Management

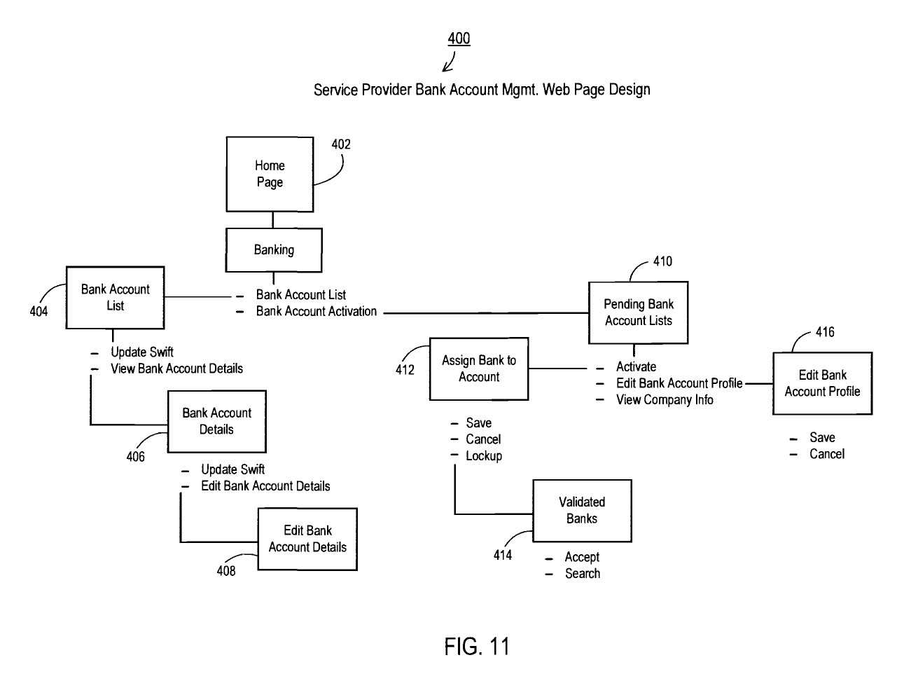

FIG. 11 is a diagram illustrating bank account management web page features 400. Access is provided to the bank account list 404 and bank account activation 410 functions via the service provider home page 402 banking pull down menu. These functions provide for performing bank account related tasks.

Bank accounts are integral to buyer program 100 operation. Unless the bank accounts are activated for each community participant, the participant remains pending. Each entity manages its own bank accounts, however the validation and activation of those accounts in the SCF system 10 is controlled by the service provider 104.

At the bank account list 404 page, the service provider 104 may update swift and view bank account details. At the bank account details 406 page, the service provider 104 may update swift and edit bank account details 408.

At the pending bank account lists 410 page, the service provider 104 may activate bank accounts, assign a bank to an account 412, edit bank account profiles and view company information. Some bank accounts require additional bank account profile information prior to activation. These bank accounts are bank accounts established as the margin and clearing accounts by the community manager 102. The bank account having the “activate” hyperlink can be activated immediately if the service provider 104 is satisfied with the information entered. When in doubt about the correctness of the data, the service provider 104 may search through a list of existing bank accounts to determine if the account already exists. If the account exists (validated banks 414), it can be associated with the new account. The new account will have the routing number of the associated account. Bank account profiles may be edited at the edit bank account profile 416 page.

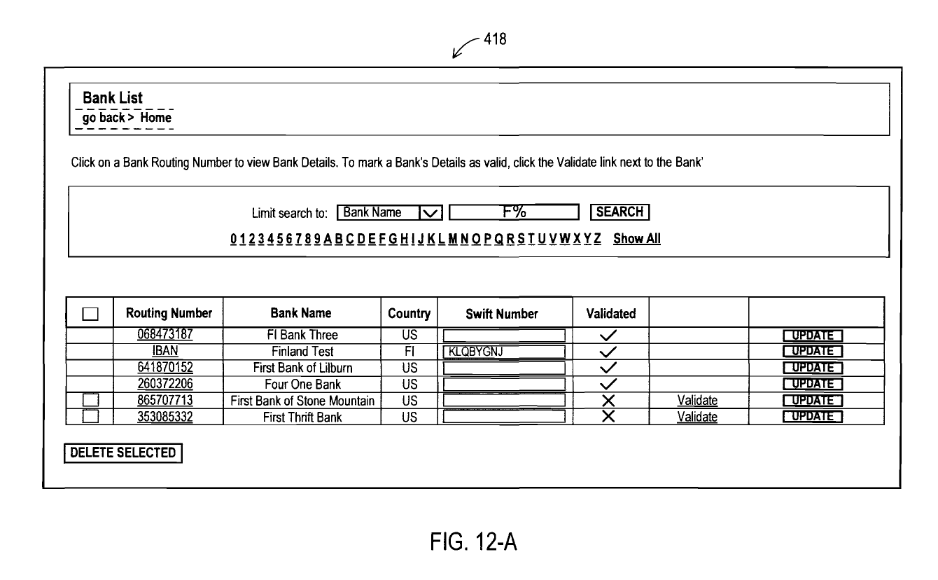

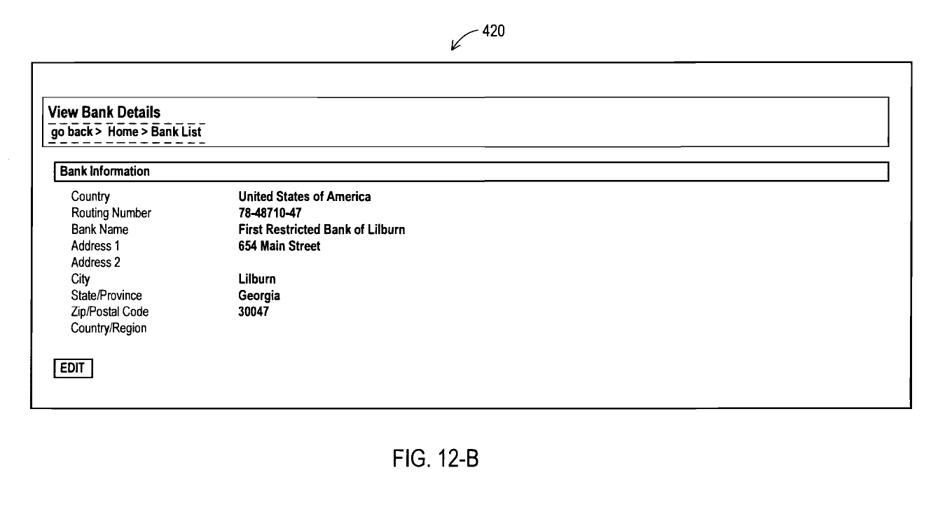

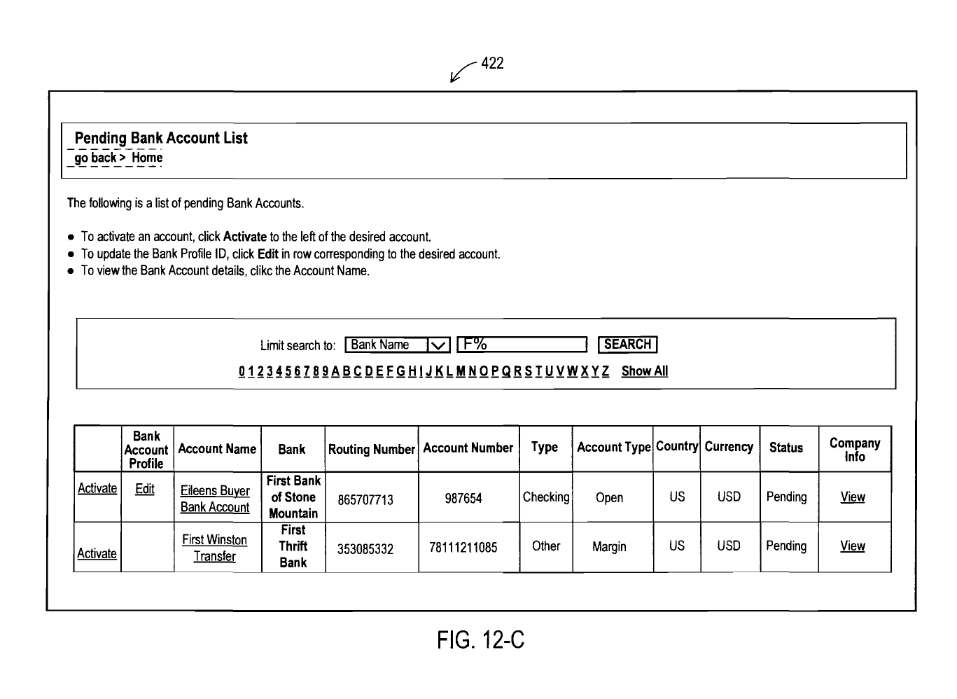

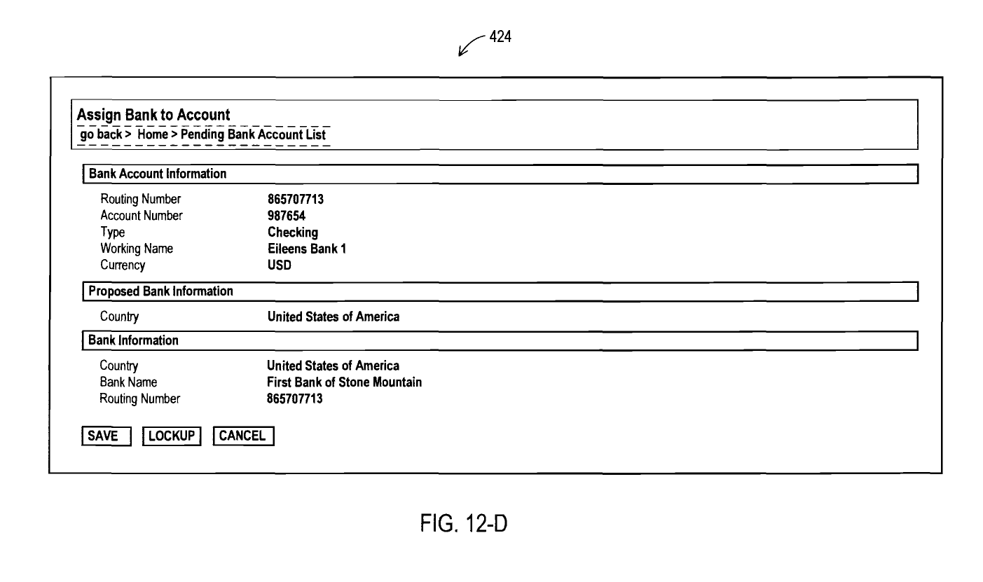

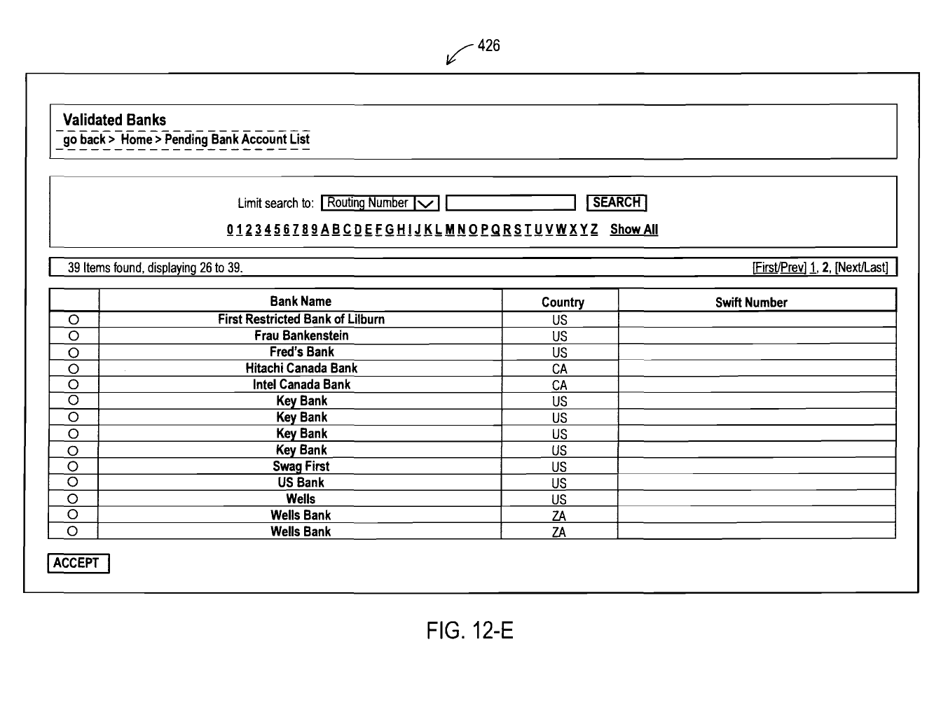

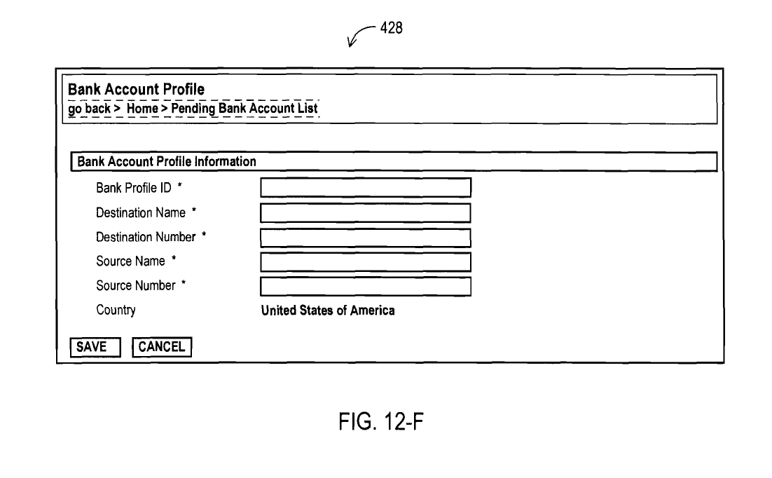

FIG. 12-A is an exemplary screen image of the bank list page 418. The banking menu allows the service provider 104 to maintain bank accounts that have been entered by different users. The bank list provides the ability to validate the banks that have been entered, and the bank account activation will activate the specific accounts entered.

The bank list provides routing number, bank name, country, swift number and validation information.

The search function is utilized for finding banks. The list may be modified and/or narrowed by entering search criteria to filter the results. Selecting show all will enable viewing of the entire list of banks. Selecting the check box to the left of the bank marks the bank for deletion by then selecting the “delete selected” button. It should be noted that validated banks may not be deleted.

A bank may be validated by selecting the “validate” hyperlink corresponding to the desired bank. Of course, if a bank is already validated the “validate” hyperlink does not appear.

Bank account information may be updated by entering the swift number in the field corresponding to the desired bank and then selecting the corresponding “update” button.

Bank details may be viewed and updated by selecting the routing number hyperlink corresponding to the desired bank. The view bank details page will open (see FIG. 12-B).

FIG. 12-B is an exemplary screen image of the view bank details page 420. Bank information including country, routing number, bank name and address are provided. Selecting the “edit” button provides for modifying bank information and opens the edit bank details page. From the edit bank details page the service provider 104 user may modify the bank name, address (including city, state/province and zip/postal) and county/region for the bank. The service provider 104 may not modify the country (in which this bank is utilized) or routing number (identifying number for the bank).

FIG. 12-C is an exemplary screen image of the pending bank account list page 422. Service providers 104 may activate any pending bank accounts entered by other entities within the system 10. In addition to activating accounts, the service provider 104 may view company information, bank account information and update the bank account profile. The service provider 104 user accessed the bank account activation from the banking menu via the pending accounts list.

The pending bank account list provides the account name, the bank name, routing number, account number, type, account type, country, currency and status. Additionally, access is provided to account information, company information and the bank account profile.

A list of pending bank accounts is displayed. The list may be modified and/or narrowed by entering search criteria to filter the results. Selecting show all will enable viewing of the entire list of bank accounts. To view bank account details, the “account name” hyperlink for the desired bank account may be selected. Selecting the “edit” hyperlink provides for editing the bank account profile (see FIG. 12-F below). Information about the company may be view by selecting the “view” hyperlink in the company info column.

A bank account may be activated by selecting the “activate” hyperlink corresponding to the desired bank account (see FIG. 12-D).

FIG. 12-D is an exemplary screen image of the assign bank to account page 424. Bank account information, proposed bank information and bank information is provided. The bank account information includes routing number, account number, type, working name and currency. The proposed bank information provides the country. The bank information provides the country, bank name and routing number. Selecting the “save” button assigns the bank to the account. Selecting the “lookup” button provides for changing the bank assigned to the account by opening the validated banks page.

FIG. 12-E is an exemplary screen image of the validated banks page 426. Upon selecting the “lookup” button from the assign bank to account page, this screen presents the capability to select a different validated bank for assignment to the account.

A list of validated banks is displayed. The list may be modified and/or narrowed by entering search criteria to filter the results. Selecting show all will enable viewing of the entire list of validated banks. The bank name, country and swift number are displayed in the list. Selecting the radio button next to the desired bank marks that bank for assignment to the account. After selecting the desired bank(s) for assignment to the account, selecting the “accept” button will assign the validated bank and open the assign bank to account page (see FIG. 12-D).

FIG. 12-F is an exemplary screen image of the bank account profile page 428. Certain bank accounts provide an optional edit feature that enables adding more bank account profile details for the relevant bank accounts. The bank account profile is required for clearing accounts.

The bank account profile page is accessed from the pending bank account list (by selecting the “edit” hyperlink in the bank account profile column. The service provider 104 user may modify the bank profile ID, destination name, destination number, source name and source number. The bank profile ID is a unique identifier for this bank account profile. Destination name is the name of the entity that is the destination for the account. Destination number is the identifying number corresponding to the destination name. Source name corresponds to the entity that is the source for the account. Source number is the identifying number for the source name. Country is not modifiable and corresponds to the country in which this bank account is utilized.

Financial Institution

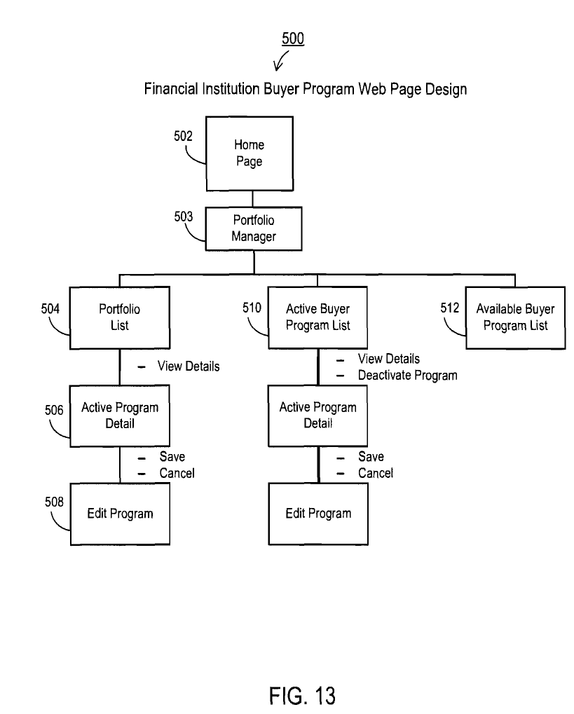

FIG. 13 is a diagram illustrating financial institution web page features 500. The financial institution home page 502 provides for performing portfolio manager tasks related to financial institutions 110. It should be noted that there must be at least one active financial institution 110 in each buyer program 100 for the buyer program 100 to be active.

The portfolio manager 503 has access to a portfolio list 504, an active buyer program list 510 and an available buyer program list 512. The portfolio list provides access to details of the financial institutions 110 portfolios including maturing obligations, program history, and the active program details. Active program detail 506 may be accessed and the financial institution 110 buyer program specific information may be edited via an edit program 508.

The active buyer program list provides access to details regarding buyer program rates, fees, open credit limit, open credit, program manager and for deactivating buyer programs 100. Active program detail 506 may be accessed and the FI buyer program 100 information may be edited via an edit program 508.

The available buyer program list provides access to any new buyer programs 100 that have been offered to the financial institution 110. New buyer programs 100 are offered by the community manager 102 adding the financial institution 110 to a buyer program 100. The financial institution 110 user can accept an available buyer program 100 via the available buyer program list.

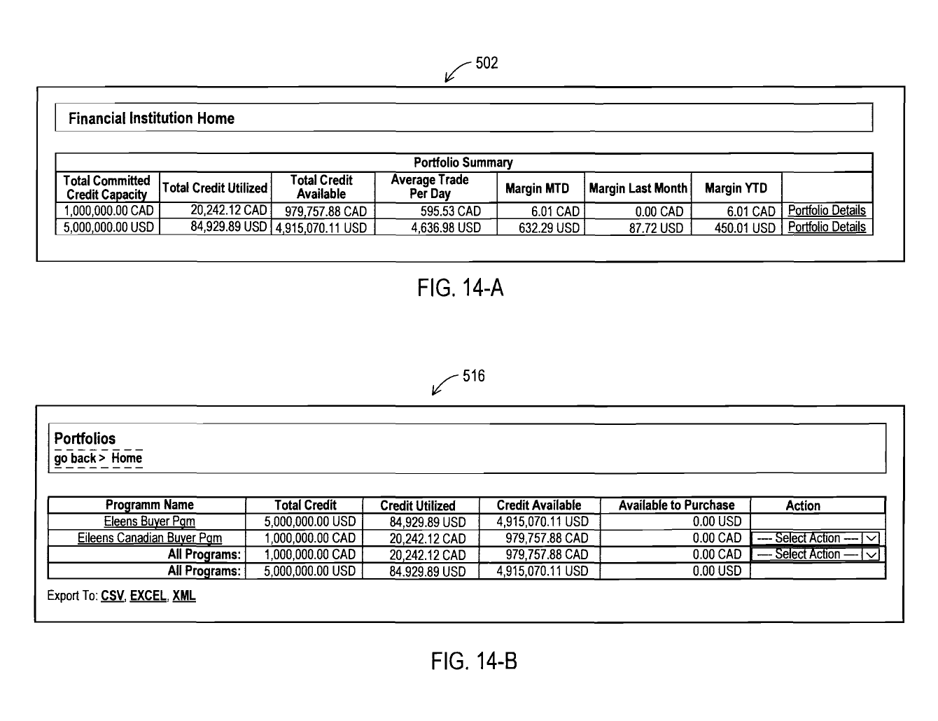

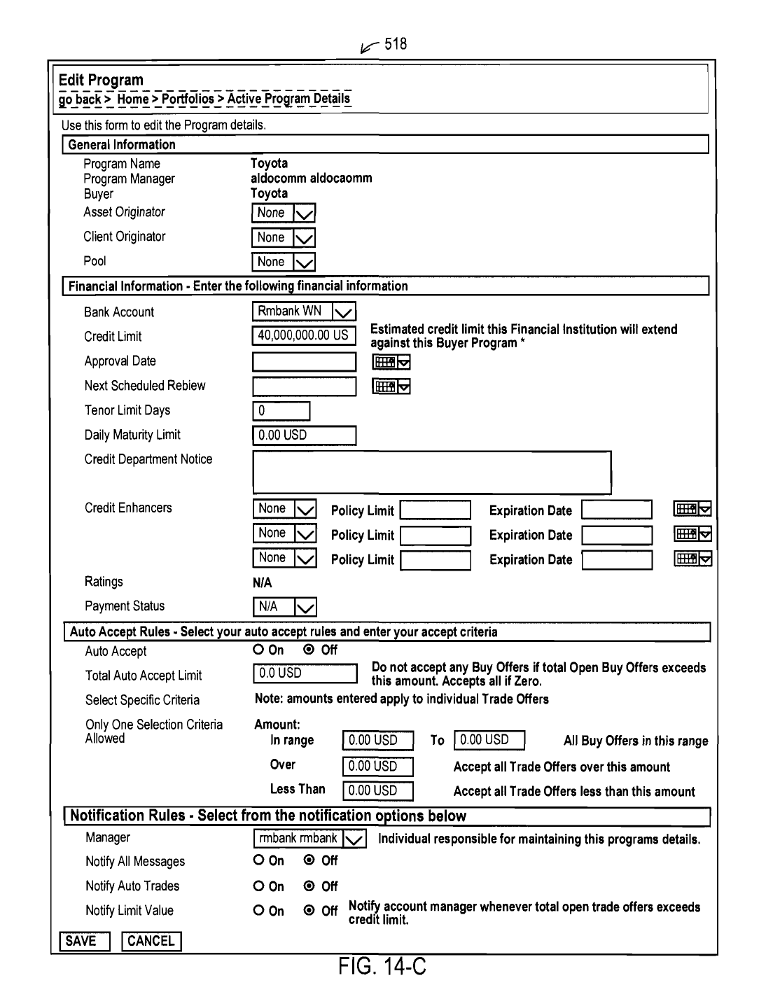

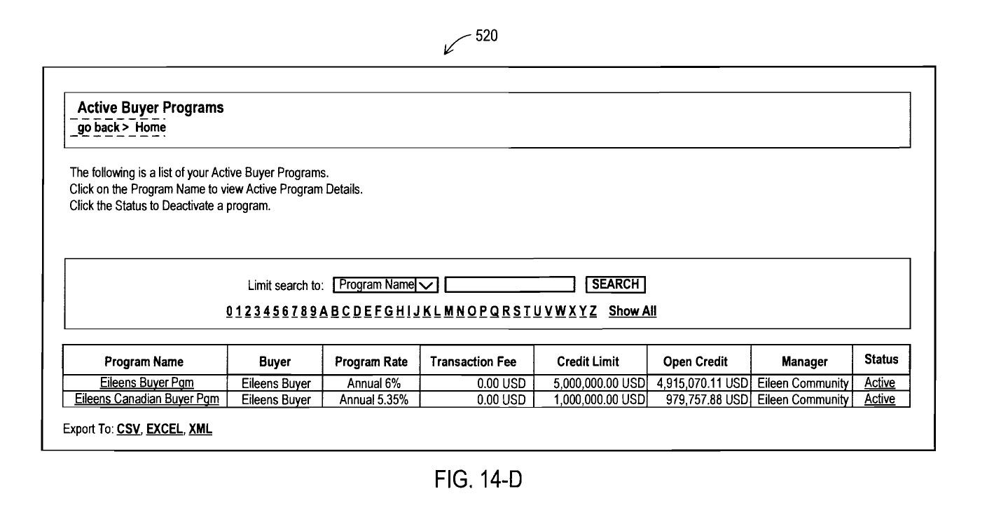

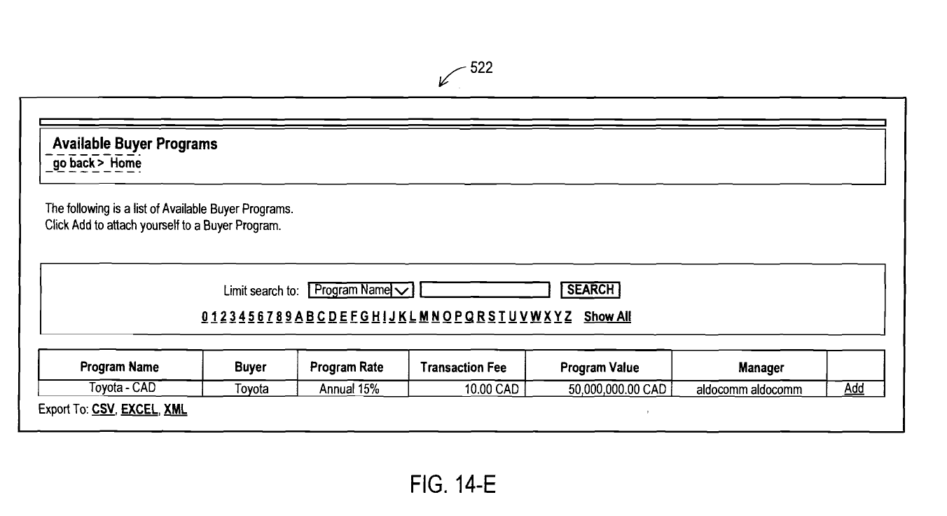

FIG. 14-A is an exemplary screen image of the financial institution home page 502. The financial institution home page 502 provides access to the portfolio summary information for financial institutions 110. A financial institution portfolio includes all the buyer programs 100 to which the financial institution 110 corresponds. The portfolio summary provides a high level view of all portfolios (buyer programs 100) combined and includes total committed credit capacity, total credit utilized, total credit available, average trade per day, margin MTD, margin last month and margin YTD.

The total committed credit capacity provides a summary total of all credit limits taken across each portfolio. The total credit utilized provides a summary total of all credit utilized taken across each portfolio. Total credit available is a summary total of all credit available.

Average trades per day provides a year-to-date average of all trades across all portfolios. The margin MTD provides a summary of the month-to-date profit performance as a total across each portfolio. Margin last month provides a summary of last month's profit performance as a total across each portfolio. Margin YTD provides a summary of the year-to-date profit performance as a total across each portfolio.

The portfolio details hyperlink opens the portfolio details page corresponding to the desired portfolio.

FIG. 14-B is an exemplary screen image of the portfolio manager page 516. Information is provided for buyer program name, total credit, credit utilized, credit available, available to purchase and an action selection pull down menu. The portfolio manager 503 provides for viewing and managing portfolio performance information (including maturing payment obligations and account history), viewing and maintaining active buyer programs 100, viewing and adding active buyer programs 100 in which the financial institution 110 has elected to participate.

Portfolios contain the details about buyer programs 100 to which the financial institution 110 has subscribed. A list of portfolios may be viewed by selecting the portfolios option from the portfolio manager pull down menu.

Portfolio details may be viewed by selecting “portfolios” from the portfolio manager pull down menu and then selecting the program name hyperlink corresponding to the program to be modified. The active program details page will be displayed. Selecting the “edit” button will cause the edit program page to display.

FIG. 14-C is an exemplary screen image of the active program details edit program page 518. Program details are presented for editing including general information, financial information, auto accept rules and notification rules.

General information includes the program name, program manager, and buyer—which are not modifiable—and asset originator, client originator and pool. The asset originator is a table entry maintained in the administration section, and can be used by the financial institution 110 to configure meaningful asset originator data and associate it with the buyer program 100. The client originator is a table entry maintained in the administration section, and can be used by the financial institution 110 to configure meaningful client originator data and associate it with the buyer program 100. The pool is a table entry maintained in the administration section, and can be used by the financial institution 110 to configure meaningful accounting pool data and associate it with the buyer program 100.

Financial information includes the bank account, credit limit, approval date, next scheduled review, tenor limit days, daily maturity limit, credit department notice, credit enhancers and payment status. The bank account is selected from a pull down menu and specifies the bank account (buyer) to be used at settlement time. The credit limit is the estimated credit limit that this financial institution 110 will extend against the buyer program 100. If there is only one financial institution 110 in the buyer program 100, then no sell offers can be submitted by a supplier 108 if the limit has been met. The approval date is selected from a selectable calendar and specifies the date that the buyer program 100 was approved. Next scheduled review is also selected from a selectable calendar and specifies the next required review date. Tenor limit days is the age of payment obligations that are allowed in the system 10.

The daily maturity limit sets a limit on the amount of payment obligations that the financial institution 110 will accept in sell offers that mature in a single day. The credit department notice is for informational messages. Credit enhancers are informational data entered by the financial institution 110 and control no system events. Payment status is an informational field for financial institution 110 use only.

The auto accept rules control the amount and various characteristics of a sell offer that would be accepted automatically by the financial institution 110. The auto accept rules may be off or on. Manager identifies the manager to which the notification rules apply. The manager is responsible for maintaining this program's details. Notification rules can be used by the financial user to limit the amount of messages received. Notification may be turned on or off for receiving all messages, auto trades messages and/or limit value messages. For example, notify limit value would notify the account manager when the total open trade offers exceeds the credit limit. (For more details, see “FI activation to buyer programs” in the “Additional Features of the Buyer Program” section below.)

FIG. 14-D is an exemplary screen image of the active buyer programs page 520. The active buyer programs page displays a list of all buyer programs 100 that are currently available to trade and is accessible from the portfolio manager menu by selecting the active buyer programs option from the pull down menu (see FIG. 14-B). Financial institution 110 users may deactivate a buyer program 100 or view/edit the buyer program details.

A list of active buyer programs 100 that are available to trade is displayed. The list may be modified and/or narrowed by entering search criteria to filter the results. Selecting show all will enable viewing of the entire list of active buyer programs 100.

A buyer program 100 may be deactivated by selecting the “active” hyperlink and then following the instructions that appear on screen. Buyer program 100 details may be viewed and/or edited (see FIG. 14-C) by selecting the buyer program hyperlink under the program name column for the desired program.

FIG. 14-E is an exemplary screen image of the viewing available programs page 522. Presented is a list of available buyer programs 100 that the financial institution 110 is invited to join. Information for the available buyer programs 100 includes the program name, buyer, program rate, transaction fee, program value and manager. A financial institution 110 may add itself to a buyer program 100 by selecting the “add” hyperlink corresponding to that buyer program 100.

To join an available buyer program 100, the financial institution selects the “add” hyperlink for the corresponding buyer program 100 and then enters the details in the active program registration page. An active program review page issues a warning that a buyer program 100 is about to be activated. After accepting the warning, the buyer program 100 is registered and the financial institution 110 is an active buyer program 100 participant.

Supplier

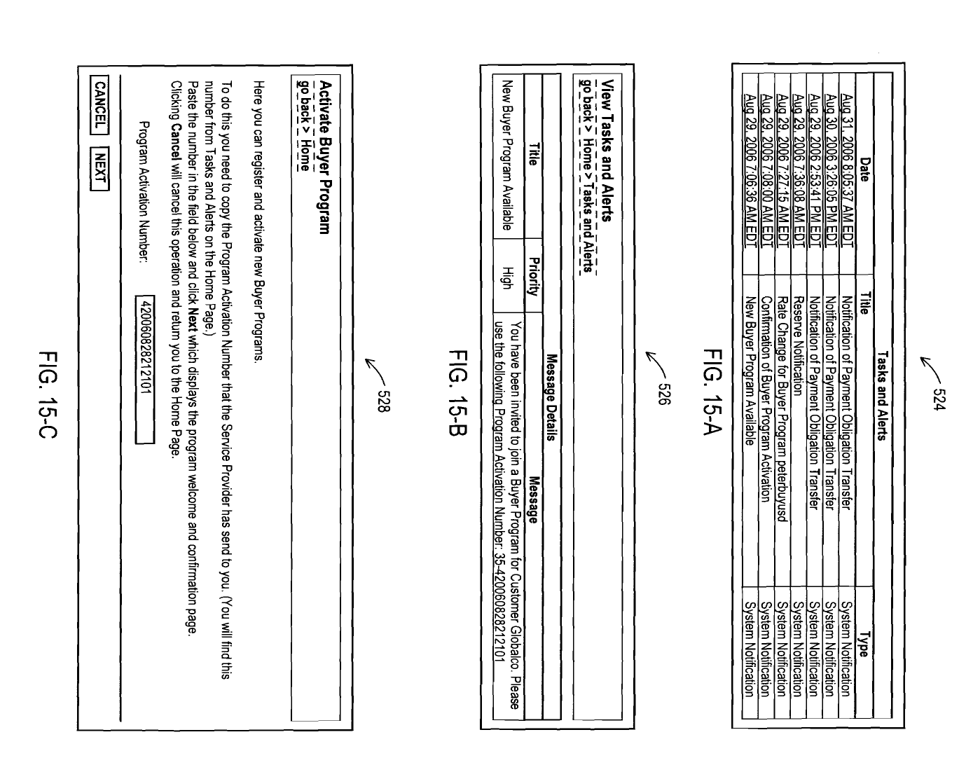

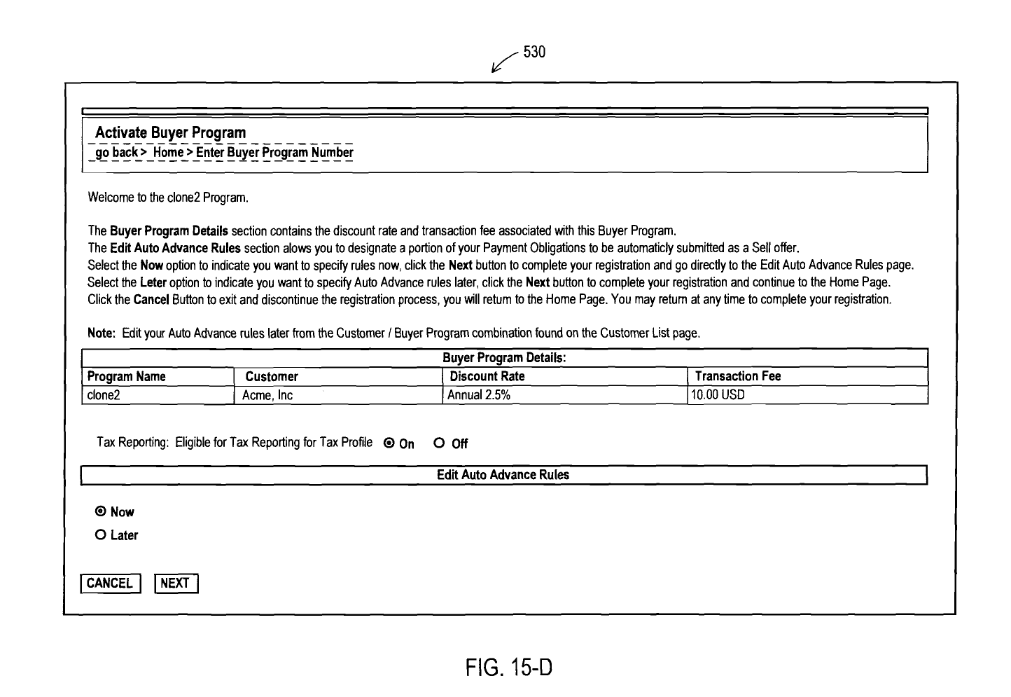

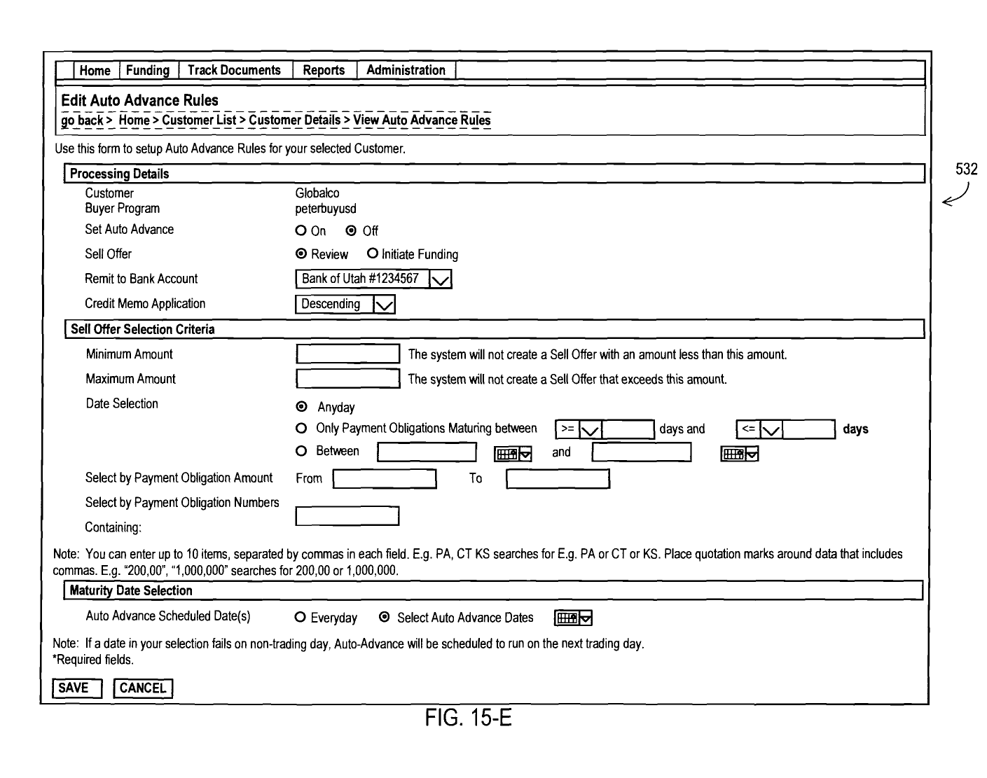

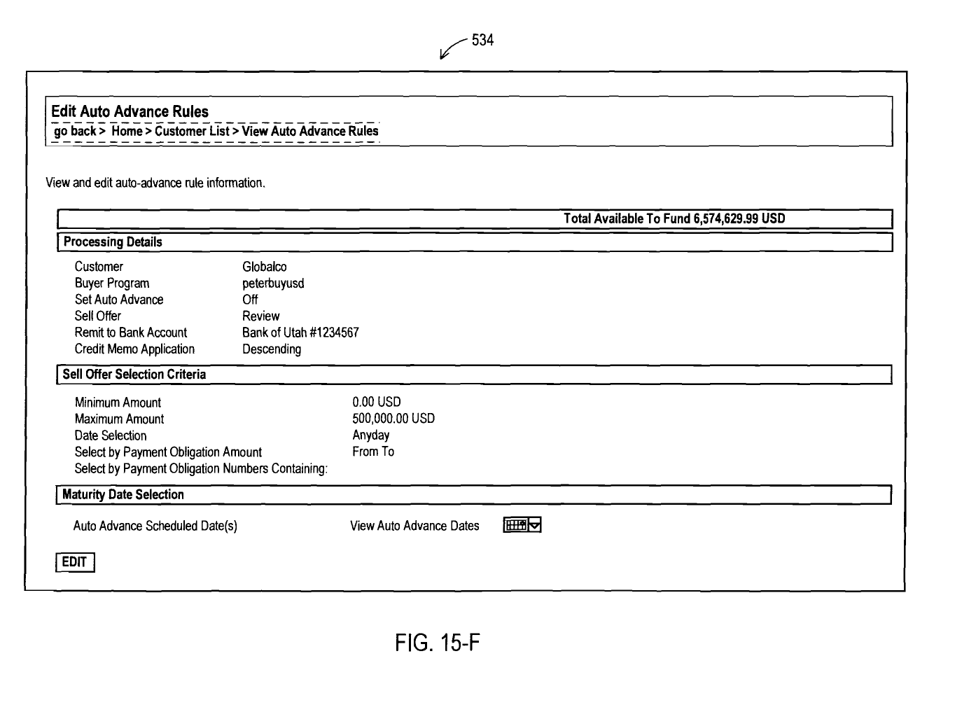

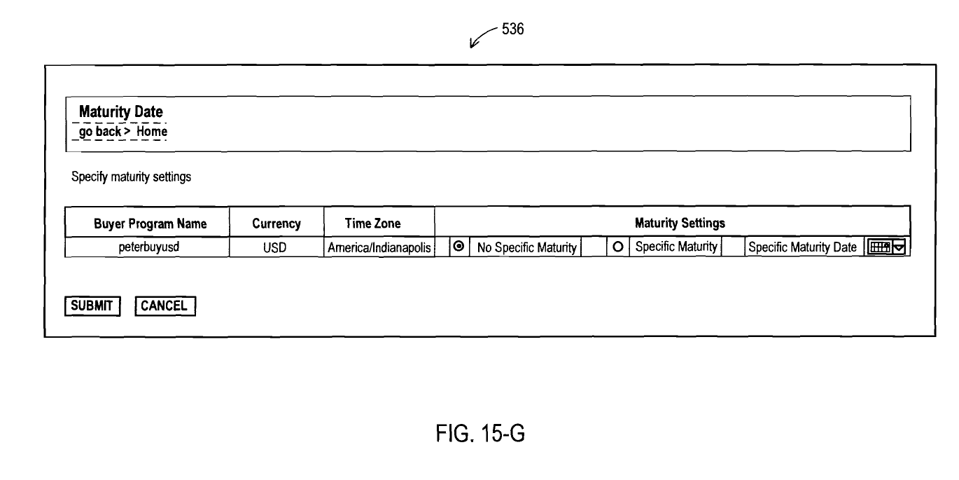

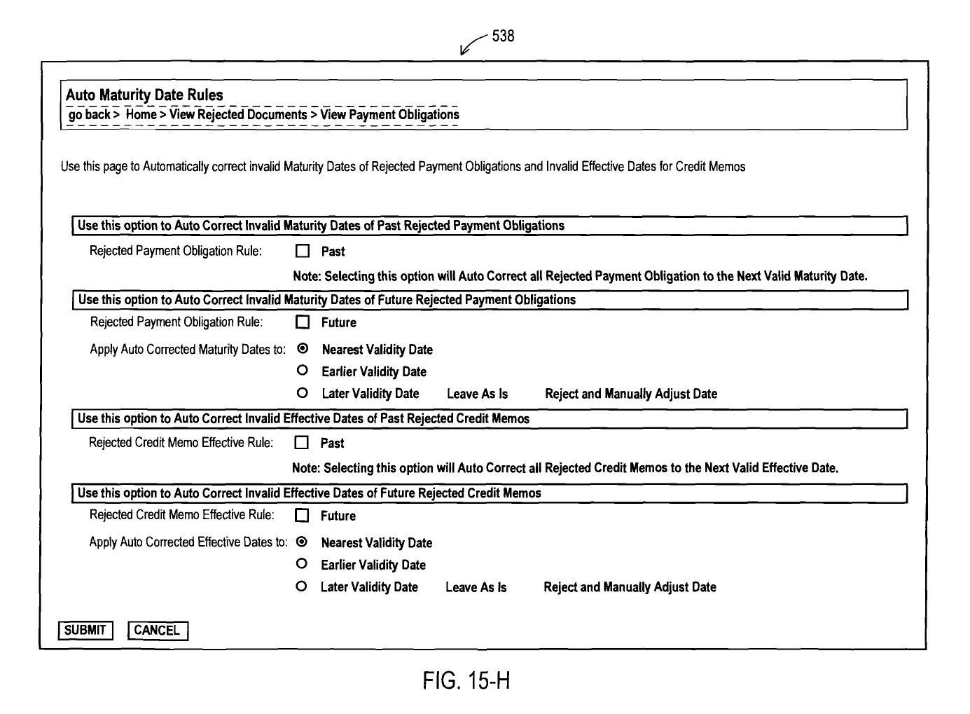

FIG. 15-A is an exemplary screen image showing the tasks and alerts 524. The primary functions of the supplier 108 in relation to the buyer program 100 are receiving notification that a buyer program 100 is available and notification to activate or deactivate from a buyer program 100. The activate buyer program function allows the supplier 108 to register and become active to new buyer programs 100. Once the service provider 104 associates the supplier 108 with a buyer program 100, the supplier 108 receives a task and alert—as shown in FIG. 15-A—that contains an activation number.

The tasks and alerts screen shows the date, title and type information for the alert, but the activation number is accessed by viewing the task and alert. From the supplier home page, the supplier 108 views the task and alert by selecting the “view” hyperlink to show the message details page.

FIG. 15-B is an exemplary screen image of the message details page 526. The message, in this instance, includes an invitation to join a buyer program 100, provides the customer information and includes the activation number. After acquiring the activation number, the supplier 108 accesses the activate buyer program function from the administration menu. The activation number is input to the activate buyer program to begin the registration process.

FIG. 15-C is an exemplary screen image of the activate buyer program page 528. The activation number—acquired from the task and alert—is entered into the program activation number box shown. Selecting the “next” button causes the welcome and confirmation page to be displayed. Selecting the “cancel” button will cancel the activate buyer program function and cause navigation back to the home page.

FIG. 15-D is an exemplary screen image of the welcome and confirmation page 530 of the activate buyer program function. The buyer program details section provides the program name, customer, the discount rate and the transaction fee associated with this buyer program 100. Tax reporting preferences are designated by selecting the radio button for the associated option. Edit auto advance rules may be specified at this time (select “now”) or at a later time (select “later”). Selecting the “now” option completes the registration process and causes the edit auto advance rules page to be displayed for specifying the auto advance rules. Selecting the “later” option completes the registration and causes navigation to the home page.

FIG. 15-E is an exemplary screen image of the edit auto advance rules page 532. Auto advance rules include processing details, sell offer selection criteria and maturity date selection. Auto advance may set to “on” or “off.” Sell offer is set by selecting “review” or “initiate funding.” “Remit to bank account” is selected via a pull down menu for selecting the bank account to which funds are remitted. The credit memo application parameter is also selected via a pull down menu.

Sell offer selection criteria include minimum amount, maximum amount, date selection, selection by payment obligation amount and selection by payment obligation numbers. When a minimum amount is specified, the system 10 will not create a sell offer with an amount less than the specified minimum amount. When a maximum amount is specified, the system 10 will not create a sell offer that exceeds the specified maximum amount.

Date selection criteria allows the supplier 108 user to determine the age of the payment obligations to be included in the sell offer. Age is based on number of days until payment obligation maturity. Selection criteria include “anyday” (any valid maturity date), “only payment obligations maturing between” (a configurable number of days) or “between” (a configurable range of dates). Selection for auto advance dates between certain days provides a scheduling calendar that opens for selecting the dates to specify the range.

Selection may also be made by payment obligation amounts in a range of prices, or set by payment obligation numbers.

Maturity date selection provides for setting auto advanced scheduled date(s) to occur on selected auto advance dates. A scheduler calendar window opens for allowing selection of dates. It should be noted that if the selection falls on a non-trading day, then auto-advance is scheduled to run on the next trading day.

Upon completion of specifying the auto advance rules, selecting the “save” button causes the auto advance rules to be saved and then causes navigation to a view auto advance rules screen. FIG. 15-F is an exemplary screen image of a view auto advance rules screen 534. The values selected for auto advance rules are displayed for verification.

Buyer

The primary function that the buyer 106 performs in relation to the buyer program 100 is to set up the program management features including setting valid maturity dates and setting auto correction rules.

To access the set maturity dates page, the buyer 106 selects the “set maturity dates” option from the buyer program management rollover menu on the navigation bar (not shown). FIG. 15-G is an exemplary screen image of a maturity date page 536. Currency, time zone and maturity settings are shown for the respective buyer program 100. Buyers 106 that have established maturity dates for payment of supplier's 108 payment obligations can use the set maturity date option to enter the respective maturity dates. Payment obligations that have been uploaded to the system 10 are validated to ensure that all payment obligation maturity dates are validated against the dates selected. Payment obligations not containing valid maturity dates are displayed for correction on the view rejected payment obligations page (not shown).

The calendar function shown for selecting a specific maturity date operates differently than the scheduling calendar utilized previously. Non-trading days are displayed in red and selected maturity dates are displayed in green. (Of course, any color coordination scheme could be used to indicate the comparison of non-trading dates versus selected maturity dates.) Non-trading days are set by the service provider 104 and include holidays and weekends. Valid maturity dates are set by the buyer 106 using the calendar to select from designated valid system maturity dates.

During payment obligation upload, the maturity dates set by the buyer 106 are used to validate the maturity dates on the payment obligations. Payment obligations rejected during the upload process appear in the rejected payment obligations list. It should be noted that a valid maturity date should be selected at least 90 days from the current date.

It should be noted that the default setting on the maturity date page is initially set to “no specific maturity date.” To set specific maturity dates, the user utilizes the calendar function and enters maturity dates for at least 90 days in the future.

Discontinuing maturity date validation may be performed via selecting the “no specific maturity” option and then selecting the “submit” option to save the changes. It should be noted that users must still correct the maturity dates of all previously rejected payment obligations even though they have deselected the “specific maturity date” option.

To access the auto correct maturity dates page, the buyer 106 selects the “auto correct maturity dates” option from the buyer program management rollover menu on the navigation bar (not shown). FIG. 15-H is an exemplary screen image of the auto maturity date rules page 538 for automatically correcting invalid maturity dates of rejected payment obligations and invalid effective dates for credit memos. The buyer 106 has the option to setup rules for automatically correcting maturity dates at the time a payment obligation or credit memo is uploaded into the system 10. The buyer 106 may set automatic correction of payment obligations with rejected maturity dates that are prior to the first valid maturity date when uploading, or to set auto correction of payment obligations with maturity dates that fall on invalid maturity dates in the future, or both.

Additionally, the buyer 106 can set an automatic auto correction of credit memos with effective dates that are prior to the first valid effective date when uploading, or set auto correction of credit memos with effective dates that fall on invalid effective dates in the future, or both.

The buyer 106 selects the “past” or “future” checkboxes from the options for maturity dates of rejected payment obligations. Selecting the “past” option will auto correct the payment obligations with a maturity date in the past to the next valid maturity date. Selecting the “future” option will require the user to select how they will apply auto corrected maturity dates-to either nearest validity date, earlier validity date or later validity date. Selecting “later validity date” also necessitates selecting the “leave as is” option or “reject and manually adjust” the maturity date.

The buyer 106 selects the “past” or “future” checkboxes from the options for effective dates of rejected credit memos. Selecting the “past” option will auto correct the rejected credit memos with an effective date in the past to the next valid effective date. Selecting the “future” option will require the user to select how they will apply auto corrected maturity dates—to either nearest validity date, earlier validity date or later validity date. Selecting “later validity date” also necessitates selecting the “leave as is” option or “reject and manually adjust” the effective date.

The submit option will save the rules settings. When a user uploads a payment obligation or credit memo that results in the auto correction of a maturity or effective date, the system 10 will send a high priority task and alert to the buyer 106 regarding the payment obligation or credit memo correction. The notification will provide the date, a summary of the auto correction, and instructions for viewing the modified effective dates, and payment obligations or credit memos.

Additional Features of the Buyer Program

Fix net community margin. The community manager 102 is able to fix the net community margin (NCM) value to a specified value which results in a valid gross community margin (GCM) relative to the appropriate service provider pricing tier in use. A checkbox titled “fixed” is available alongside the NCM textbox on the pricing tab of the buyer program setup 136. This fixes the NCM value and prevents further system 10 changes to the value. The NCM textbox becomes a required input field if the “fixed” checkbox is selected. When setting specific NCM to ON, the GCM is equal to the service provider fee plus the fixed NCM value. When fixing the NCM value by selecting the ON checkbox, the GCM input box should typically be disabled. The GCM is then auto-calculated.

Entered gross community margin. If the NCM is set to OFF, the GCM textbox is a required input field and the NCM textbox is disabled. The user must enter a gross community margin that is equal to or greater than the service provider fee. The system 10 then auto-calculates the NCM—the net community margin is equal to the gross community margin minus the service provider fee. It should be noted that when the total supplier pricing (TSP) locked rate is selected, the NCM ON checkbox is disabled.

Clearing accounts. Multiple clearing accounts may be utilized: one is utilized by the buyer 106 for maturing obligations and the second is utilized by the system 10 via a trust for trades. On the buyer program pricing page an entry for a second clearing account is available. The page has a section for clearing accounts with two selection options. The first selection is for a clearing account for maturing obligations, and is used for maturing obligations typically owned by the buyer 106. The payment transactions to suppliers 108 and financial institutions 110 for maturing obligations go to this clearing account. A second selection is for a clearing account for trades. The payment transactions for trades go to this clearing account and include the funds to pay the community manager 102, service provider 104 and supplier 108. The clearing account histories differentiate between the two clearing accounts for transactions. Self funding transactions from the buyer 106 use the maturing obligation clearing account. The system 10 differentiates between self funding trades and trades from third party financial institutions 110.

Currency at default buyer program. The system 10 allows the service provider 104 to select the currency at the default buyer program level. Buyer program pricing tiers 214 (variations from the default) are in the same currency as the default buyer program 100. The system 10 allows any number of default buyer programs 100 per currency, and allows multiple buyer program pricing tiers 214 per default buyer program 100. A buyer 106 may have any number of currencies and the buyer program pricing tiers 214 under the default are in the same currency as the default. The buyer program pricing tiers 214 do not give the user the option to select the currency but rather display the currency of the default buyer program 100. Once the currency is established for the buyer program 100 it can not be changed.

A supplier 108 may belong to more than one default buyer program 100 per buyer 106. Because a supplier 108 might bill a buyer 106 in different currencies—for example, European and Canadian—the supplier 108 may belong to multiple default buyer programs 100. The supplier 108 can not belong to two different buyer program pricing tiers 214 that are pricing tiers of the same default buyer program 100. A supplier 108 can only be moved between buyer programs that are buyer program pricing tiers 214 of a default buyer program 100. They can not be moved between default buyer programs 100.

The community manager home page 202 allows the community manager 102 to select the currency to get a community summary by buyer programs 100 trading in similar currencies. The community manager 102 defines the currency of the home page summary and can view the summary in each currency the community 112 is trading in by selecting the currency from a list box of appropriate currencies. The community manager 102 can set the default currency for display when first accessing the home page. The community manager home page 202 allows the user to select the currency for the trading snapshot. The community manager 102 defines the currency of the trading snap shot and views the snap shot in each currency the community 112 is trading in. The community manager 102 can group and summarize buyer programs 100 by currency on the list buyer program page.

The community manager 102 can define the currency of the clearing and margin bank accounts. All bank accounts are defined by currency. The system 10 only allows a clearing account with the same currency as the buyer program 100 to be associated with it. A community manager 102 is not allowed to associate a clearing bank account that does not have the same currency as the buyer program 100. The buyer program 100 may have a clearing account for maturing obligations that can be owned by the buyer 106 and have a second clearing account for trades owned by the a third party trust, the system 10 or a financial institution 110. This keeps the two transactions separate.

Capability to perform supplier pricing and allocate rates to financial institutions. The buyer program 100 has the capability to perform supplier pricing, as well as the capability for allocation of rates to financial institutions 110. The buyer program list page contains a list of buyer programs 100 associated with a selected buyer 106. From the buyer program list page the community manager 102 can search and find buyer programs 100, view buyer program details, deactivate buyer programs 100 and add buyer programs 100. The buyer program list page is accessed from the home page or the community buyer list page.

Enhanced buyer program 100 capabilities allow the buyer 106 to have multiple buyer programs 100 thereby having the capability to organize suppliers 108 into different buyer program pricing tiers 214 for the same buyer 106, and association of an FI pricing profile 208 to a financial institution 110 and a buyer program 100. The community manager 102 is able to add FI pricing profiles 208, view rate change history and otherwise add additional pricing capability related to the buyer program pricing tiers 214. FI pricing profiles 208 are associated with a buyer program 100. A new supplier 108 associated to the buyer 106 will be displayed with a status of “Unassigned” until they are added to a buyer program 100. Suppliers 108 may be moved around within buyer programs 100. If a buyer program 100 is deactivated, the suppliers 108 display as unassigned and in effect, belong to the default/root buyer program 100.

The buyer program 100 is segmented into five areas or tabs. Each tab contains information about that specific aspect of the buyer program 100. The five tabs are (1) buyer program 100—general information about the buyer program 100, (2) pricing—used to apply fees and rates when trades occur, (3) distribution used to determine how trades are distributed to the various financial institutions 110 participating in the buyer program 100 (only applies to the default buyer program 100 and is also viewable from pricing tiers), (4) FI—financial institutions 110 are added to or deactivated from the buyer program 100 using this feature (only applies to the default buyer program 100 and is viewable from pricing tiers—when financial institutions 110 are deactivated from the default buyer program 100, they are deactivated from all pricing tier buyer programs 100) and (5) supplier 108—suppliers 108 are added to the buyer program 100 or assigned to other buyer programs 100 using this feature.

Tax reporting functionality. Tax reporting functionality facilitates compliance with the Australian Goods and Services Tax (GST) regulations. This will enable implementation of the system 10 by Australian customers and also by customers in countries that have taxes similar to the GST.

A new tax profile field is added to the buyer program 100 for tax reporting.

Community manager 102 address details and ABN No. are available in the buyer program details tab.

Tax invoice and tax transaction reports are available in the report menu.

ABN Number is an optional selection on buyer program edit tab.

Notification of tax report generation is sent to the service provider 104, community manager 102 and supplier 108.

Suppliers 108 receiving tax reports are identified by assignment of a tax reporting flag on the buyer program pricing tab.

Suppliers 108 joining the buyer program 100 are required to indicate whether they are eligible for tax reporting for the tax profile assigned (other than none) in the buyer program 100.

The tax component in the tax invoice report is calculated by locating the tax profile within the buyer program 100 and checking the tax percentage in the tax profile. The tax rate used in this invoice is the rate at the time the invoice is generated.

A tax profile drop-down is available on the buyer program pricing tab. This tax profile is used for the associated suppliers” 108 transactions if eligible for tax reporting If no tax profile is assigned to a buyer program 100, the supplier 108, community manager 102 and service provider 104 will NOT get any tax reporting reports or notifications during that period.

Enhanced auto advance features. The auto advance rules are set by buyer program 100 and not the buyer 106 because users have multiple buyer programs 100 per buyer 106.

The auto advance rules typically only run during the quiet period and not every time payment obligations are uploaded.

Additional filtering criteria allow the user to select other criteria in filtering their payment obligations.

The capability to schedule the auto advance allows the user to set the auto advance to either “Initiate Funding” or “Review” options. If auto advance is set to “initiate”, then the sell offer is immediately submitted following execution of the auto advance process. If auto advance is set to “Review”, the sell offer is not automatically submitted, but is held for review and the user may cancel or submit the sell offer. A task and alert notifies the supplier 108 if auto advance created a sell offer and provides an alert for each buyer program 100.

The sell offer creates one sell offer for the amount equal to or less then the “not to exceed” amount.

Since the auto advance function runs during system 10 quiet time, the user can modify the auto advance rules at any time prior to processing.

All cancelled sell offers are listed using track documents functionality—cancelled search status of sell offers.

At closure of sell offer window for the day, all sell offers that are still unreviewed or that have been reviewed after window closure are cancelled.

Sell offers are generated with a monetary amount within the sell offer minimum and maximum amount.

Buyer offer distribution methods for buyer programs. Two distribution methods for buy offers are available to select from the default buyer program 100 of the buyer 106 only within the community module. These are rotational and manual. In the rotational distribution method, buy offers are immediately sent to relevant financial institutions 110 after creation by a supplier 108 and proceed to the next financial institution 110 in sequence if either rejected or timed out. In the manual distribution method, buy offers are immediately sent to the community manager 102 after creation by a supplier 108. The community manager 102 distributes the relevant buy offer(s) to financial institutions 110. If the buy offer times out or is rejected, it returns to the community manager 102 for redistribution. If the rotational distribution method is selected (on the distribution tab of the buyer program 100), each financial institution 110 that is part of the buyer program 100 is assigned a rotational sequence (system assigned or manual assigned). This ensures that buy offers are rotated between financial institutions 110 in a specific sequence

Internal/external financial institutions. The self funding liquidity enhancement provides functionality allowing a buyer's 106 treasury department to “become” the financial institution 110 and fund their own payment obligations. This new type of financial institution 110 is referred to as an “Internal FI”. True financial institutions 110 are referred to as “External FI's”.

When adding a new buyer program 100, community managers 102 also identify and flag the internal financial institution 110.

The community manager 102 can flag a financial institution 110 as internal on the buyer program 100 (add, edit and view) FI tab. An “Internal FI” column is also on the FI tab in conjunction with an “update” button that flags the selected financial institutions 110 as internal. Any number of financial institutions 110 may be flagged as internal.

Payment obligations that have been sold to internal financial institutions 110 mature and become “Settled” at the time of purchase. Therefore, internal financial institutions 110 will never have maturing obligations and will always reflect as “Settled”.

For an internally funded trade, the fees normally credited to the community manager 102 are included in the financial institution margin.

The buy offer fees will be recalculated on financial institution 110 acceptance because it is not known whether the buy offer will be sent to an internal or external financial institution 110. The buy offers screen in the internal financial institution 110 module reflects the fees as if the buy offer has already been funded, for example if the buy offer community fees are incorporated into the financial institution margin (trade cost and trade margin values will be updated). The community manager 102 and service provider 104 view the buy offer as if it was sent to an external financial institution 110 until the internal financial institution 110 accepts the trade.

When the check box is checked, the internal financial institution 110 is signifying the forfeit of fees. The checkbox is only enabled if the internal financial institution 110 check box is checked.

Once a buy offer has been accepted, the fees will be recalculated so that the sum of the community share of fees and the community share of interest is zero.

Internal financial institutions 110 are included in the rotational sequence and therefore community managers 102 assign a rotation sequence to internal financial institutions 110 as well.

FI activation to buyer programs. When a financial institution 110 is added to a buyer program 100 by a community manager 102, the financial institution 110 is sent a notification to join the particular default buyer program 100. The financial institution 110 enters a credit limit with other necessary information and accepts the association with the relevant buyer program 100. The status of this financial institution 110 changes to “active” on the FI tab of the buyer program 100. The particular buyer program 100 is present on the active programs and portfolios pages of the FI module.

The financial institution 110 can deactivate this buyer program 100 from its portfolios at any stage.

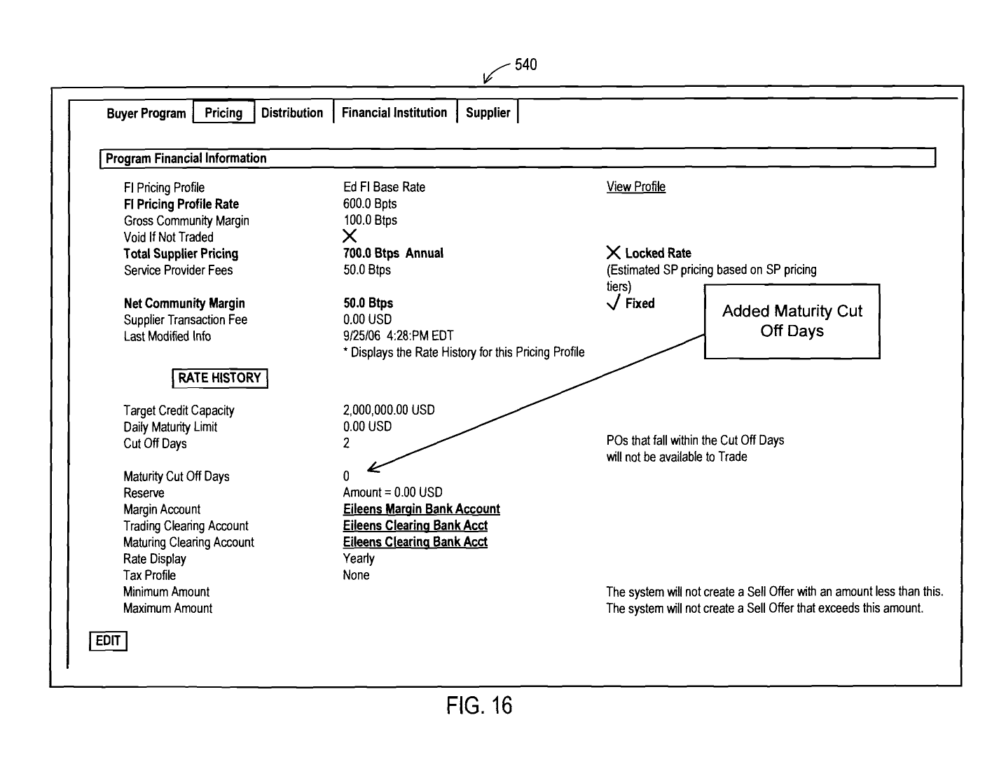

Added maturity cut off days. FIG. 16 is an exemplary screen image illustrating added maturity cut off days 540. Maturity cut off days operates similar to cut off days where an obligation is not allowed to be traded if it is to become mature within 2-3 days. A maturity not to exceed days is necessary. For example, if the not to exceed days is set at 75 days, then invoices can be uploaded that are longer than 75 days, but they can not be traded until they are 75 days or younger (as in “cut off days”). Once the payment obligation maturity becomes 75 days or younger it is available to trade. This is important since a financial institution 110 may offer $50 million in liquidity but can perform obligations in excess of 75 days. This capability allows the payment obligations to be uploaded but not traded.

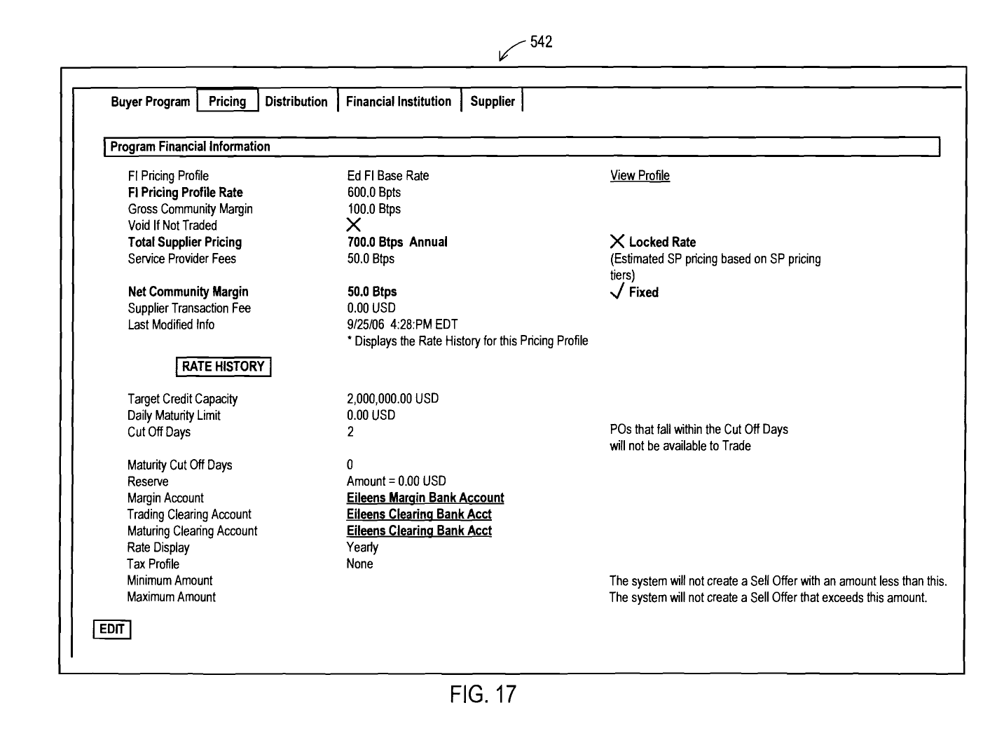

Daily maturity limit. FIG. 17 is an exemplary screen image illustrating daily maturity limit 542. The daily maturity limit per buyer 106 is monitored to restrict the financial institution 110 from buying invoices that exceed the daily maximum. This helps prevent financial institutions 110 from exceeding daily credit limits. For example, a buyer 106 may have a $1 million credit limit and a $100,000 daily limit. Thus, the buyer 106 does not want to exceed $100,000 on any one day for maturing obligations. If a supplier 108 creates a sell offer and the daily limit is met, then those payment obligations are rejected for the sell offers that violate the daily limit. After checking whether the sell offer exceeds the total credit limit available for the sell offer, the daily maturity limit will be checked. If the buyer 106 has a daily maturity limit set, the system 10 checks the maturity date for the invoice on a sell offer, adds all the invoices with the same maturity date on that sell offer, and then adds that total to what has already been purchased for that day. The system 10 then compares that total to the daily limit to verify that it is not exceeded. If the limit is exceeded the user is given a warning that the daily maturity limit is exceeded for this maturity date, the available limit, and that the payment obligations for that maturity date will be removed from the sell offer. The user may then cancel or continue.

If the user continues, then those invoices are removed and the system 10 checks the next date. The system 10 will proceed date-by-date until the final sell offer is created.

If the user cancels, the sell offer is not created and the user can go back to the work sheet to remove invoices and then re-submit to stay within the daily maturity availability.

Cross community financial institution. The service provider 104 has the capability to assign FIs across buyer programs 100 and across communities 112. A financial institution 110 can belong to any number of communities 112 and any number buyer programs 100 within those communities 112. The only exception to this rule is that the financial institution 110 may not belong to more than one buyer program pricing tier 214 within a default buyer program 100.

Cross community suppliers. The service provider 104 has the capability to assign suppliers 108 across multiple buyer programs 100 and across multiple communities 112. A supplier 108 can belong to any number of communities 112 and any number of buyer programs 100 within those communities 112. The only exception to this rule is that the supplier 108 may not belong to more than one buyer program pricing tier 214 within a default buyer program 100.

Multiple communities within the SCF platform. The service provider 104 has the capability to set up multiple communities 112 to support the participating entities on the SCF platform. Each community 112 can consist of one or more buyer programs 100. Suppliers 108 and financial institutions 110 can belong to any number of buyer programs 100 across any number of communities 112 thus providing a comprehensive range of configuration possibilities.

Credit Memos

Another embodiment of the present invention addresses trading, auto advance and miscellaneous module enhancements regarding credit memos. Credit memos may be uploaded into the system 10, validated, processed, and then addressed at maturity. A trade is another event that affects open credit memos.

Once open credit memos are uploaded into the system 10 and validated, the two events affecting open credit memos are (1) a maturity date and (2) a trade. Open credit memos are different from payment obligation number (PON) credit memos since open credit memos have not been applied to an invoice.

FI funded or self funded trades are not treated differently within the system 10. In practice, they are often treated differently because (1) a credit memo cannot be sold to a financial institution 110, and (2) a trade acts like a maturity date for self funders so that credit memos can be processed with a trade and presented to a financial institution 110. For self funders, this is like a supplier 108 induced maturity date and operates differently. Due to the complexity of self funding, credit memos are addressed within the system 10, and trades are treated similarly with credit memos being applied to an invoice.

The application of credit memos at a trade adds another element of complexity. The application of a credit memo takes effect once a trade is approved by the financial institution 110. For example, if a supplier 108 creates a trade that times out or is rejected by the financial institution 110, eventually timing out, the credit memos are released from the invoice to which they were applied and go back to where originally applied.

Trading With Credit Memos

The two events that affect a credit memo are (1) a maturity date or (2) a trade. A trade is a maturity date for a supplier 108 electing to sell an invoice. The invoice is closed in the supplier's books. PON credit memos are not affected by trading because they are already applied to invoices. Credits with PONs are applied to invoices together with a certified value for the invoice.

Negative invoices are applied to invoices at the time of trade to produce a correct certified value. The supplier 108 cannot create a sell offer that contains a credit memo. The credit memo is applied to the invoices. Negative invoices greatly affect the creation and processing of trades.

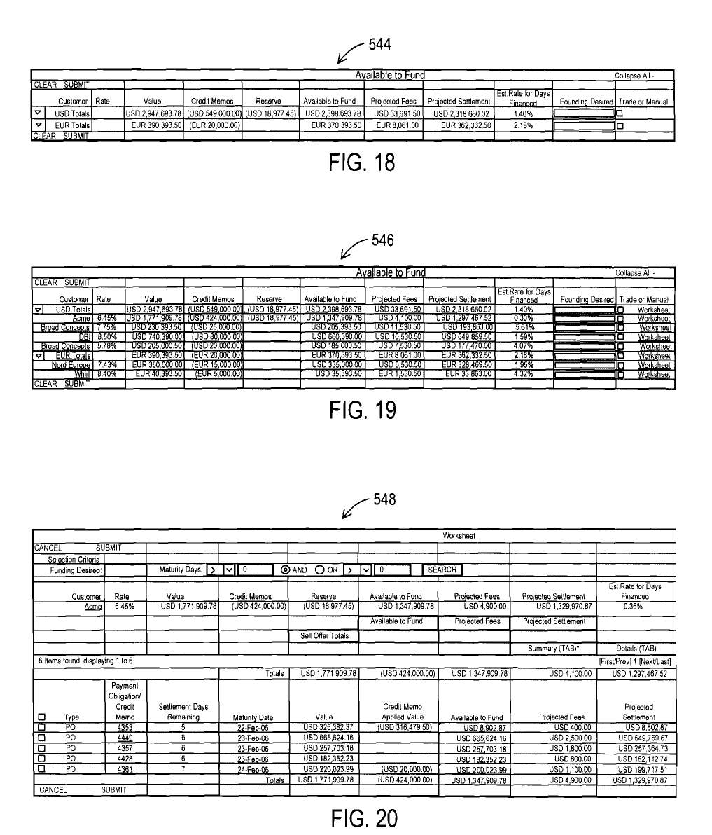

FIG. 18 is an exemplary screen image illustrating the available to fund 544 functionality of the buyer program 100. At the available to fund 544 screen, the system 10 is performing the credit memo application functionality. If the invoice is not traded, the execution is temporary and does not change the invoice or the credit memo. If a user is in the available to fund functionality and another user in the track docs functionality brings up a payment obligation that is being traded, the invoice or the credit memo are not changed. For the financial institution 110 accessing the buy offer, the invoices appear as if the credit memos have been applied. Once the buy offer is accepted—manually or automatically—the system 10 applies the credit memos as permanent. Once the buy offer is accepted, the process is not reversible. Credit memos are typically applied to invoices that have been traded. If a credit memo in the available to fund screen had an amount applied to it, but was not traded or could not be traded, then that amount is not applied to the credit memo. The credit memo is only applied to invoices that were traded.

It should be noted that temporary execution insures that the invoice is selected and actually confirmed by the financial institution 110, otherwise the credit memo is not applied to the invoice. If either the sell offer or the buy offer time out, or if the financial institution 110 rejects the offer, then the credit memos are not applied. To the financial institution 110, it appears as if the credit memos were applied.

Applying Credit Memos

Negative invoice credit memos are applied to invoices by maturity date processing in an ascending manner. The credit memos that consume an invoice are not actually applied to the invoice, since it makes the invoice non-tradable and the user can not select it. In theory, that invoice is being held back.

As an example, if today's date is February 1 and the next maturity date is February 10. During that period there is one invoice and one credit memo. On the worksheet, the system 10 shows the credit memo applied in the credit memo applied value, showing the certified value and the new calculation of fees. But the credit memo is not actually applied.

In another example, an invoice cannot be traded if the credit memo value is larger than the invoice. If the invoice is $5 and the credit memo is $6, then the amount that can be traded is $0.

In yet another example, an invoice can be traded if the invoice value is greater than the credit memo value. If the invoice is $10 and the credit memo is $2, then the amount that can be traded is $8 and fees are calculated based on $8. The $2 credit memo is not applied to the invoice until the trade happens, but all calculations are based on $8.

Apply Credit Memos

Each maturity date is treated as a period. Values are netted out for each period. Credit memos are applied in ascending or descending order for that period rather than for all invoices in the system 10.

For credit memos that have an open value in the past, a determination is made whether the older credit memos can be consumed by invoices that are within the cut off date range. Those credit memos are not displayed on the available to fund screen. Otherwise, the credit memos are not consumed. The open value—value of credit memos, value of cut off day invoices—are open credit memos on available to fund.

Older credit memos are applied first. Credit memos for other periods are applied before the credit memos in the current period. Thus, older credit memos are not moved into periods very far into the future. Older credit memos are likely to go to the next pay or trade period, if possible.

Credit memos are applied—as a default—in ascending order for a particular maturity date. Thus, the smallest invoice values are applied first in a pay period. Typically, the smallest invoices are consumed leaving a smaller number of invoices having larger values.

The system 10 picks credit memos with earlier effective dates and consumes the open amount until the value goes to zero with the first invoice (ascending or descending and picks the invoice). Once zero is reached, the system 10 moves to the next credit memo, etc. Thus, the oldest credit memo is applied to the invoice.

The details tab allows a user to apply credit memos in a descending order. The credit memos are applied for that buyer program 100 in ascending to descending order by maturity date. Credit memos are then applied to the largest invoices first for that period.

Once traded and accepted, the credit memos are applied, and the normal processing for history and audit trail apply. The system 10 updates the history of the credit memo, for example, to read “Credit memo applied to payment obligation [XXXX] for <CUR> xxx.xxx.xxx.xx because of a trade on <DATE>.” It is also important to differentiate whether the credit memo is applied for a maturing obligation or for a trade. Additionally, the payment obligation is updated with a history record to read “Credit memo [XXXX] applied to payment obligation for <CUR> xxx.xxx.xxx.xx because of a trade on <DATE>.” The documents are hyperlinked so the user can quickly search on that document through track docs.

It should be noted that each maturity date is treated as a pay period and all processing is by period for all periods. If invoices are loaded for 30 days, then each day is treated as a pay period. Changing credit memos from ascending to descending applies the change for all 30 days, but each period (e.g., day) performs the ascending or descending. All invoices are not arranged for a 30 day period. Rather, each maturity date is arranged, for all 30 days.

There is no search criteria in the available to fund screen, and searches are not performed by funding, currency, customer or maturity dates. Rather, when a supplier 108 enters the available to fund screen, results are already displayed by the buyer 106 or buyer program 100.

Instruction text at the top of the available to fund screen directs to “Pick the customer that you want to discount the payment obligations. You can trade all available payment obligations for all customers, trade all invoices for a certain customer, put in an amount needed by customer or simply pick individual invoices by customer via the worksheet.”

Upon a user entering the available to fund screen, the system 10 displays the results of all the buyer programs 100 for this supplier 108. When the supplier 108 enters the available to fund screen, the system 10 performs calculations for credit memos and reserves. The available to fund items are listed by currency. The expand all button expands the details of all currencies to show the user all the buyers 106 for all currencies. Upon selecting the expand all button, it becomes a collapse all, and would thus collapse all currencies. An arrow next to the currency represents “closed” for the currency. Selecting the arrow expands that currency (and the arrow points downward).

Buyers 106 for a supplier 108 are displayed by currency, allowing the user to quickly and easily see all the buyers 106, rates, available to fund, fees, etc. The clear function key clears any funding desired calculations that have been performed. The submit function key creates a trade for the desired amount, upon the user selecting a funding desired amount and clicking the trade button. Upon the user selecting trade and then submit, the system 10 trades the entire projected settlement.

The currency view totals the sub-ledgers or buyer programs 100 for that supplier 108 for that currency. The arrow—while closed—shows the summary level for that currency. Selecting the arrow moves it to point downward and shows all buyer programs 100 for that currency. Totals are listed by currency and are the total row based on selected criteria.

The rate column is the rate per buyer program 100, and is not applicable for the summary view.

The value column is the total of certified values of payment obligations for all buyer programs 100 for a currency based on the selection criteria.

The credit memos column lists the total open credit memos for selection criteria, and is listed as a negative number.

The reserve column gives the total reserve amount for this particular supplier 108, and is discussed in further detail below.

The available to fund column gives the amount available to fund. It is calculated based on credit memos and reserve rules.

The projected fees column gives the total of projected fees all invoices available to trade based on the selection criteria selected.

The projected settlement column gives the projected set and is what the supplier 108 expects to receive when taking the invoice value, credit memos and reserves, less projected fees.

The estimated rate for days financed column gives the results of a calculation approximating projected fees/available to fund. This provides a rate based on days financed. This amount is always less than the annualized rate.

The funding desired column is not applicable for the currency view.

The trade box is selected if the user is trading the total projected settlement for that currency. Upon selecting trade and Submit, the system 10 creates the sell offer(s) to trade that total amount.

FIG. 19 is an exemplary screen image illustrating the available to fund functionality of the buyer program 100 in expanded detail 546 from FIG. 18. Selecting the expand all or the expansion arrow causes the system 10 to display details for the individual buyer programs 100 and their details by currency.

The customer column is expanded to show the name of the buyer 106 rather than the buyer program 100. The supplier 108 is only a part of one buyer program 100 per currency. A hyperlink provides access to see the buyer 106 in greater detail.

The rate column shows the buyer program 100 for that supplier 108.

The value column shows the total of certified values of payment obligations for that buyer program 100 for a currency.

The credit memos column lists the total open credit memos and is listed as a negative number.

The reserve column lists the total reserve amount for this supplier 108. Reserve functionality is discussed in further detail below.

The available to fund column lists the available to fund amount for the buyer program 100 after credit memos are applied. The system 10 calculates the available to fund amount using the credit memo processing rules.

The projected fees amount is the amount for discounting the invoices based on the new available to fund amount after the credit memos are applied.

The projected settlement is the resulting amount after subtracting the projected fees from the available to fund amount.

The ‘Est. Rate for Days Financed’ is essentially the amount after dividing the projected fees by the available to fund amount. This amount is the rate based on the days financed and is less that the annualized rate.

Funding desired is the amount desired from the buyer 106 the user requires. After entering the funding desired amount, the user may select trade or worksheet. By selecting a desired funding amount and selecting trade, the system 10 allows the user to create a sell offer without manually selecting the individual invoices. Selecting worksheet shows the invoices selected for that particular amount.

Selecting trade box after placing nothing in the funding desired area indicates that the user is trading the total projected settlement for that buyer 106. Selecting trade and submit causes the system 10 to create the sell offers to trade that total amount. If the user enters a funding desired amount and selects trade, then the system 10 create a sell offer for that buyer 106 at the lowest possible fees.

The worksheet allows the user to see the available invoices to trade for that buyer program 100. Operation is similar to the available to fund screen.

Field Calculations

The system 10 performs the credit memo and reserve calculations when the user opens the available to fund screen. Thus, the calculations are accurate as of the moment the user opens the screen. Alternatively, the system 10 may present a message (e.g., pop-up window) indicating that processing time is required while running the calculations. In yet another alternative, the user could select a run button to process the credit memos if the calculations are process intensive.

The rate is provided from the buyer program 100 tier with which this supplier 108 is associated.

The value is the sum of the certified values of the payment obligations for this supplier 108 and buyer program 100.

The credit memos column provides the sum of the open value of the net negative invoices in the system 10. PON credit memos that have been applied to invoices are not be displayed. (This includes credit memos with open values in the past if the invoices within the cut off days are less than the value of the credit memos.) Only the difference is shown. For example, if the past credit memos open value is $10, and the invoice value for invoices within the cut off is $7, then the open credit memos value displaying in the available to fund screen is $3.

Reserve is discussed in detail below.

The available to fund column provides the value of invoices that are available to trade after the credit memo process has run. The credit memo process executes and is temporarily applied to the invoices in the system 10, leaving an available to fund amount. Default processing rules for credit memos are ascending and apply to the smallest invoices first until the credit memo is consumed for a period. The credit memo value is subtracted from the value of the invoice before fees are calculated.

The projected fees value is based on the new value of the invoice, and is calculated by the system 10 with a new certified value for the invoice after the credit memo has been applied This is the standard fees calculation methodology.

The AFI-Fees corresponds to the projected settlement.

Worksheet Summary Tab

FIG. 20 is an exemplary screen image illustrating the summary tab 548 of the worksheet. The results of the calculations are shown in the worksheet. The details are available upon the user selecting worksheet to see the details. (The details are not recalculated by the system 10 merely for viewing the worksheet.) It should be noted that the worksheet can be on the same page as the available to fund screen, or alternatively on a separate screen.

For manual selection of invoices, a user selects the worksheet hyperlink which causes the system 10 to open the worksheet—whether on the same or a separate screen—so that the user may select the invoices.

In one embodiment, the worksheet screen would eliminate the need for the available to fund screen, thus combining the functionality into one step. A user selects the worksheet at an individual buyer 106 level to view the available invoices that they can trade. At this point, the user can also view how the system 10 calculated the credit memos.

In one embodiment, a bar label having the title ‘Worksheet’ separates the worksheet portion of the screen from the available to fund portion of the screen. The cancel function key cancels any selections that were made on the worksheet and takes the user back to the available to fund screen. The submit key places any invoices that have been selected on the sell offer confirmation screen as a sell offer. The process from the available to fund screen to the worksheet to the sell offer confirmation is a one step process.

The selection criteria are used to filter the results. A funding desired amount selects or checks the invoices at the lowest possible fees to get closest to the amount requested. Selecting submit causes those invoices to be traded. Selecting filter by maturity days shows the invoices only by that maturity date. Since the system 10 has already run the calculations, selecting filter by maturity days is a display filter rather than a new calculation. The customer information from the available to fund screen is displayed above the invoices.

Sell offer totals displays a counter for the sell offer. As the user selects invoices for the sell offer, the invoices are added to a running total bar containing the available to fund, fees, and projected settlement. In one embodiment, the sell offer totals are part of an anchored frame, allowing the user to scroll through titles while maintaining the ability to view the sell offer totals. The sell offer totals display allows the user to monitor the sell offer as it is built.

Two tabs are available at the top of the query; (1) a summary tab and (2) a details tab.

The summary tab is typically be the default tab and shows payment obligations and invoices available to trade based on the credit memo application at the time the user entered the screen. If a payment obligation is not available to be chosen because it was consumed by a credit memo in the credit memo processing run, then the payment obligation is not displayed on the summary tab.

The details tab provides details regarding how the credit memos and reserve were calculated so the user can see how amounts were consumed.

An available to fund check box allows the user to select individual invoices or select the box at the top to select all invoices. When the user selects the all box, then all invoices are selected including those that are not displayed on the screen. In summary view, all items have a check box.

The type column contains a two letter field indicating whether the document is a payment obligation (PO). In summary view, the user sees only POs.

The ‘Payment Obligation/Credit Memo’ field lists the corresponding number of the payment obligation or credit memo. In summary view, only POs are shown.

The ‘Settlement Days Remaining’ column shows the days remaining to maturity of the invoice or credit memo.

The ‘Maturity Date’ column shows the date of maturity for the payment obligation or credit memo.

The ‘Value’ column shows the certified value of the invoice or credit memo before trade or before the credit memo application.

The ‘Credit Memo Applied Value’ column shows the value of the credit memo applied to this invoice. Dependent upon how the system 10 processes the credit memos, the credit memo applied value shows what has been temporarily applied to the invoice.

The ‘Available to Fund’ column shows the newly certified value of the invoice after credit memos are applied if the corresponding invoice is traded.

The ‘Projected Fees' column are calculated for the certified value, rate and days financed.

The ‘Projected Settlement’ column shows the projected amount the supplier 108 is to receive if they trade the corresponding invoice. The projected amount changes dependent on when the sell offer is approved.

The default screen typically shows 100 invoices with columns being sortable as in the available to fund screen.

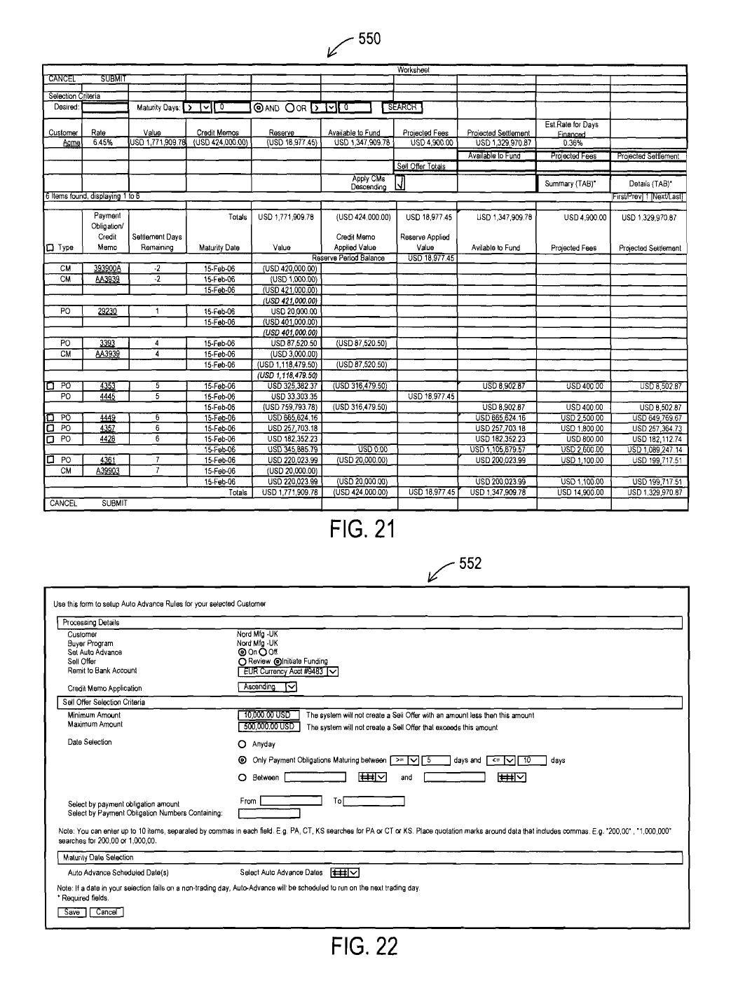

FIG. 21 is an exemplary screen image illustrating the details tab 550 of the worksheet. The credit memo and reserve calculations are shown for the system 10. The details are available showing how the credit memos and reserve were calculated against the user's available to fund amount. It should be noted that reserves are discussed in detail below. Of course, desirable color schemes may be used to provide a clear and accurate display of totals and sub-totals for the user.

On the details tab for a maturity date, the credit memos are typically shown first followed by payment obligations. Mixing credit memos with payment obligations could make the display hard to follow.

Totals are typically presented in groupings for each maturity date. The totals shown include settlement days remaining, maturity date, and value. If the settlement days remaining shows a negative value because of the credit memo's open value, then the screen has a credit memo opening period balance for the next maturity date.

It should be noted that an open credit memo is in the past. For negative invoices, if a pay period arrives and there are still invoices that have not been processed at that maturity date, the system 10 waits until the next pay period or trade date for processing. Old invoices are process at trades and displayed as negative settlement days.

If a trade happens on a day where invoices for that day are not trading due to the cut off days, the system 10 checks to be certain that invoices within the cut off period do not consume the old credit memos. For example, if today is February 16 with cut off 3 days, and invoice maturity on February 17, the invoices fall within the cut off and do not display in the available to fund total. If February 15 maturity date credit memos are still open, the system 10 determines whether the credit memo value is larger than the invoice value for February 17. If the credit memo value is larger than the invoice, then the remaining value of those credit memos appears as an open value for trades occurring on February 16. If the credit memo value is smaller than the invoice value, then those credit memos do not appear on the available to fund screen. Invoices within the cut off period are added to show the user how the credit memos carry over. (For the summary tab, only tradable invoices are displayed.) Invoices for February 18 are within the cut off period, thus if not displayed the user would want to know why the credit memos weren't included. The user is thus shown that some portion of those credit were consumed by invoices within the cut off period. (These invoices are not tradable.) Further, the credit memo application ascending/descending does not need to recalculate for invoices in the cut off period. As shown in FIG. 21, invoices within the cut off are differentiated by graying out the trade columns to the right. Of course, other methods for differentiating could be chosen. Credit memos are applied as they are applied at maturity.

The available to fund screen has no affect on credit memos and invoices after the cut off date. Further, the available to fund screen has no affect on credit memos and invoices being processed within the cut off period. For example, as shown in FIG. 21, if the $1,000 credit memo is applied to the maturity date on February 18, and the $19,000 is consumed from the $401,000 credit memo, then that credit memo is used on the available to fund screen and the $1,000 credit memo has no affect on the available to fund screen or the ascending/descending selection.

The ‘CM Opening Period Balance’ row is displayed for dates that have a negative balance of credit memos-credit memos larger than payment obligations. This balance carries forward to the next maturity date. This row is not displayed if there is no credit memo open period balance. Any credit memos carrying forward from a previous period are shown in this manner.

The check box to the left is used for selecting payment obligations. Check boxes are only shown next to valid payment obligations. If a payment obligation is consumed because of a credit memo, it does not have a check box.

The ‘Type’ field displays credit memo and payment obligation document types.

The ‘Payment Obligation/Credit Memo’ column displays credit memo and payment obligation numbers. All credit memos that are applied are displayed in the details tab.

In the ‘Settlement Days Remaining’ column, the settlement days can be negative for credit memo document types for unconsumed or open credit memos.

The ‘Value’ column shows the credit memo value, and is the open unapplied value of the credit memo. If any part of the credit memo has been applied or consumed, it does not appear in the value column.

The ‘Credit Memo Applied Value’ column shows the credit memos that have been applied by the credit memo process. The system 10 typically applies credit memos by in an ascending order by default, thus consuming the smallest invoices first. The system 10 continues until the value of the credit memo is consumed.

The ‘Apply CMs Descending’ flag allows for switching the system 10 to recalculate the credit memo application and apply credit memos to the largest invoices first, then proceeding to the smallest invoices. If a user selects an invoice, and due to the new calculation that invoice is no longer available, then the box for selecting the ‘Apply CMs Descending’ flag is not available and the value is subtracted from the sell offer totals.

The ‘Reserve Applied Value’ is discussed in detail below.

The ‘Available to Fund’, ‘Projected Fees’, and ‘Projected Settlement’ columns function as described previously in the summary tab.

Of course, a user may switch between the summary tab and the details tab without losing the data or selections. The selected tab is typically highlighted.

Trades Creation

Trades are created in (1) the currency view, (2) the buyer program/ledger view, (3) the worksheet, or (4) auto advance rules.

Within the currency view, selecting trade and submit causes the system 10 to create sell offer(s) for all invoices and programs.

Within the buyer program/ledger view, a user can select the trade flag and then select submit, and the system 10 creates sell offers for invoices and programs. Alternatively, the user can enter a funding desired amount and then select the trade amount, and the system 10 picks the invoices for the lowest fees that meet the request. In yet another alternative, the user can select the worksheet and manually select invoices for the trades.

Within the worksheet, a user may use the summary tab or the details tab for selecting trades. In one option, a user enters a funding desired amount and selects search, the system 10 selects invoices to match the amount, and then the user selects submit to create the sell offer. In another option, a user selects the box for selecting all invoices, and the selects submit to create the sell offer. In yet another alternative, the user selects individual invoices that are available to trade, then selects submit and the sell offer is created.

Currency View

If a user selects trade and then submit, the system 10 provides a warning message to confirm that the user desires to trade all invoices for the particular currency. If the user chooses to continue, then the system 10 continues to create the sell offers. The sell offer confirmation screen then allows for initiating funding for all sell offers. Of course, the sell offers can be canceled at this point.

If a user selects submit without first selecting trade, the system 10 provides a warning to select the checkbox indicating the buyers 106 for which to create a trade.

Buyer Program/Ledger View From the buyer program or ledger view, the user can trade everything for that buyer program 100. The user selects the trade and submit. Selecting submit without selecting a trade box corresponding to a buyer 106, the system 10 provides a warning to select the trade box corresponding to a buyer(s) 106 for which to create a trade. The trade checkbox can be selected from multiple buyers 106 or ledgers. Upon selecting submit, the sell offers are then created. After selecting submit, the system 10 prompts for confirmation to trade all invoices for the buyer(s) 106. Choosing to continue causes the system 10 to create the sell offer(s).

Alternatively, the user can enter a funding desired amount and then select the trade amount, and the system 10 picks the invoices for the lowest fees that meet the request. If the user enters a funding desired amount and then selects submit, the system 10 prompts to select the trade checkbox corresponding to the buyer(s) 106 for which to create a trade. Upon placing a checkbox next to the corresponding buyer 106, the system 10 creates a sell offer. Users may create sell offers for multiple ledgers at the same time, and the system 10 calculates the lowest fees.

A user may also create sell offers from within the worksheet. The user may enter a funding desired amount and then select worksheet. The system 10 opens the worksheet screen and the summary tab shows the invoices that have been selected by the system 10. The sell offer trade totals are populated with the totals from the selected invoices. The user may deselect some of the invoices and the sell offer trade total decrease, thus allowing the user to create their own trade. Selecting submit, at any time, opens the sell offer confirmation screen. Selecting cancel returns to the ledger view and shows the original funding desired amount.

Worksheet Summary or Details Tab

A user may select individual invoices from the worksheet in multiple ways, including the summary tab or the details tab.

In one option, a user enters a funding desired amount and selects search. The system 10 selects the invoices that satisfy the request with the lowest fees. The sell offer trade totals are populated with the invoices that have been selected. The user can deselect some of the invoices, so that the sell offer trade totals are decreased, thus allowing the user to create their own trade. Selecting submit, at any time, takes the user to the sell offer confirmation screen. Selecting cancel takes the user back to the ledger view with the original funding desired amount. Selecting clear causes all the selected invoices on the worksheet to be cleared (deselected).

In another option, a user can select on the checkbox for selecting all available invoices. The sell offer totals are then updated. The user can also deselect invoices to reduce the sell offer totals. Upon selecting submit, the sell offer is created.

In another option, a user can select individual invoices that are available to trade. The selected invoices populate the sell offer totals. Upon selecting submit, the sell offer is then created.

It should be noted that the user can switch between the summary tab and the details tab. The system 10 keeps track of the invoices that have been selected, and the header information worksheet remains the same.

Selecting the apply credit memos descending and an invoice that was previously selected is no longer available, then the invoice checkbox becomes unchecked and the invoice is dropped from the sell offer totals.

Auto Advance

FIG. 22 is an exemplary screen image illustrating the auto advance features 552 of the worksheet. Auto advance can be set for credit memo application ascending or descending, and is active if the buyer program 100 details is set to ‘No’.

Auto advance creates a sell offer that meets the parameters of FIG. 22. The system 10 runs the credit memo applied routine and then auto advance creates the sell offer based on the results.

Sell Offer Creation

Once the invoices have been selected and the user selects submit, the user is taken to the sell offer confirmation screen. At the sell offer confirmation screen, the user can select their pay to bank account and initiate funding.

Module Changes

Task and Alert—Credit Memo Application Based on Trade. If a trade is accepted and then credit memos are applied based on the acceptance, a task and alert is sent for the credit memo application. The task and alert states how the credit memos are applied (e.g., “Credit Memo [xxxx] has been applied to Payment Obligation [xxxx] for <CUR> xxx,xxx,xxx.xx”). A separate task and alert typically corresponds to one credit memo. Credit memo application task and alerts are typically a high priority.

Buyer and Supplier Exceptions. If a credit memo is applied to an invoice in a pay period to which the credit memo was not originally designated, an exception event is created. The exception event is flagged for the credit memo report. Additionally, the history on the credit memo is updated with an explanatory message (e.g., “Credit memo was not applied to designated effective date <DATE> because of a trade on <DATE>.”). Such an exception is also applicable for negative invoices that are applied to a different pay period than planned because of a maturity date.

Payment Obligation Aged Forecast (Supplier). The payment obligation aged forecast values are the net of credit memos for a maturity date. The report looks at certified values (PON credit memos). Credit memos that act as negative invoices are subtracted from the forecast for a specific day.

Payment Obligation Report (Supplier). Negative invoices do not affect amount received in all situations. Searches on obligation types, traded, paid early and open do affect the amount received. The matured-untraded type does not affect the amount received. A credit memo that is assigned to a pay period may have reduced the amount paid at maturity to zero, thus the supplier 108 may not have been paid any amount. An asterisk or star appears next to payment obligations that have the matured-untraded type. The asterisk indicates that the amount received for payment obligations that have a matured-untraded type may not be correct because of credit memos, and that the EFI statement for the maturity date can be used to determine what was received.

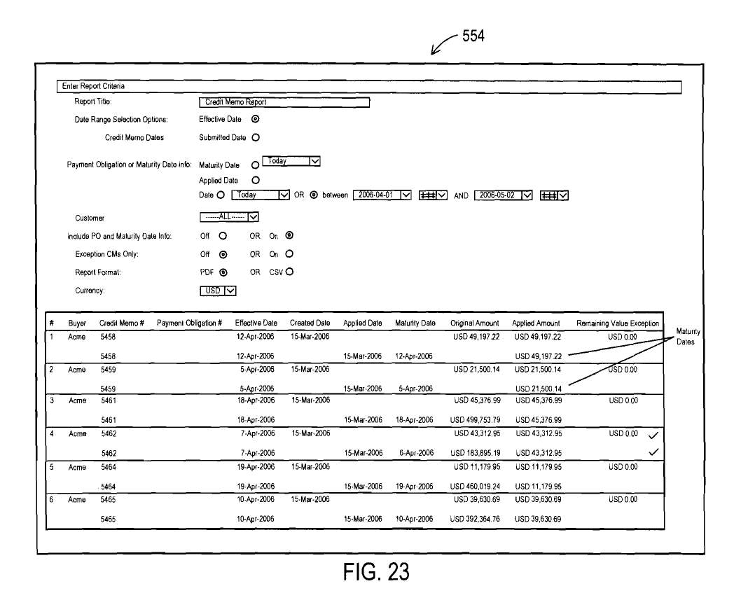

Credit Memo Report. FIG. 23 is an exemplary screen image illustrating the report criteria 554 features of the buyer program 100.

Credit memo documents have an effective and a submitted date. Under date range selection options, the term ‘Credit Memo Dates' appears next to the radio buttons for selecting either effective date or submitted date. Below the credit memo dates term appears a term ‘Payment Obligation or Maturity Dates’, for selecting the options maturity date or applied date with radio buttons.

The ‘Include PO and Maturity Date Info’ term indicates that credit memos can be applied to maturity dates that are displayed for negative invoice.

A status field (not shown) is added to the screen in FIG. 23 to indicate the status for the credit memo.

If the ‘Include PO and Maturity Date Info’ is on, then a payment obligation number or maturity date is displayed. If the credit memo is applied to a maturity date, it does not include a payment obligation number effective date. Applied date, maturity date, and applied amount are populated, and the original date field is left blank. For example, a credit memo could be applied to a payment obligation and multiple maturity dates, and each would be displayed on the credit memo report.

Reserve

The reserve functionality combines with credit memos to prevent the buyer 106 from acquiring a net negative balance with their suppliers 108 due to trading. The reserve functionality allows the system 10 to set a reserve percentage or amount to hold back some invoices for a supplier 108 and prevent them from being traded. The non-traded amount is used to offset credit memos coming in for that supplier 108. For example, suppose a buyer 106 owes a supplier $500,000, and then discovers before maturity that they have $50,000 in credits. If the supplier 108 traded all $500,000, then the buyer 106 would actually owe $50,000 more than desired. Having a 10% reserve would hold back $50,000. Since the $50,000 is not traded, it can be offset with credits.

Reserves and Available to Fund. The reserve applies when calculating the available to fund on the worksheet. The reserve is used for trades rather than with maturing obligations, and is only restricts the trading of obligations.

Reserves and Credit Memos. The reserve functionality works in conjunction with credit memos. The reserve function typically runs after the credit memo application. When a user reaches the available to fund screen and the system 10 calculates available to fund, the system 10 also calculates the reserve. From the worksheet details tab, applying credit memos descending causes the credit memos recalculate reserve to be reapplied also. An invoice that was reserved may no longer be reserved due to how credit memos were applied. For example, a reserved payment obligation may go to $0.00 value because of the new credit memo run and thus, can no longer be reserved.

The reserve is also applied in an ascending order only. It starts at the beginning of a monthly period and moves downward, consuming earlier invoices before consuming later invoices. A supplier 108 cannot do a descending reserve calculation from the end of the month. Thus, the reserve typically starts on today's date and moves to the end of the month. Once the reserve calculation reaches the first date with available invoices, it reserves in an ascending manner. The reserve calculation takes the smallest invoices and moves to the largest invoices, with the goal of consuming smaller invoices and leaving larger invoices to trade.

Essentially, a reserve is a credit memo with its value applied to the invoice, but any amount of reserve that is assigned to an invoice makes that invoice non-tradeable.

Reserve Period. The reserve period typically applies to a calendar month and the reserve amount is calculated for that period. If the calculated reserve amount is not used for that period, it does not typically apply to any other periods.

For example, if the reserve for January is $10,000, the entire reserve is $10,000. If nothing is reserved in January, or no credits are received, the $10,000 balance does not carry over to February, but rather expires at the end of the month (January).

However, if credit memos are not used in a period (or month), they do not expire, but rather move on to the next month. If the credit memo carries over to the next month, it consumes the reserve for that month.

Percentage or Amount. The reserve can be based upon a calculated percentage or a specific amount of the uploaded payment obligations. If both a calculated percentage and a specific amount are specified, then the greater of the two is used as the reserve.

As an example, 10% and $10,000 are chosen for the reserve. If one payment obligation was uploaded for $1,000, the reserve would be $10,000 (10% of $1,000 is $100, thus the larger $10,000 is the reserve). However, if the reserve is set at $10,000, but with no percentage specified, then the system 10 reserves $10,000 and perform no percentage calculations. Similarly, if the reserve is set at 10%, then $100 is the reserve.

Percentage looks at all uploads for the month for invoices having a maturity date in that month. If the reserve is 10% for January, then it is 10% for all uploads in the month of January with a maturity date in January. Thus, if invoices are uploaded on January 15, having a maturity date in January, the maturity date January 1-31 is used for the 10% calculation.

It should be noted that the payment obligation calculation is based on original value rather than the certified value. A credit memo PON decreases the certified value, and would cause miscalculations of the reserve percentage.

Reserve Consumption. When the amount of credit memos applied for the monthly period equals or exceeds the specified reserve amount, then the reserve commitment is considered met for the period. The reserve amount is then set to zero.

For example, if the reserve is $10,000 for January and $2,000 in credit memos are uploaded, then the reserve is $8,000. But if $9,000 in credit memos are uploaded, then the reserve is zero for that month. The credit memo amount is based on effective date of the credit memo, not the uploaded or submitted date. If credit memos for February are uploaded in January, then they count toward the February reserve consumption rather than January. It should be noted that this reserve consumption includes all credit memo amount, that is credit memos and credit memo PONs.

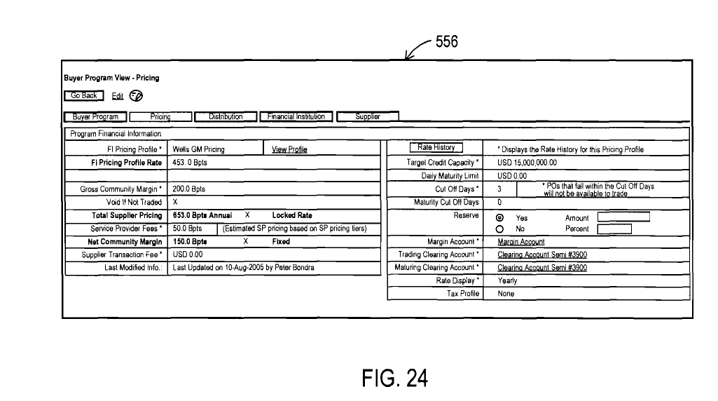

Reserves are set in the CM Module. FIG. 24 is an exemplary screen image of the buyer program view for pricing 556. The reserves amount is maintained by the community manager 102 on behalf of the buying organization. A reserve can be specified for any buyer program 100 or buyer program clone, and can be on or off for any of the tiers.

A ‘Reserve’ field is included in the buyer program 100 and can be set by any tier. Any supplier 108 in the tier then gets this reserve. The reserve field can be set on or off (Yes or No in FIG. 24). If the reserve field is turned on, there are two fields for entering percentage and amount inputs the percentage is a 2 digit field and the amount field accepts the size of the invoice amount. The user can enter values in one or both fields, and the larger of the two values is used as the reserve amount.

The reserve amount can be changed as needed and takes effect immediately. For example, if the reserve amount is changed, then moments after the change a user at the available to fund screen receives the effects of the new amounts.

If the reserve is set to yes and an amount is not entered, the user is not allowed to leave the screen until an amount is entered (even 0.00 or 0%) in one of the fields or turns the reserve off.

Trades in Partial Months. When specifying a reserve for a partial month where the month does not begin on the first, the reserve is applied as if the entire month is being calculated. For example, if a supplier 108 desires to trade invoices from June 5 through August 5, then all payment obligations and credit memos are used in the calculation, but only the payment obligations from June 5 are displayed.

When specifying a reserve for a partial month where the month does not end on the last day of the month, the reserve is applied from the beginning of the month to the last day. For example, if a supplier 108 desires to trade invoices from June 5 through August 5 when calculating the August reserves, only the payment obligations and credit memos from the beginning of the month to August 5 are used. However, the total reserves for the month are applied.

The reserve for a month is not prorated. Rather the entire reserve is the value for a given month.

Reserves Restrict Trading of a Payment Obligation. A payment obligation can not be traded if a reserve has been applied against the payment obligation on the worksheet. This is true even if it is a partial application. For example, a $1 reserve applied to a $1,000,000 invoice causes the $1,000,000 to be on reserve.

Reserve Applied to Tradeable Invoices Only. A reserve only applies to tradeable payment obligations on the worksheet. A reserve can not be applied against a non-tradable invoice on the worksheet.

Reserve and the Cut Off Days. Invoices that are not tradeable but that can consume an invoice need to be checked to see whether they can consume the reserve. (This can be confusing to a user that sees a reserve, but that reserve is not consumed on the worksheet.) The recommendation appears on the details tab of the summary worksheet. The invoices are displayed in maturity cut off so the user can see that they are being consumed.

Available to Fund Screen Modifications. The reserve amount is available to the user at the available to fund currency view, the buyer view, and the ledger view. The currency view reserve totals the buyer programs 100 for that currency. The individual ledger view is the total for that buyer 106.

The reserve is as large as the invoices with dates. For example, if the date is January 1, the reserve is $10,000, and the invoices have maturity dates in January, February, and March, the reserve is $30,000 (assuming no credit memos). The reserve consumes $10,000 per month rather than $30,000 beginning in January.

As credit memos are uploaded to the system 10, the reserve amount is consumed and the amount for the month is reduced.

Worksheet Modifications. The reserve field does not show on the summary tab which only shows available to trade invoices. An invoice with a reserve does not show because it can not be traded.

The details tab contains a subtotal field showing the reserve balance for the month. The reserve balance decreases as credit memos are entered into the system 10 for that month. The reserve field merely shows the balance and not the difference between the original reserve and the credit memo.

After the credit memos are applied, the reserve balance is applied to invoices in an ascending method for the month. Upon reaching the first date with available invoices reserves are applied in an ascending manner and consumed until the reserve balance goes to zero. An invoice with a reserve is non-tradable.

The reserve amount applied for the invoice goes into the reserve applied value. The user sees this value since they can not trade the invoice due to the reserve.

Supplier Customer List. The reserve column under the supplier list denotes whether a reserve is on or off. If the reserve is on, the percentage, amount, or both are displayed.

Buyer Supplier List. The reserve column under the buyer supplier list denotes whether a reserve is on or off. If the reserve is on, the percentage, amount, or both are displayed.

Task and Alert Community. If a reserve value for a tier is changed, a task and alert is sent to the community manager 102. The reserve notification message could, for example, denote that “The reserve has been changed for <BUYER PROGRAM>. The reserve is now <%, AMT or Both> from <%, AMT, or BOTH>”.

Task and Alert Supplier. If a reserve value for a supplier 108 has changed, or if the supplier 108 has been moved to a tier with a different reserve, a task and alert notification is sent. The reserve notification message could, for example, denote “For <BUYER> as of <DATE> the new reserve is <%, AMT or Both>”.

Auto Advance. Auto advance takes into account the reserve when calculating. The system 10 runs the credit memo and reserve rules, and then selects the available invoices that meet the selection criteria.

Accordingly, it will be understood that various embodiments of the present invention described herein are preferably implemented as a special purpose or general-purpose computer including various computer hardware as discussed in greater detail below. Embodiments within the scope of the present invention also include computer-readable media for carrying or having computer-executable instructions or data structures stored thereon. Such computer-readable media can be any available media which can be accessed by a general purpose or special purpose computer, or downloadable to through wireless communication networks. By way of example, and not limitation, such computer-readable media can comprise physical storage media such as RAM, ROM, flash memory, EEPROM, CD-ROM, DVD, or other optical disk storage, magnetic disk storage or other magnetic storage devices, any type of removable non-volatile memories such as secure digital (SD), flash memory, memory stick etc., or any other medium which can be used to carry or store computer program code in the form of computer-executable instructions or data structures and which can be accessed by a general purpose or special purpose computer, or a mobile device.

When information is transferred or provided over a network or another communications connection (either hardwired, wireless, or a combination of hardwired or wireless) to a computer, the computer properly views the connection as a computer-readable medium. Thus, any such a connection is properly termed and considered a computer-readable medium. Combinations of the above should also be included within the scope of computer-readable media. Computer-executable instructions comprise, for example, instructions and data which cause a general purpose computer, special purpose computer, or special purpose processing device such as a mobile device processor to perform one specific function or a group of functions.

Those skilled in the art will understand the features and aspects of a suitable computing environment in which aspects of the invention may be implemented. Although not required, some of the inventions are described in the general context of computer-executable instructions, such as program modules, being executed by computers in networked environments. Such program modules are often reflected and illustrated by flow charts, sequence diagrams, exemplary screen displays, and other techniques used by those skilled in the art to communicate how to make and use such computer program modules. Generally, program modules include routines, programs, objects, components, data structures, etc. that perform particular tasks or implement particular abstract data types, within the computer. Computer-executable instructions, associated data structures, and program modules represent examples of the program code for executing steps of the methods disclosed herein. The particular sequence of such executable instructions or associated data structures represent examples of corresponding acts for implementing the functions described in such steps.

Those skilled in the art will also appreciate that the invention may be practiced in network computing environments with many types of computer system configurations, including personal computers, hand-held devices, multi-processor systems, microprocessor-based or programmable consumer electronics, networked PCs, minicomputers, mainframe computers, and the like. The invention may also be practiced in distributed computing environments where tasks are performed by local and remote processing devices that are linked (either by hardwired links, wireless links, or by a combination of hardwired or wireless links) through a communications network. In a distributed computing environment, program modules may be located in both local and remote memory storage devices.

An exemplary system 10 for implementing the inventions, which is not illustrated, includes a general purpose computing device in the form of a conventional computer, including a processing unit, a system memory, and a system bus that couples various system components including the system memory to the processing unit. The computer will typically include one or more magnetic hard disk drives (also called “data stores” or “data storage” or other names) for reading from and writing to. The drives and their associated computer-readable media provide nonvolatile storage of computer-executable instructions, data structures, program modules, and other data for the computer. Although the exemplary environment described herein employs a magnetic hard disk, a removable magnetic disk, removable optical disks, other types of computer readable media for storing data can be used, including magnetic cassettes, flash memory cards, digital video disks (DVDs), Bernoulli cartridges, RAMs, ROMs, and the like.

Computer program code that implements most of the functionality described herein typically comprises one or more program modules may be stored on the hard disk or other storage medium. This program code, as is known to those skilled in the art, usually includes an operating system, one or more application programs, other program modules, and program data. A user may enter commands and information into the computer through keyboard, pointing device, or other input devices (not shown), such as a microphone, game pad, satellite dish, scanner, or the like. These and other input devices are often connected to the processing unit through known electrical, optical, or wireless connections.

The main computer that effects many aspects of the inventions will typically operate in a networked environment using logical connections to one or more remote computers or data sources, which are described further below. Remote computers may be another personal computer, a server, a router, a network PC, a peer device or other common network node, and typically include many or all of the elements described above relative to the main computer system in which the inventions are embodied. The logical connections between computers include a local area network (LAN), a wide area network (WAN), and wireless LANs (WLAN) that are presented here by way of example and not limitation. Such networking environments are commonplace in office-wide or enterprise-wide computer networks, intranets and the Internet.

When used in a LAN or WLAN networking environment, the main computer system implementing aspects of the invention is connected to the local network through a network interface or adapter. When used in a WAN or WLAN networking environment, the computer may include a modem, a wireless link, or other means for establishing communications over the wide area network, such as the Internet. In a networked environment, program modules depicted relative to the computer, or portions thereof, may be stored in a remote memory storage device. It will be appreciated that the network connections described or shown are exemplary and other means of establishing communications over wide area networks or the Internet may be used.

In view of the foregoing detailed description of preferred embodiments of the present invention, it readily will be understood by those persons skilled in the art that the present invention is susceptible to broad utility and application. While various aspects have been described in the context of a preferred embodiment, additional aspects, features, and methodologies of the present invention will be readily discernable therefrom. Many embodiments and adaptations of the present invention other than those herein described, as well as many variations, modifications, and equivalent arrangements and methodologies, will be apparent from or reasonably suggested by the present invention and the foregoing description thereof, without departing from the substance or scope of the present invention. Furthermore, any sequence(s) and/or temporal order of steps of various processes described and claimed herein are those considered to be the best mode contemplated for carrying out the present invention. It should also be understood that, although steps of various processes may be shown and described as being in a preferred sequence or temporal order, the steps of any such processes are not limited to being carried out in any particular sequence or order, absent a specific indication of such to achieve a particular intended result. In most cases, the steps of such processes may be carried out in a variety of different sequences and orders, while still falling within the scope of the present inventions. In addition, some steps may be carried out simultaneously. Accordingly, while the present invention has been described herein in detail in relation to preferred embodiments, it is to be understood that this disclosure is only illustrative and exemplary of the present invention and is made merely for purposes of providing a full and enabling disclosure of the invention. The foregoing disclosure is not intended nor is to be construed to limit the present invention or otherwise to exclude any such other embodiments, adaptations, variations, modifications and equivalent arrangements, the present invention being limited only by the claims appended hereto and the equivalents thereof.

What is claimed is:

1. In an electronic supply chain finance system having a buyer, at least one supplier that provides goods/services to the buyer outside of the system, and at least one financial institution, each of which accesses the system through a computer network interface, a method of enabling the buyer to apply credit against accounts receivable owed to the supplier by the buyer, comprising the steps of:
receiving a payment obligation from the buyer, the payment obligation having a payment value and a payment maturity date and being associated with an underlying accounts receivable from the buyer to the supplier;
receiving a credit note from the buyer, the credit note having a credit value and a credit maturity date and being associated with the underlying accounts receivable from the buyer to the supplier;
presenting the payment obligation to the financial institution as if the payment value has been reduced according to the credit value; and
upon or before the payment maturity date, reducing the payment value of the payment obligation according to the credit value of the credit note.

2. The method of claim 1, wherein the credit maturity date includes a period, and wherein the reduction of payment values occur for payment obligations that fall within the period.

3. The method of claim 1, wherein upon the buyer trading the payment obligation prior to the payment maturity date, the reduction of the payment value occurs as if the payment obligation reached the payment maturity date.

4. The method of claim 3, wherein the reduction of the payment value occurs by application of credit notes according to age of the credit notes.

5. The method of claim 1, wherein upon the credit maturity date having passed, the reduction of the payment value occurs as if the payment obligation reached the payment maturity date.

6. The method of claim 5, wherein the reduction of payment value occurs by application of credit notes according to the age of the payment obligations.

7. The method of claim 1, wherein the payment obligation is batch loaded into the system from an accounts payable system of the buyer.

8. The method of claim 1, wherein the credit memo is batch loaded into the system from an accounts payable system of the buyer.

9. The method of claim 1, further comprising setting a reserve value against the payment value, wherein the reserve value is a percentage of the payment value, and wherein if the credit note equals or exceeds the reserve value, the payment value in excess of the credit note is available for trading, otherwise the payment value in excess of the reserve value is available for trading.

10. The method of claim 1, further comprising setting a reserve value against the payment value, wherein the reserve value is a specified value, and wherein if the credit note equals or exceeds the reserve value, the payment value in excess of the credit note is available for trading, otherwise the payment value in excess of the reserve value is available for trading.

11. In an electronic supply chain finance system having buyers, suppliers that provide goods/services to the buyers outside of the system, and financial institutions, all having access to the system through computer network interfaces, a method enabling buyers to apply credits against accounts receivable owed to suppliers by the buyers, comprising the steps of:
defining a community within the system, the community including at least one respective buyer and one or more suppliers and financial institutions associated with the respective buyer;
configuring a buyer program associated with the respective buyer, the buyer program associating a subset of the suppliers and of the financial institutions with the respective buyer;
and thereafter:
receiving a payment obligation from the respective buyer, the payment obligation having a payment value and a payment maturity date and being associated with an underlying accounts receivable from the respective buyer to a respective supplier of the subset of suppliers;
receiving a credit note from the respective buyer, the credit note having a credit value and a credit maturity date and being associated with the underlying accounts receivable from the respective buyer to the respective supplier;
presenting the payment obligation to a respective financial institution of the subset of financial institutions as if the payment value has been reduced according to the credit value; and
upon or before the payment maturity date, reducing the payment value of the payment obligation according to the credit value of the credit note.

12. The method of claim 11, further comprising receiving multiple payment obligations from the respective buyer.

13. The method of claim 11, wherein the credit maturity date includes a period, and wherein the reduction of payment values occurs for payment obligations that fall within the period.

14. The method of claim 11, wherein upon the buyer trading the payment obligation prior to the payment maturity date, the reduction of the payment value occurs as if the payment obligation reached the payment maturity date.

15. The method of claim 14, wherein the reduction of the payment value occurs by application of credit notes according to the age of the credit notes.

16. The method of claim 11, wherein upon the credit maturity date having passed, the reduction of the payment value occurs as if the payment obligation reached the payment maturity date.

17. The method of claim 16, wherein the reduction of the payment value occurs by application of credit notes according to the age of the payment obligations.

18. In an electronic supply chain finance system having a buyer, at least one supplier that provides goods/services to the buyer outside of the system, and at least one financial institution, each of which accesses the system through a computer network interface, a method of enabling the buyer to apply credit against accounts receivable owed to the supplier by the buyer, comprising the steps of:
receiving a payment obligation from the buyer, the payment obligation having a payment value and a payment maturity date and being associated with an underlying accounts receivable from the buyer to the supplier;
receiving a credit note from the buyer, the credit note having a credit value and a credit maturity date and being associated with the underlying accounts receivable from the buyer to the supplier;
presenting the payment obligation to the financial institution as if the payment value has been reduced according to the credit value; and
upon determining a correspondence between the credit note and the payment obligation, reducing the payment value of the payment obligation according to the credit value of the credit note.

19. The method of claim 18, wherein the payment obligation is batch loaded into the system from an accounts payable system of the buyer.

20. The method of claim 18, wherein the credit memo is batch loaded into the system from an accounts payable system of the buyer.
